(19) United States
(12) Patent Application Publication
(10) Pub. No.: US 2011/0314840 A1
(43) Pub. Date: Dec. 29, 2011

(54) Various methods for industrial scale production of graphene and new devices/instruments to achieve the latter

(76) Inventor: Hamid-Reza Jahangiri-Famenini, Scarborough (CA)

(21) Appl. No.: 13/134,217

(22) Filed: Jun. 2, 2011

Related U.S. Application Data
(60) Provisional application No. 61/398,332, filed on Jun. 24, 2010.

(51) Int. Cl. F25B 39/02; F28F 7/00; B65D 6/28; C01B 31/04; C09D 127/18; H01B 1/04; B01J 19/08; F28D 15/00; B32B 3/00; B82Y 40/00

(52) U.S. Cl. 62/56; 165/104.19; 165/185; 220/600; 428/195.1; 423/448; 524/546; 252/502; 204/157.6; 204/157.61; 427/228; 427/458; 427/598; 977/734

(57) ABSTRACT

This invention is comprised of the following innovations: various devices/instruments which may be used in the preparation of a compact monolayer [made up of a suitable organic material (or organic compound)] as well as the carbonization of the latter; efficient methods for preparing a compact monolayer which is free from all “other” materials that were used in the various processes involved in the said preparation of the said compact monolayer; various methods for carbonizing a compact monolayer by means of a suitable “heat source” (which allows the application of a sudden searing “heat” extremely quickly) in order to produce a graphene layer, where the said heat source may be a “hot surface” or a suitable “radiation type beam” such as a suitable laser beam, or a suitable maser beam, or a suitable electron beam; and finally, various methods to provide a protective layer for a graphene layer.

### CROSS-REFERENCE TO RELATED APPLICATIONS

Not Applicable

### STATEMENT OF FEDERALLY SPONSORED RESEARCH/DEVELOPMENT

Not Applicable

### REFERENCE TO A “SEQUENCE LISTING”, A TABLE, OR A COMPUTER PROGRAM LISTING APPENDIX SUBMITTED ON A COMPACT DISC AND AN INCORPORATION BY REFERENCE OF THE MATERIAL ON THE COMPACT DISC

Not Applicable

### BACKGROUND OF THE INVENTION

First discovered in 2004, graphene is a one-atom-thick planar sheet of sp2-bonded carbon atoms that are densely packed in a honeycomb crystal lattice. In other words, it consists of a two-dimensional, giant, flat molecule made up of a lattice of carbon atoms, arranged in hexagons, which is only the thickness of an atom.

Graphene was initially obtained by mechanical exfoliation of graphite, using “the sticky-tape method” to repeatedly split graphite crystals into increasingly thinner pieces.

Various other methods for producing graphene have been used such as evaporating a mixture of large carbon-containing molecules and firing it over a heated metal surface such as extremely thin pieces of nickel, followed by dissolving away the nickel with chemicals, then “mounting” the carbonized residue (that may contain graphene) on a flexible polymer.

The various methods of producing graphene that have been published to this date have been useful for small scale production and therefore employed for research purposes only, as the said methods are cumbersome and/or complicated.

Until the advent of this invention, producing graphene on an industrial scale was virtually non-existent, and its production in “workable” quantities (for research purposes) had been very difficult.

This invention proposes various methods of industrial scale production of graphene at a low cost, by the way of carbonizing a compact monolayer [made up of a suitable organic material (or organic compound)]. It also “introduces” new devices/instruments as well as offering improvements to the Langmuir-Blodgett method for the production of a compact monolayer, thereby allowing the industrial scale production of a compact monolayer free of “unwanted materials” to take place at a fast pace.

Graphene possesses many unique properties, such as: being transparent, having remarkable mechanical strength, being bendable and foldable while still retaining its properties, being an excellent conductor of electricity.

Due to its unique electronic properties, graphene may be used to fabricate ultra-fast graphene transistors that operate at GHz or near terahertz frequencies while using less energy compared to the currently available transistors as well as being able to operate at room temperature.

The high electrical conductivity and high optical transparency of graphene make it a candidate for transparent conducting electrodes, required for such applications as touchscreens, liquid crystal displays, organic photovoltaic cells, and organic light-emitting diodes.

Other areas where graphene may be used include: “detection technology” and in the conductive plates of ultracapacitors.

### BRIEF SUMMARY OF THE INVENTION

The objective of this invention is to produce graphene on an “industrial scale”, through straightforward processes, and at a low cost. This invention allows a “patterned” graphene to be produced as the final product, where the said “patterns” may assume the patterns of minute electrical circuits or that of any other “desirable” patterns.

The uniqueness of this invention is that up to this date, there has not been an invention to produce graphene on an industrial scale, let alone possessing the other attributes of this invention i.e. the straightforwardness, the low cost, or the ability to produce the said graphene according to a desired pattern.

This invention is comprised of the following innovations:
1. Various devices/instruments which may be used in the preparation of a compact monolayer [made up of a suitable organic material (or organic compound)] as well as the carbonization of the latter:
   a) Various substrates where some of the said substrates possess a surface that allows for an easy removal of any material(s) that is/are spread/deposited over the said surface; whereas some other substrates possess a surface with desired “patterns” so as to allow a “patterned” carbonization of any material(s) that is/are spread/deposited over the said surface; whereas in the case of some other substrates, each of the said substrates possesses a hollow tube within its body, just below its upper surface, where the said tube runs “back and forth” across the “width/sides” of the said substrate. The function of the said tube is to allow the flow of a suitable fluid of desired temperature (hot or cold) through it so as to raise or reduce the temperature of the said upper surface of the said substrate, thereby facilitating or hindering the removal of any material(s) that is/are spread/deposited over the said upper surface of the said substrate.
   b) Various plates, where the heated surface of each of the said plates carbonizes any organic material (or organic compound) upon coming into contact with them. Some of the said plates possess a surface that allows for an easy removal of any material(s) that is/are adhered to the said surface; whereas some other plates possess a surface with desired “patterns” so as to allow a “patterned” carbonization of the said organic material (or organic compound), as described above; whereas in the case of some other plates, each of the said plates possesses a hollow tube within its body, just below its surface, where the said tube runs “back and forth” across the “width/sides” of the said plate. The function of the said tube is to allow the flow of a suitable fluid of desired temperature (hot or cold) through it so as to raise or reduce the temperature of the said surface of the said plate, thereby facilitating or hindering the removal of any material(s) that is/are spread/deposited over the said surface of the said plate.
   c) Various containers possessing features/components that provide ideal chambers for the preparation of a compact monolayer which is free from all “other” materials that were used in the various processes involved in the preparation of the said compact monolayer.
2. Efficient methods for preparing a compact monolayer which is free from all “other” materials that were used in the various processes involved in the said preparation of the said compact monolayer.
3. Various methods for carbonizing a compact monolayer by means of a suitable “heat source” (which allows the application of a sudden searing “heat” extremely quickly) in order to produce a graphene layer, where the said heat source may be a “hot surface” or a suitable “radiation type beam” such as a suitable laser beam, or a suitable maser beam, or a suitable electron beam.
4. Various methods to provide a protective layer for a graphene layer.

### BRIEF DESCRIPTION OF THE DRAWINGS

FIG. 1 is a cross-sectional elevation view of a substrate, where its upper surface is coated with a layer of a suitable material/substance.

FIG. 2 is a plan, cutaway view of a substrate of appropriate thickness which possesses a hollow tube within its body, just below its upper surface, where the said tube runs “back and forth” across the “width/sides” of the said substrate.

FIG. 2.1 is cross-sectional elevation view of the FIG. 2.

FIG. 3 is a cross-sectional elevation view of a substrate, where its upper surface possesses suitably “raised” patterns.

FIG. 4 is a cross-sectional elevation view of a substrate, where its upper surface possesses suitably “carved/etched” patterns.

FIG. 5 is a cross-sectional elevation view of a substrate identical to that shown in FIG. 3, except that the said substrate also possesses a hollow tube within its body just below its surface, where the said tube runs “back and forth” across its “width/sides”.

FIG. 6 is a cross-sectional elevation view of a substrate identical to that shown in FIG. 4, except that the said substrate also possesses a hollow tube within its body just below its surface, where the said tube runs “back and forth” across its “width/sides”.

FIG. 7 is a cross-sectional elevation view of a substrate identical to that shown in FIG. 1, except that the said substrate also possesses a hollow tube within its body just below its surface, where the said tube runs “back and forth” across its “width/sides”.

FIG. 8 is a cross-sectional elevation view of a substrate identical to that shown in FIG. 3—with the exception that the surface of the said substrate is coated with a layer of a suitable material/substance.

FIG. 9 is a cross-sectional elevation view of a substrate identical to that shown in FIG. 4—with the exception that the surface of the said substrate is coated with a layer of a suitable material/substance.

FIG. 10 is a cross-sectional elevation view of a substrate identical to that shown in FIG. 8, except that the said substrate also possesses a hollow tube within its body just below its surface, where the said tube runs “back and forth” across its “width/sides”.

FIG. 11 is a cross-sectional elevation view of a substrate identical to that shown in FIG. 9, except that the said substrate also possesses a hollow tube within its body just below its surface, where the said tube runs “back and forth” across its “width/sides”.

FIG. 12 is a cross-sectional elevation view of a plate with a smooth surface.

FIG. 13 is a plan, cutaway view of a plate of appropriate thickness which possesses a hollow tube within its body, just below its upper surface, where the said tube runs “back and forth” across the “width/sides” of the said plate.

FIG. 13.1 is cross-sectional elevation view of the FIG. 13.

FIG. 14 is a cross-sectional elevation view of a plate, where its upper surface possesses suitably “raised” patterns.

FIG. 15 is a cross-sectional elevation view of a plate, where its upper surface possesses suitably “carved/etched” patterns.

FIG. 16 is a cross-sectional elevation view of a plate identical to that shown in FIG. 14, except that the said plate also possesses a hollow tube within its body just below its surface, where the said tube runs “back and forth” across its “width/sides”.

FIG. 17 is a cross-sectional elevation view of a plate identical to that shown in FIG. 15, except that the said plate also possesses a hollow tube within its body just below its surface, where the said tube runs “back and forth” across its “width/sides”.

FIG. 18 is a cross-sectional elevation view of a plate identical to that shown in FIG. 12 with the exception that the surface of the said plate is coated with a layer of a suitable material/substance.

FIG. 19 is a cross-sectional elevation view of a plate identical to that shown in FIG. 18, except that the said plate also possesses a hollow tube within its body just below its surface, where the said tube runs “back and forth” across its “width/sides”.

FIG. 20 is a cross-sectional elevation view of a plate identical to that shown in FIG. 14 with the exception that the surface of the said plate is coated with a layer of a suitable material/substance.

FIG. 21 is a cross-sectional elevation view of a plate identical to that shown in FIG. 15 with the exception that the surface of the said plate is coated with a layer of a suitable material/substance.

FIG. 22 is a cross-sectional elevation view of a plate identical to that shown in FIG. 20, except that the said plate also possesses a hollow tube within its body just below its surface, where the said tube runs “back and forth” across its “width/sides”.

FIG. 23 is a cross-sectional elevation view of a plate identical to that shown in FIG. 21, except that the said plate also possesses a hollow tube within its body just below its surface, where the said tube runs “back and forth” across its “width/sides”.

FIG. 24 is a cross-sectional elevation view of a sealed shallow container, consisting of a shallow container and a lid which possesses 2 or more tubes, where the said lid can be secured to the top of the said shallow container so as to seal the latter.

FIG. 25 is a cross-sectional elevation view of a long sealed shallow container with a conveyor belt system placed on its floor along its length, where the said long sealed shallow container consists of a long shallow container and a lid (that possesses a number of tubes) which can be secured to the top of the said long shallow container so as to seal the latter.

FIG. 26 is a cross-sectional elevation view of a long sealed shallow container which is similar to that shown in FIG. 25 with the exception that the length of the conveyor belt system which is used in this version of the invention is shorter than that of the said conveyor belt system shown in FIG. 25 by the magnitude of one of the sides of a shallow tray (in which a compact monolayer is prepared).

FIG. 27 is a cross-sectional elevation view of a long sealed shallow container which is similar to that shown in FIG. 26 with the exception that in this version of the invention, a suitable substrate (as shown in FIGS. 1 thru 11) in the shape of a long strip is positioned in the proximity of the surface of the said conveyor belt, while being held in place by means of a number of rollers, whereas a small portion of the end part of the said conveyor belt system (and the said substrate strip) that is proximal to the said shallow tray is “bent downwards”.

FIG. 28 is a cross-sectional elevation view of a long sealed shallow container which is similar to that shown in FIG. 26 except for the further addition of a “temporary substrate” positioned (and “held in place”) above (and in the proximity of) the upper surface of a suitable substrate (as shown in FIGS. 1 thru 11).

FIG. 29 is a cross-sectional elevation view of a long sealed shallow container which is similar to that shown in FIG. 27 except for the further addition of a “temporary substrate strip” positioned (and “held in place”) in the proximity of the outward surface of a suitable substrate strip as described in FIG. 27.

FIG. 30 is a cross-sectional elevation view of a suitable substrate which is placed at the bottom of a sealed shallow container where an adequate amount of a suitable vehicle is added in the said sealed shallow container in order to produce a monolayer.

FIG. 31 is a cross-sectional elevation view of a sealed shallow container and its contents which is similar to that shown in FIG. 30, where the addition of a “gaseous mixture”, through one of the tubes, into the said sealed shallow container is demonstrated.

FIG. 32 is a cross-sectional elevation view of a sealed shallow container and its contents which is similar to that shown in FIG. 30, where an “encircling instrument” which has “compressed/forced together” the said monolayer described in FIG. 30, in order to form a compact monolayer is demonstrated.

FIG. 33 is a cross-sectional elevation view of a vehicle (which is positioned beneath a compact monolayer inside a sealed shallow container) and a suitable substrate (which is “resting” at the bottom of the said enclosed shallow container).

FIG. 34 is a cross-sectional elevation view of a sealed shallow container and its contents which is similar to that shown in FIG. 33, demonstrating the direction of removal of the gaseous layer above a compact monolayer inside the said sealed shallow container, through a tube (in the lid of the said sealed shallow container), to the outside of the said sealed shallow container while simultaneously replacing it with a “fresh” mixture of gases from outside of the said sealed shallow container, through another tube (in the said lid of the said sealed shallow container).

FIG. 35 is a cross-sectional elevation view of a sealed shallow container and its contents which is similar to that shown in FIG. 33, where a container of an appropriate size (which is placed inside the said sealed shallow container, at a level above the said compact monolayer) is demonstrated.

FIG. 36 is a cross-sectional elevation view of a sealed shallow container and its contents which is similar to that shown in FIG. 33, where a suitable transparent or opaque substance over the top surface of the said compact monolayer is demonstrated.

FIG. 37 is a cross-sectional elevation view of a sealed shallow container and its contents which is similar to that shown in FIG. 36, where a plate of suitable dimensions held at a suitable angle on top of a compact monolayer (in such a manner that one end of the said plate which is proximal to the said compact monolayer just barely touches the latter at an appropriate angle) is demonstrated.

FIG. 38 is a cross-sectional elevation view of a sealed shallow container and its contents which is similar to that shown in FIG. 36, where a plate of suitable dimensions held at a suitable angle on top of a vehicle (on an area beyond the boundary of a compact monolayer, where the surface of the said vehicle is not covered by the said compact monolayer) in such a manner that one end of the said plate which is proximal to the said vehicle just barely touches the surface of the latter at an appropriate angle is demonstrated.

FIG. 39 is a cross-sectional elevation view of a sealed shallow container and its contents which is similar to that shown in FIG. 36, demonstrating the “mechanical” removal of a “set” film (with a compact monolayer adhered to its lower surface) from the top of a vehicle, by “grasping” (e.g. by means of suitable tweezers or pliers) and “peeling off” the said set film from the top of the said vehicle.

FIG. 40 is a cross-sectional elevation view of a sealed shallow container and its contents which is similar to that shown in FIG. 36, where a suitable number of holes at the bottom of the said sealed shallow container is demonstrated.

FIG. 41 is a cross-sectional elevation view of a sealed shallow container and its contents which is similar to that shown in FIG. 40, except for the absence of the said suitable number of holes at the bottom of the said sealed shallow container, in order to satisfy another embodiment of the invention.

FIG. 42 is a cross-sectional elevation view of a sealed shallow container and its contents which is similar to that shown in FIG. 33, according to another embodiment of the invention.

FIG. 43 is a cross-sectional elevation view of a “Hamid Substrate” which has come into contact with a compact monolayer spread/deposited directly on the upper surface of a suitable substrate according to another embodiment of the invention.

FIG. 44 is a cross-sectional elevation view of a long sealed shallow container and its contents which is similar to that shown in FIG. 25, demonstrating a shallow tray and its contents (a suitable substrate, at the bottom of the said shallow tray, and a compact monolayer floating on top of a suitable vehicle) which is placed over the conveyor belt (inside the said long sealed shallow container), as well as demonstrating a number of appropriate sized containers (each containing the required suitable material according to another embodiment of the invention) which are placed at numerous locations along the entire length of the said long sealed shallow container at a level above the said compact monolayer.

FIG. 45 is a cross-sectional elevation view of a long sealed shallow container and its contents which is similar to that shown in FIG. 26, demonstrating the contents of a shallow tray (a suitable substrate at the bottom of the said shallow tray and a compact monolayer floating on top of a suitable vehicle).

FIG. 46 is a cross-sectional elevation view of a long sealed shallow container and its contents which is similar to that shown in FIG. 27, demonstrating the contents of a shallow tray (a compact monolayer floating on top of a suitable vehicle and an “encircling instrument”).

FIG. 47 is a cross-sectional elevation view of a compact monolayer which is “sandwiched” between 2 suitable vehicles inside a shallow tray.

FIG. 48 is a cross-sectional elevation view of a long sealed shallow container and its contents which is similar to that shown in FIG. 45, except that in this version of the invention, a compact monolayer is “sandwiched” between 2 suitable vehicles.

FIG. 49 is a cross-sectional elevation view of a long sealed shallow container and its contents which is similar to that shown in FIG. 46, except that in this version of the invention, a compact monolayer is “sandwiched” between 2 suitable vehicles.

FIG. 50 is a cross-sectional elevation view of a long sealed shallow container and its contents which is similar to that shown in FIG. 45, except that a “temporary substrate” is positioned (and “held in place”) above (and in the proximity of) the upper surface of a suitable substrate.

FIG. 51 is a cross-sectional elevation view of a long sealed shallow container and its contents which is similar to that shown in FIG. 50, except that in this version of the invention, a compact monolayer is “sandwiched” between 2 suitable vehicles.

FIG. 52 is a cross-sectional elevation view of a long sealed shallow container and its contents which is similar to that shown in FIG. 46, except that a “temporary substrate strip” is positioned (and “held in place”) in the proximity of the outward surface of a suitable substrate strip.

FIG. 53 is a cross-sectional elevation view of a long sealed shallow container and its contents which is similar to that shown in FIG. 52, except that in this version of the invention, a compact monolayer is “sandwiched” between 2 suitable vehicles.

FIG. 54 is a cross-sectional elevation view of a compact monolayer which is spread/deposited directly on the surface of a temporary substrate.

FIG. 54.1 is a cross-sectional elevation view of a pane which is positioned in the proximity of the “lower surface” of a suitable substrate on which a compact monolayer is sandwiched between the later and a temporary substrate according to a further embodiment of the invention.

FIG. 55 is a cross-sectional elevation view of a long sealed shallow container and its contents which is similar to that shown in FIG. 45, except that a “suitably strong” magnet is positioned (and “held in place”) above (and in the proximity of) the upper surface of a compact monolayer.

FIG. 56 is a cross-sectional elevation view of a long sealed shallow container and its contents which is similar to that shown in FIG. 46, except that a “suitably strong” magnet is positioned (and “held in place”) above (and in the proximity of) the upper surface of a compact monolayer.

FIG. 57 is a cross-sectional elevation view of a long sealed shallow container and its contents which is similar to that shown in FIG. 48, except that a “suitably strong” magnet is positioned (and “held in place”) above (and in the proximity of) the upper surface of a compact monolayer.

FIG. 58 is a cross-sectional elevation view of a long sealed shallow container and its contents which is similar to that shown in FIG. 49, except that a “suitably strong” magnet is positioned (and “held in place”) above (and in the proximity of) the upper surface of a compact monolayer.

FIG. 59 is a cross-sectional elevation view of a compact monolayer which is “sandwiched” between two “suitable surfaces” according to another embodiment of the invention.

### DETAILED DESCRIPTION OF THE INVENTION

### Definitions of Some of the Words Encountered in this Text/Document

Carbonization: In this document, it means the conversion of an organic compound (or an organic material) into carbon (or a carbon-containing residue) through pyrolysis, by exposing the said organic compound (or organic material) to a sudden searing “heat” extremely quickly so as to turn the said organic compound (or organic material) into solid carbon.
Compact monolayer: In this document, it means a monolayer which is compressed so as to produce a monolayer of desired compactness.
Doped compact monolayer: In this document, it means a compact monolayer which is doped by a suitable conventional method.
Doping: In this document, it means the process of intentionally introducing impurities into an extremely pure semiconductor to change its electrical properties.
Equilibrium vapor pressure: In this document, it means the pressure of a vapor in equilibrium with its non-vapor (or liquid) phase.
Graphene: In this document, it means a one-atom-thick planar sheet of sp2-bonded carbon atoms that are densely packed in a honeycomb crystal lattice. In other words, it consists of a two-dimensional, giant, flat molecule made up of a lattice of carbon atoms, arranged in hexagons, which is only the thickness of an atom.
Hamid Substrate: In this document, it means a thin, flexible and foldable opaque or transparent sheet which is covered on one side by a thin layer of a suitable opaque or transparent adhesive material, while the other side of the said sheet remains adhesive free.
Monolayer: In this document, it means a one-molecule thick layer of a substance.
Organic compound: In this document, it means any member of a large class of chemical compounds whose molecules contain carbon.
Organic material: In this document, it means matter that has come from a once-living organism; is capable of decay or the product of decay; or is composed of organic compounds.
Partial pressure: In this document it means, in a mixture of ideal gases, each gas has a partial pressure which is the pressure which the gas would have if it alone occupied the volume.
Substrate: In this document, it means the slab/material upon which a monolayer is spread/deposited (e.g. a plate of glass or a thin layer/sheet of another suitable synthetic material which may also be flexible and/or foldable).
Vehicle: In this document, it means a layer of a suitable liquid which is immiscible and non-reactant with the organic compound (or the organic material) which is to be used in the processes that are described in the inventions described in this document/text. The said organic compound (or the organic material) does not dissolve in the said vehicle. The said vehicle should have another property, which is, the vehicle should always allow the said organic compound (or organic material) to float on top of the said vehicle, or in other words, the vehicle should always position itself directly below the said organic compound (or organic material).

The invention described within is comprised of a “two stage” process of preparing a compact monolayer, and its subsequent conversion into carbon atoms by carbonization; plus various devices/instruments which may be used in various processes involved in the said two stages.

### Detailed Description of Various Devices/Instruments

A suitable substrate 1, which could be any of substrates A, B, C, D, E, F, B1, C1, D1, E1 or F1 described in versions 1, 2, 3, 4, 5 or 6 below.

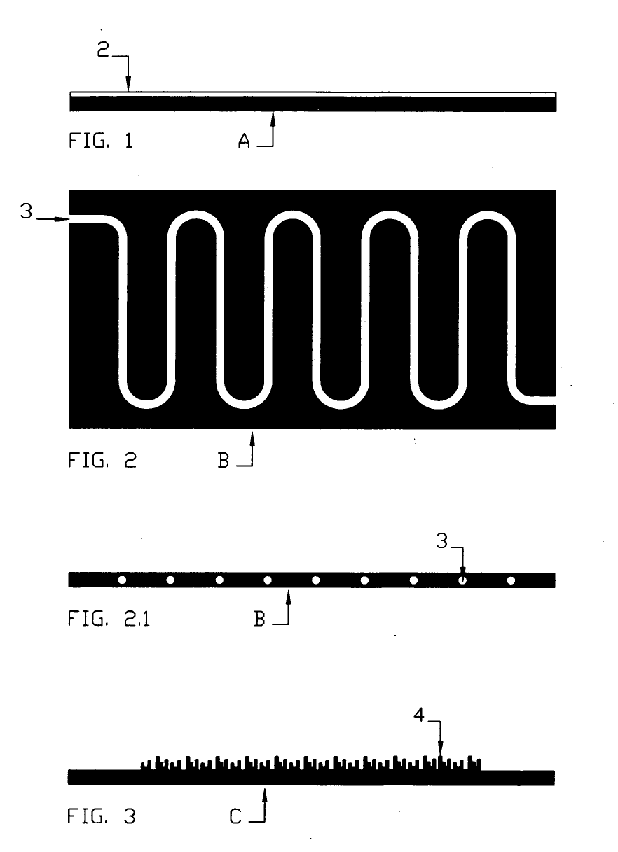

Version 1: Referring to FIG. 1: According to this version of the invention, the upper surface of a substrate A (made up of a suitable material) is coated, by a suitable method, with a layer of a suitable material/substance 2 where the latter may be a suitable non-stick material (e.g. Teflon) or a suitable “dissolvable” substance.

The non-stick surface of a “non-stick coated” substrate A, as described above, enables an easy removal of any material(s) that is/are spread/deposited on the said non-stick surface.

Where a substrate A coated with a suitable dissolvable substance is used, any material(s) that is/are spread/deposited/adhered on the surface of the said substrate A could be “removed”/detached from the said “dissolvable coating/surface” by dissolving the said “dissolvable coating/surface” using (a) suitable chemical reagent(s). It may be desirable to initially “peel off”/“cut out”/separate the said dissolvable coating/surface [with the said spread/deposited material(s) still adhered to the said dissolvable coating/surface] from the said substrate A before the said chemical treatment.

Version 2: Referring to FIGS. 2 and 2.1: This version of the invention is comprised of a substrate B (made up of a suitable material) of appropriate thickness which possesses a hollow tube 3 within its body, just below its upper surface, where the said tube 3 runs “back and forth” across the “width/sides” of the said substrate B.

The function of the said tube 3 is to allow the flow of a suitable fluid of desired temperature (hot or cold) through it so as to raise or reduce the temperature of the said upper surface of the said substrate B, thereby facilitating or hindering the removal of any material(s) that is/are spread/deposited over the said upper surface of the said substrate.

Version 3: Referring to FIG. 3: This version of the invention is comprised of a substrate C (made up of a suitable material), the upper surface of which possesses suitably “raised” patterns 4, where the latter may assume the patterns of minute electrical circuits or that of any other “desirable” patterns.

The function of the said raised patterns 4 on the said surface of the said substrate C is to allow the “instantaneous” carbonization of a compact monolayer (as described in version 23) which is resting/deposited on the said surface of the said substrate C to take place, upon coming into contact with a suitably hot plate (as described in versions 7, 8, 9, 10 and 11), only in the said raised areas, thus producing a “patterned graphene”. The said compact monolayer is produced as described in version 18.

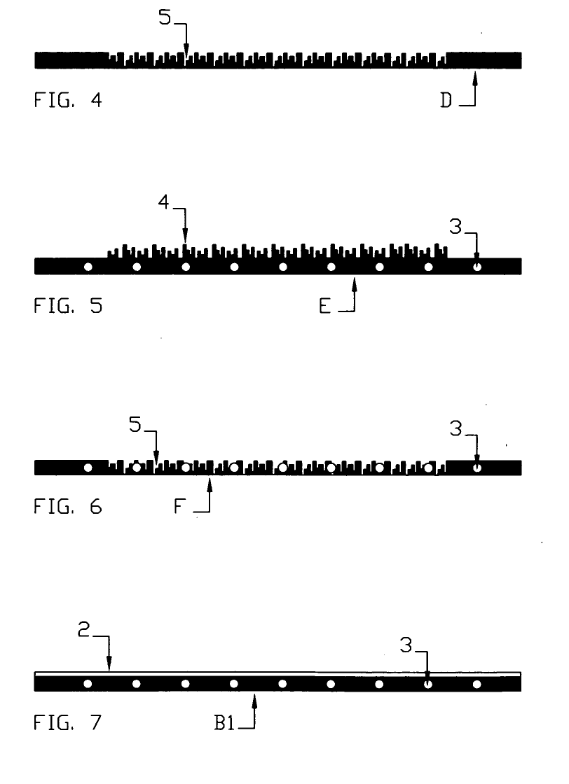

Version 4: Referring to FIG. 4: This version of the invention is comprised of a substrate D (made up of a suitable material), the upper surface of which possesses suitably “carved/etched” patterns 5, where the latter may assume the patterns of minute electrical circuits or that of any other “desirable” patterns.

The function of the said carved/etched patterns 5 on the said surface of the said substrate D is to allow the “instantaneous” carbonization of a compact monolayer (as described in version 23) which is resting/deposited on the said surface of the said substrate D to take place, upon coming into contact with a suitably hot plate 6 (as described in versions 7, 8, 9, 10 and 11), in all the areas of the said compact monolayer except in the said carved/etched areas, thus “converting” the said compact monolayer into a graphene layer possessing within it “uncarbonized patterns” where the latter correspond to the said carved/etched patterns 5.

Version 5: Referring to FIGS. 5 and 6: This version of the invention is comprised of substrates E and F which are identical to the substrates as described in versions 3 and 4 above, except that in this version of the invention, the said substrates E and F possess hollow tubes 3 within their bodies just below their surfaces, where the said tubes 3 run “back and forth” across “width/sides” of the said substrates E and F.

The function of the said tubes 3 are to allow the flow of a suitable fluid of desired temperature (hot or cold) through them so as to raise or reduce the temperature of the said surfaces of the said substrates E and F, thereby facilitating or hindering the removal of any carbonized material(s) that is/are “residing” on the said surfaces.

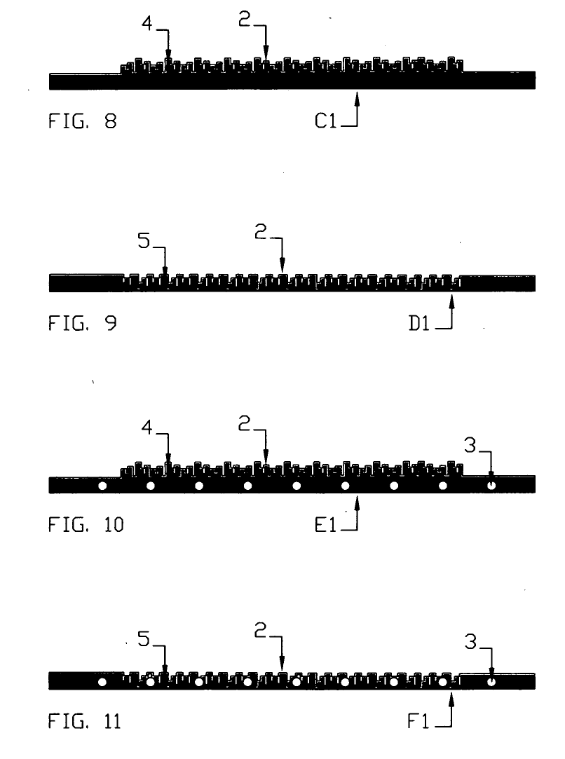

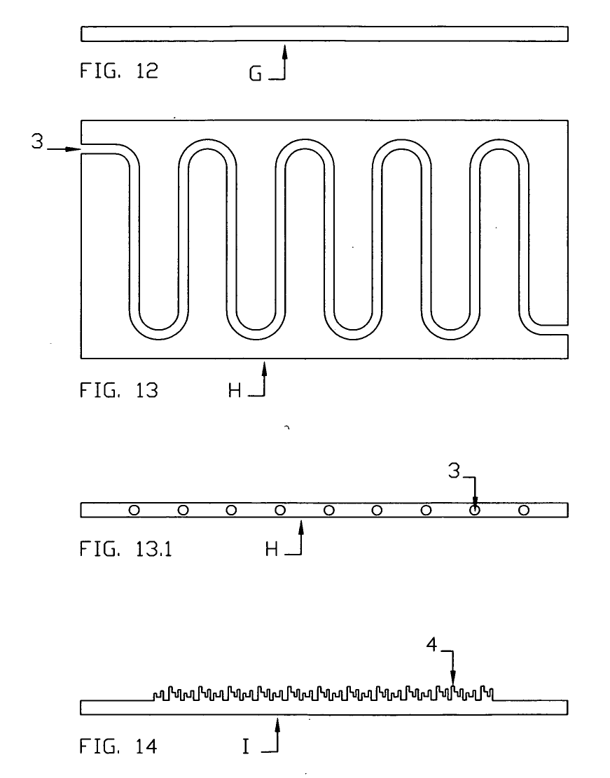

Version 6: Referring to FIGS. 7, 8, 9, 10 and 11: This version of the invention is comprised of substrates B1, C1, D1, E1 and F1 which are identical to the substrates as described in versions 2, 3, 4 and 5 above, except that in this version of the invention, the said surfaces of the said substrates B1, C1, D1, E1 and F1 are coated, by a suitable method, with a layer of a suitable material/substance 2 where the latter may be a suitable non-stick material (e.g. Teflon) or a suitable “dissolvable” substance.

The non-stick surface of a “non-stick coated” substrate, as described above, enables an easy removal of any material(s) that is/are spread/deposited on the said non-stick surface.

Where a substrate coated with a suitable dissolvable substance is used, any material(s) that is/are spread/deposited/adhered on the said surface of the said substrate could be “removed”/detached from the said “dissolvable coating/surface” by dissolving the said “dissolvable coating/surface” using (a) suitable chemical reagent(s). It may be desirable to initially “peel off”/“cut out”/separate the said dissolvable coating/surface [with the said spread/deposited material(s) still adhered to the said dissolvable coating/surface] from the said substrate before the said chemical treatment.

A suitable plate 6, which could be any of plates G, H, I, J, K, L, G1, H1, I1, J1, K1 or L1 described in versions 7, 8, 9, 10, 11 and 12 below.

Version 7: Referring to FIG. 12: This version of the invention is comprised of a plate G (made up of a suitable material which enables it to be heated to suitably high temperatures) with a smooth surface.

The function of the said plate G is (after being initially heated to a suitable temperature by a suitable method) to “instantaneously” carbonize a compact monolayer (as described in version 23) which is resting/deposited on the surface of a substrate upon coming in contact with the latter, thus “converting” the said compact monolayer into a graphene layer.

Version 8: Referring to FIGS. 13 and 13.1: This version of the invention is comprised of a plate H (made up of a suitable material) of appropriate thickness which possesses a hollow tube 3 within its body, just below its surface, where the said tube 3 runs “back and forth” across the “width/sides” of the said plate H.

The function of the said tube 3 is to allow the flow of a suitable fluid of desired temperature (hot or cold) through it so as to raise or reduce the temperature of the said surface of the said plate H, thereby facilitating or hindering the removal of any carbonized material(s) that is/are “residing” on the said surface.

Version 9: Referring to FIG. 14: This version of the invention is comprised of a plate I (made up of a suitable material which enables it to be heated to suitably high temperatures) possessing raised “patterns” 4 on its surface, where the latter may assume the “patterns” of minute electrical circuits or that of any other “desirable” patterns.

The function of the said “patterned” plate I is (after being initially heated to a suitable temperature by a suitable method) to “instantaneously” carbonize a compact monolayer (as described in version 23) which is resting/deposited on the surface of a substrate only in those raised areas 4 upon coming in contact with the said compact monolayer thus “converting” the said compact monolayer into a “patterned” graphene layer.

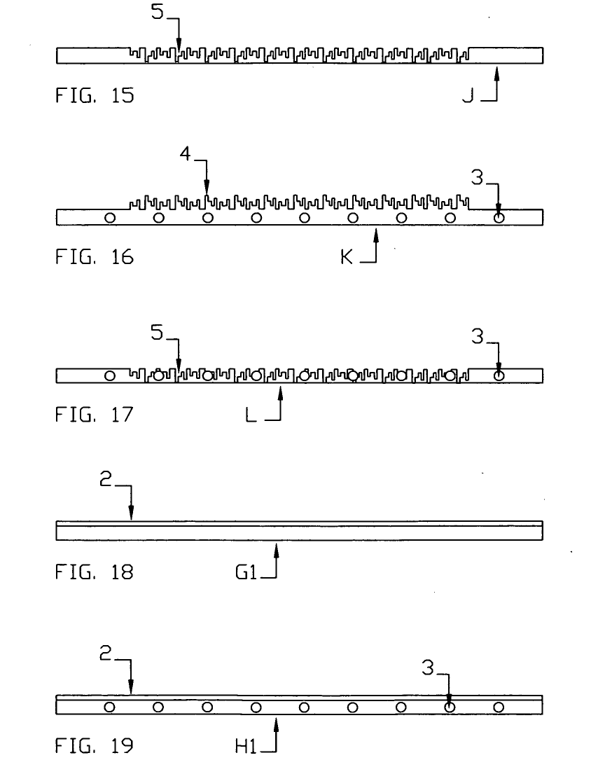

Version 10: Referring to FIG. 15: This version of the invention is comprised of a plate J (made up of a suitable material which enables it to be heated to suitably high temperatures) possessing “carved/etched” patterns 5 on its surface, where the said carved/etched patterns 5 may assume the patterns of minute electrical circuits or that of any other “desirable” patterns.

The function of the said “patterned” plate J is (after being initially heated to a suitable temperature by a suitable method) to “instantaneously” carbonize a compact monolayer (as described in version 23) which is resting/deposited on the surface of a substrate in all the areas of the said compact monolayer except in the said carved/etched areas 5, thus “converting” the said compact monolayer into a graphene layer possessing within it “uncarbonized patterns” where the latter correspond to the said carved/etched patterns 5.

Version 11: Referring to FIGS. 16 and 17: This version of the invention is comprised of plates “K” and “L” which are identical to the plates as described in versions 9 and 10, except that in this version of the invention, the said plates K and L possess hollow tubes 3 within their bodies, just below their surfaces, where the said tubes 3 runs “back and forth” across the “width/sides” of the said plates K and L.

The function of the said tubes 3 are to allow the flow of a suitable fluid of desired temperature (hot or cold) through them so as to raise or reduce the temperature of the said surfaces of the said plates K and L, thereby facilitating or hindering the removal of any material(s) that is/are “residing” on the said surface.

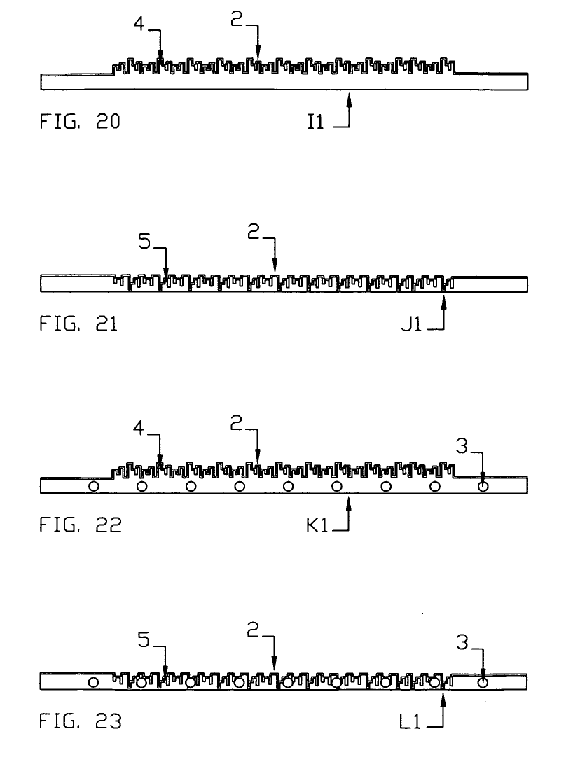

Version 12: Referring to FIGS. 18, 19, 20, 21, 22 and 23: This version of the invention is comprised of plates G1, H1, I1, J1, K1 and L1 which are identical to the plates G, H, I, J, K and L as described in versions 7, 8, 9, 10 and 11, except that in this version of the invention, the said surfaces of the said plates are coated, by a suitable method, with a layer of a suitable material/substance 2 where the latter may be a suitable non-stick material (e.g. Teflon) or a suitable “dissolvable” substance.

The non-stick surface of a “non-stick coated” plate, as described above, enables an easy removal of any material(s) that is/are “attached”/adhered to the said non-stick surface.

Where a plate coated with a suitable dissolvable substance is used, any material(s) that is/are spread/deposited/adhered on the said surface of the said plate could be “removed”/detached from the said “dissolvable coating/surface” by dissolving the said “dissolvable coating/surface” using (a) suitable chemical reagent(s). It may be desirable to initially “peel off”/“cut out”/separate the said dissolvable coating/surface [with the said spread/deposited material(s) still adhered to the said dissolvable coating/surface] from the said plate before the said chemical treatment.

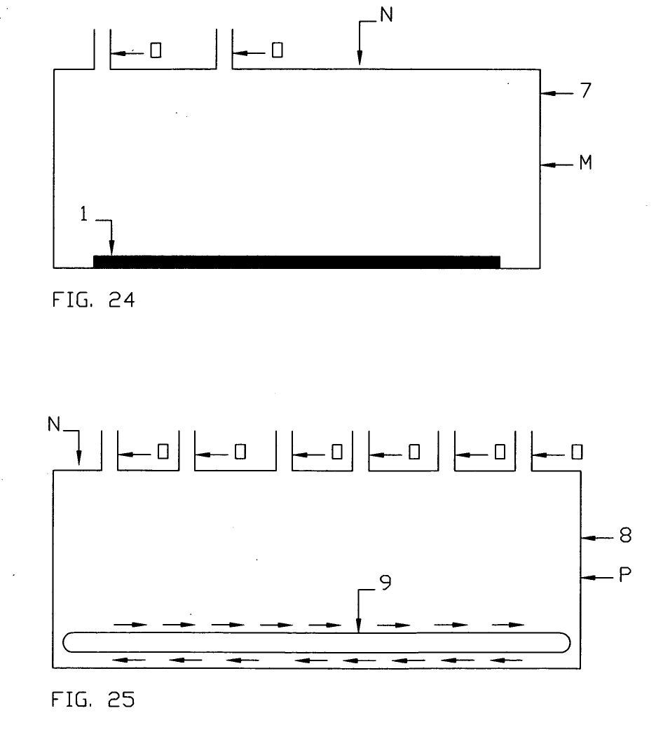

Version 13: Referring to FIG. 24: A sealed shallow container 7, consisting of a shallow container M and a lid N which possesses 2 or more tubes O, where the said lid N can be secured to the top of the said shallow container M so as to seal the latter.

The said sealed shallow container 7 is used for preparing a compact monolayer (as described in version 18), where the former is large enough to allow a suitable substrate 1 to be placed on its “floor” horizontally.

The purpose of the said tubes O in the said lid N is to connect the inside of the said sealed shallow container 7 to the outside, thus allow the introduction and the removal of gaseous materials into and out of the said sealed shallow container 7.

Version 14: Referring to FIG. 25: A long sealed shallow container 8 with a conveyor belt system 9 placed on its floor along its length, where the said long sealed shallow container 8 consists of a long shallow container P and a lid N (that possesses a number of tubes O) which can be secured to the top of the said long shallow container P so as to seal the latter.

The said long sealed shallow container 8 resembles the sealed shallow container 7 as described in version 13, above, except that in this version of the invention, the length of the said long sealed shallow container 8 is many times greater than its width, thus the long portion of the said long sealed shallow container 8 resembles a “long corridor”.

The purpose of the said conveyor belt system 9 is to transport any object that is placed over it, from one end of the said long corridor to its other end.

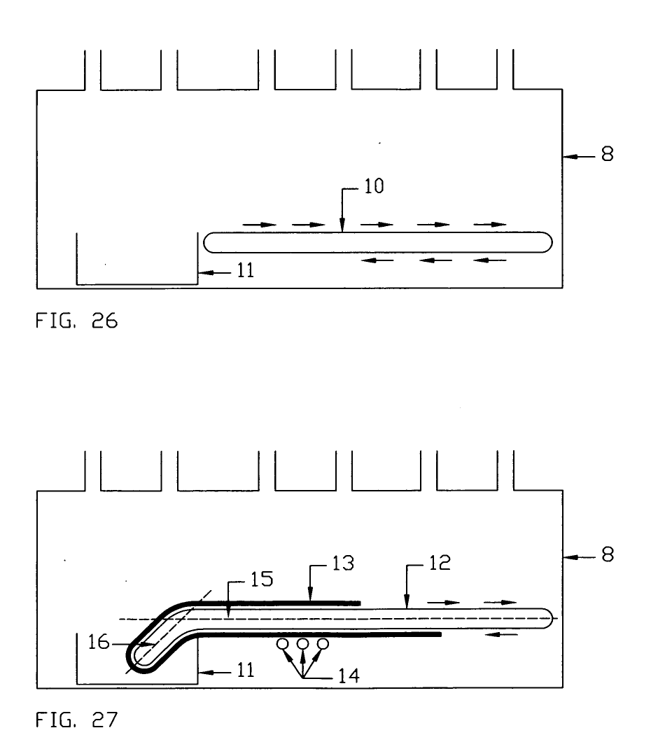

Version 15: Referring to FIG. 26: A long sealed shallow container which is identical to the long sealed shallow container 8 as described in version 14, with a conveyor belt system 10 placed on its floor along its length, except that the length of the conveyor belt system 10 which is used in this version of the invention is shorter than that of the said conveyor belt system 9 in version 14 by the magnitude of one of the sides of a shallow tray 11 (in which a compact monolayer is prepared) in such a manner that when the said shallow tray 11 is placed on the floor of the said long sealed shallow container 8, close to one of its ends, one end of the said conveyor belt system 10 is positioned at the proximity of the side of the said shallow tray 11 which is facing the said long corridor as describe in version 14, while the other end of the said conveyor belt system 10 is positioned at the proximity of the other end of the said long corridor.

Version 16: Referring to FIG. 27: A long sealed shallow container which is identical to the long sealed shallow container 8 as described in version 15, with a conveyor belt system 12 placed on its floor along its length except that in this version of the invention, a suitable substrate (as described in claims 1, 2, 3, 4, 5 and 6) in the shape of a long strip 13 which is made up of a suitable material is positioned in the proximity of the surface of the said conveyor belt system 12, while being held in place by means of a number of rollers 14, whereas a small portion of the end part of the said conveyor belt system 12 (and the said substrate strip 13) that is proximal to the said shallow tray 11 is “bent downwards”.

Upon switching on the said conveyor belt system 12, the portion of the said substrate strip 13 that lies below the central axis 15 & 16 of the former will continuously “travel” in the direction towards the end part (apex) of the said conveyor belt system 12, while the portion of the said substrate strip 13 that lies above the said central axis 15 & 16 travels in the direction away from the said end part (apex) of the said conveyor belt system 12.

Version 17: Referring to FIG. 28: This version of the invention is comprised of a “temporary substrate” 17 positioned (and “held in place”) above (and in the proximity of) the upper surface of a suitable substrate 1 as described in versions 1, 2, 3, 4, 5 and 6, by suitable means; therefore, the said suitable substrate 1 and the said temporary substrate 17 continue to keep their positions “unchanged” relative to one another at all times i.e. when the said suitable substrate 1 rises, then, the said temporary substrate 17 also rises at exactly the same rate of speed, thus keeping the distance separating them constant.

One of the properties of the said temporary substrate 17 is that it should be adequately thin so as to allow “passage/penetration” of “electrostatic forces” or allow “passage/penetration” of magnetic field (“possessed/produced” by a suitable magnet) to take place effectively and efficiently across its width.

Another property of the said temporary substrate 17 is that it does not adversely interfere with the electrostatic charges that might be carried by any other components that are involved in various processes (in the various versions of the invention) i.e. the said temporary substrate 17 does not cause the electrostatic charges carried by any other components involved in various processes to be “neutralized”.

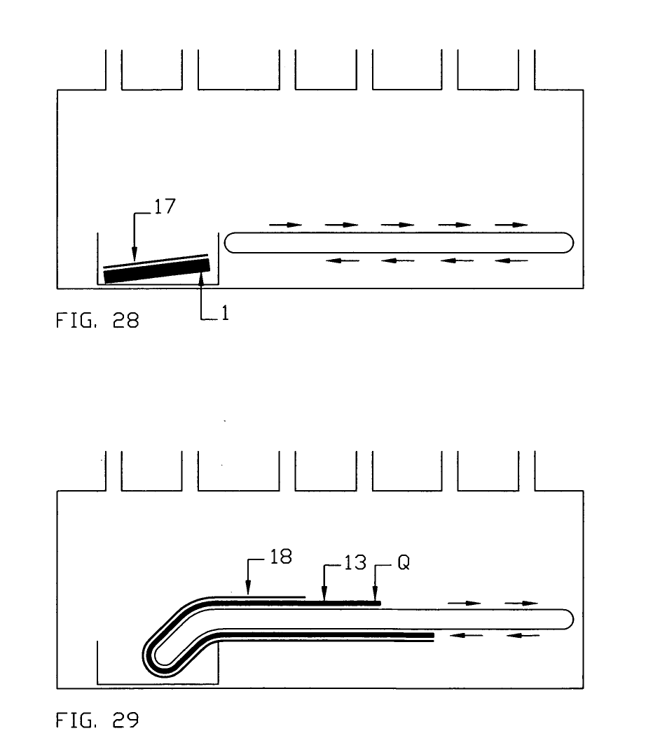

Version 18: Referring to FIG. 29: This versions of the invention is comprised of a “temporary substrate strip”18 positioned (and “held in place”) in the proximity of the outward surface Q of a suitable substrate strip 13 as described in version 16 of the invention, by suitable means; therefore, the said temporary substrate strip 18 and the said suitable substrate strip 13 continue to keep their positions “unchanged” relative to one another throughout the processes involved in this version of the invention i.e. when the said suitable substrate strip 13 moves (in the direction mentioned in claim 16), then, the said temporary substrate strip 18 also moves in the same direction as the said suitable substrate strip 13 at exactly the same rate of speed while keeping the distance separating them constant.

One of the properties of the said temporary substrate strip 18 is that it should be adequately thin so as to allow “passage/penetration” of “electrostatic forces” or allow “passage/penetration” of magnetic field (“possessed/produced” by a suitable magnet) to take place effectively and efficiently across its width.

Another property of the said temporary substrate strip 18 is that it does not adversely interfere with the electrostatic charges that might be carried by any other components that are involved in various processes (in the various versions of the invention) i.e. the said temporary substrate strip 18 does not cause the electrostatic charges carried by any other components involved in various processes to be “neutralized”.

### Detailed Description of a “Two Stage” Process of Preparing a Compact Monolayer, Followed by the Conversion of the Latter Into Carbon (or a Carbon-Containing Residue) by Carbonization

Stage 1: Preparing a compact monolayer, made up of a suitable organic material (or organic compound) which is spread/deposited on a suitable substrate 1.

Stage 2: “Converting” the said compact monolayer, which is spread/deposited on the said suitable substrate 1, into carbon (or a carbon-containing residue) by carbonization, so as to result in a single layer of graphene.

In order to achieve the objective of stage 1, above, first a suitable substrate 1 should be “submerged in” a suitable vehicle, and positioned at a suitable level below the surface of the said suitable vehicle.

Then, a compact monolayer, made up of a suitable organic material (or organic compound) which floats on top of the said vehicle, should be prepared.

Then, the said vehicle, which lies directly below the said compact monolayer, should be “removed” so that the said compact monolayer can spread/deposit itself directly on top of the said suitable substrate 1.

Preparing a Monolayer which Floats on Top of a Vehicle:

There are a number of conventional methods to prepare a monolayer; two of which are described below:

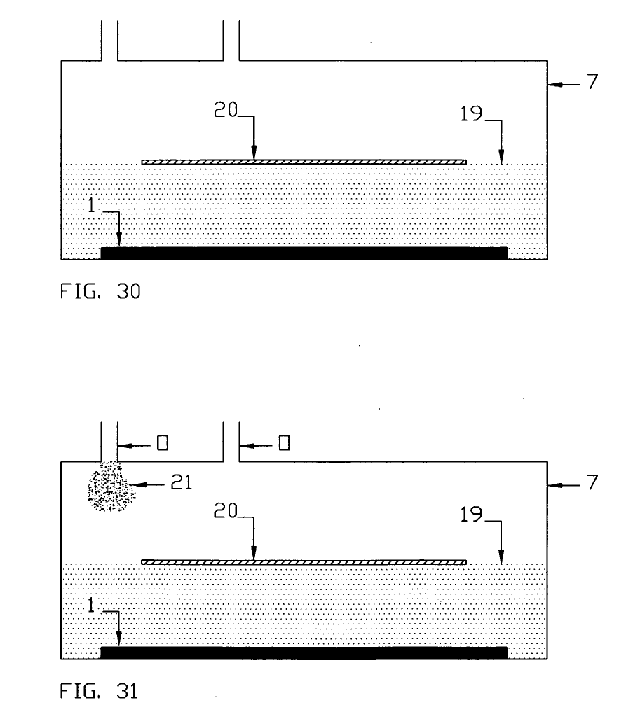

1. Liquid-liquid method: Referring to FIG. 30, a suitable substrate 1 is placed on the “floor” of a sealed shallow container 7.

Then, an adequate amount of a suitable vehicle 19 (which is in a liquid phase) is added on top of the said suitable substrate 1 in the said sealed shallow container 7.

Next, an adequately small amount of a suitable organic material (or organic compound), which is in a liquid phase and is non-reactant and immiscible with the said vehicle 19, is “gently introduced/added” to the top of the said vehicle 19 so as to form a monolayer 20 on top of the said vehicle 19.

2. Gas-liquid method: Referring to FIG. 31, the said suitable substrate 1 is placed on the “floor” of the sealed shallow container 7.

Next, an adequate amount of the suitable vehicle 19 (which is in a liquid phase) is added on top of the said suitable substrate 1 in the said sealed shallow container 7.

Next, an adequate amount of a “gaseous mixture” 21 is added into the said sealed shallow container 7 through one of the said tubes O. The said gaseous mixture 21 is made up of a mixture of a suitable gaseous organic material (or organic compound) plus an inert gas; in addition, the components of the said gaseous mixture possess the following attributes:
a. The said inert gas should remain in a gaseous state throughout the processes that follow.
b. The said components of the said gaseous mixture 21 should neither react with the said vehicle 19, nor should they dissolve nor suspend into the said vehicle 19.
c. When the said organic material (or organic compound) component of the said gaseous mixture 21 is “forced” to liquefy (at a later stage), the said liquefied organic material (or organic compound) should be immiscible and non-reactant with the said vehicle 19.

The amount and the partial pressure of the said gaseous organic material (or organic compound) introduced into the said sealed shallow container 7, as well as the ambient atmospheric pressure and the ambient temperature inside the said sealed shallow container 7 are adjusted so as to liquefy precisely that amount of the said gaseous organic material (or organic compound) that is necessary to form a monolayer 20 of the said organic material (or organic compound) to float on top of the said vehicle 19.

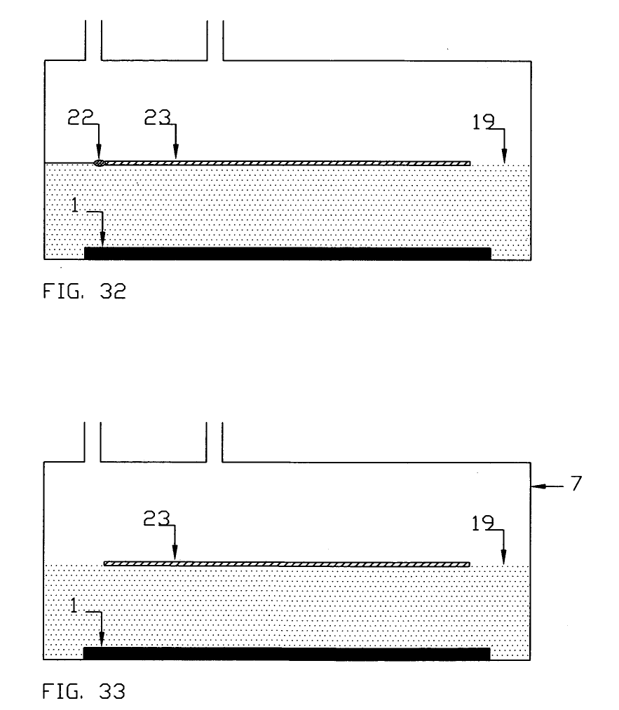

Referring to FIG. 32: Following the formation of the said monolayer 20 by one of the conventional methods (FIGS. 30 and 31), the outside perimeter of the said monolayer 20 is then “encircled” by a suitable “encircling instrument” 22, (e.g. a flexible filament/thread coated with a non-stick material).

The said “encircling instrument” 22, is then allowed to perform two tasks: firstly, to “compress/force together” the said monolayer 20 (FIGS. 30 and 31) so as to make a monolayer that exists in one “continuous” piece (in cases where the said monolayer 20 exists in more than one piece and each piece is floating on the surface of the said vehicle 19 like an “island” or where there are “gaps/fissures” in the said monolayer 20); and secondly, to “compress” the said monolayer 20 to produce a monolayer of desired “compactness”. The result is an enclosed compact monolayer 23 which is in one piece and floating on top of the said vehicle 19.

The remaining surface of the said vehicle 19 which is not covered by the said compact monolayer 23, i.e. the area lying to the outside of the said “encirclement”, is left free of the said organic material (or organic compound), and thus in direct contact with the gaseous phase above.

The force applied in the said compression/forcing together is closely monitored by means of a suitable device so as to warn the operator to stop increasing the magnitude of the said applied force before the system reaches the point where the said compact monolayer 23 “breaks” and forms a double layer, by sliding one layer over the top of (or below) the “broken layer/piece”.

The next step, after the formation of the said compact monolayer 23 in one piece, is to allow the said compact monolayer 23 to be spread/deposited over (or on top of) the said suitable substrate 1, which is achieved by “removing” the said vehicle 19 by means of a suitable method, without “disturbing” the said compact monolayer 23 as described below.

Version 19: Referring to FIG. 33: Promoting a continuous evaporation, at a desirable rate, of the said vehicle 19 which is positioned beneath the said Compact monolayer 23 [made up of a suitable organic material (or organic compound)] according to the method described in version 19A bellow {where the said compact monolayer 23 which is floating on top of the said vehicle 19 is first produced by one of the conventional methods and then “compressed” [inside the said sealed shallow container 7 according to “Stage 1: Preparing a compact monolayer (FIG. 32)”]}, followed by the removal of the said continuously evaporated vehicle 19 from inside the said sealed shallow container 7, by one of the methods described in versions 19B, 19C, 19C1, 19C2, 19C3, or 19C4 below, thus causing/allowing the said compact monolayer 23 to be spread/deposited directly on a suitable substrate 1 (as described in versions 1, 2, 3, 4, 5 and 6) which is “resting” at the bottom of the said enclosed shallow container 7.

Version 19A: Promoting a continuous evaporation, at a desirable rate, of the said vehicle 19 as described in version 19 above (to take place only from the part of the surface of the said vehicle 19 that is not covered by the said compact monolayer 23), while at the same time preventing the said compact monolayer 23 from undergoing a net quantitative or a net qualitative change, as well as preventing the said compact monolayer 23 and the said vehicle 19 from coming to a boil, all achieved by ensuring the following conditions/criteria are met:
a) The temperature of the system (i.e. contents inside the said sealed shallow container 7) is kept at a value/magnitude that is lower than that of the boiling point of an immiscible mixture which is made up of the said vehicle 19 and the said organic material (or organic compound) present in the said compact monolayer 23, under the ambient atmospheric pressure inside the said sealed shallow container.
b) The ambient atmospheric pressure inside the said sealed shallow container 7 is kept at a value/magnitude which prevents the said compact monolayer 23 [made up of a suitable organic material (or organic compound)] or the said vehicle 19 from coming to a boil at the temperature of the system (i.e. contents inside the said sealed shallow container 7).
c) The vapor pressure of the said organic material (or organic compound) inside the said sealed shallow container 7 is constantly kept at a value that ensures the net amount of the said organic material (or organic compound) present in the said compact monolayer 23 remains unchanged [i.e. the amount of the said organic material (or organic compound) which is evaporated and removed from the said compact monolayer 23 into the “gaseous layer” above the said compact monolayer 23 equals the amount of the said organic material (or organic compound) which is liquefied from the said gaseous layer and added/deposited onto the said compact monolayer 23].
d) The vapor pressure of the said vehicle 19 inside the said sealed shallow container 7 is constantly kept at a low enough magnitude in such a manner as to ensure a steady evaporation of the said vehicle 19, achieved by a constant and steady removal of the said gaseous form of the said vehicle 19 from the said gaseous phase above the said compact monolayer 23 inside the said sealed shallow container 7, through one of the methods as described in versions 19B, 19C, 19C1, 19C2, 19C3, and 19C4 below.

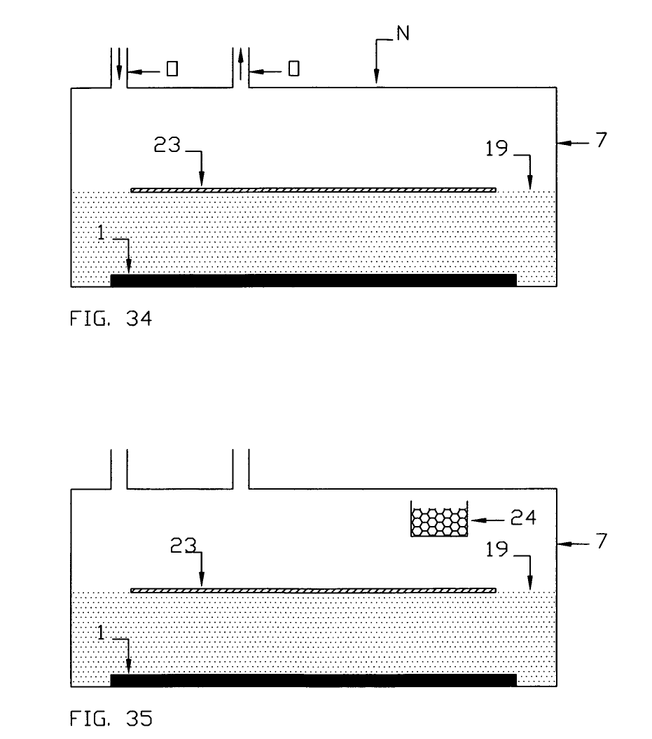

Version 19B: Referring to FIG. 34: Removal of the gaseous form of the said vehicle 19 (i.e. the portion of the said vehicle 19 which is evaporated, as described in version 19A, above) from the gaseous layer above the said compact monolayer 23 inside the said sealed shallow container 7 (as described in version 19A) [achieved by a steady removal, at a desired rate, of the entire said gaseous layer above the said compact monolayer 23, through the said tube O (in the lid N of the said sealed shallow container 7), to the outside of the said sealed shallow container 7] while simultaneously replacing it [through another said tube O (in the lid N of the said sealed shallow container 7) from outside of the said sealed shallow container 7] with a “fresh” mixture of gases [that contains the said vehicle 19 and the said organic material (or organic compound) present in the said compact monolayer 23, both in gaseous form, plus other inert gases or “pure air”] while ensuring the following conditions/criteria are met:
1. The said fresh mixture of the said gases should contain zero or very small amounts of the said vehicle in a gaseous phase so that the vapor pressure of the said vehicle 19 in the said fresh mixture of the said gases is either zero or at such a low value/magnitude that promotes the evaporation of the said vehicle 19 (at the temperature inside the said sealed shallow container 7) while the said fresh mixture of the gases contains just enough of the said organic material (or organic compound) present in the said compact monolayer 23 in gaseous form to impart a vapor pressure that is optimal in order to ensure that the net amount of the said organic material (or organic compound) present in the said compact monolayer 23 remains unchanged [i.e. the amount of the said organic material (or organic compound) which is evaporated and removed from the said compact monolayer 23 into the said gaseous layer equals the amount of the said organic material (or organic compound) which is liquefied from the said gaseous layer and added to the said compact monolayer 23], and
2. The temperature and the ambient atmospheric pressure of the “system” (i.e. the contents inside the said sealed shallow container 7) are constantly kept at a suitable level so as to prevent the said vehicle 19 or the said compact monolayer 23 [made up of a suitable organic material (or organic compound)] from coming to a boil, as described below:
   a) The ambient atmospheric pressure of the said system is kept at a value/magnitude which prevents the said compact monolayer 23 and the said vehicle 19 from coming to a boil at the temperature of the said system, and
   b) The temperature of the said system is kept at a value/magnitude that is lower than the boiling point of an immiscible mixture which is made up of the said vehicle 19 and the said organic material (or organic compound) present in the said compact monolayer 23 under the said ambient atmospheric pressure of the said system.

Version 19C: Referring to FIG. 35: Removal of the gaseous form of the said vehicle 19 (i.e. the portion of the vehicle 19 which is evaporated, as described in version 19A, above) from the gaseous layer above the said compact monolayer 23 inside the said sealed shallow container 7 (as described in version 19A) by “trapping” the said gaseous form of the said vehicle 19 “within” the contents of a container 24 of an appropriate size (which is placed inside the said sealed shallow container 7, at a level above the said compact monolayer 23), according to one of the following methods:

Version 19C1: According to this version of the invention, the said container 24 of an appropriate size as described in version 19C, contains a suitable material, in a liquid or a solid form, which chemically reacts with the said gaseous form of the said vehicle 19 (above the said compact monolayer 23) as described in version 19C to form a different substance, while the said suitable material contained in the said container 24 of an appropriate size is “inert” towards the said gaseous form of the said organic material (or organic compound) which is present in the said gaseous layer above the said compact monolayer 23 inside the said sealed shallow container 7 [i.e. the said gaseous form of the said organic material (or organic compound) does not chemically react with the said suitable material contained in the said container 24 of an appropriate size, neither does it dissolve in, nor suspend in the said suitable material, when the latter is in a liquid form].

Version 19C2: According to this version of the invention, the said container 24 of an appropriate size as described in version 19C, contains a suitable liquid which allows the said gaseous form of the said vehicle 19 (above the said compact monolayer 23) as described in version 19C to be dissolved in or suspended into the said suitable liquid, while the said suitable liquid contained in the said container 24 of an appropriate size is “inert” towards the said gaseous form of the said organic material (or organic compound) which is present in the said gaseous layer above the said compact monolayer 23 inside the said sealed shallow container 7 [i.e. the said gaseous form of the said organic material (or organic compound) does not chemically react with, nor dissolve in, nor suspend into the said suitable liquid contained in the said container 24 of an appropriate size].

Version 19C3: According to this version of the invention, the said container 24 of an appropriate size as described in version 19C, contains a suitable porous material that possesses numerous small pores which allows the said gaseous form of the said vehicle 19 (above the said compact monolayer 23) as described in version 19C to be adsorbed onto the surfaces of the said numerous small pores of the said porous material, while the said suitable porous material contained in the said container 24 of an appropriate size is “inert” towards the said gaseous form of the said organic material (or organic compound) which is present in the said gaseous layer above the said compact monolayer 23 inside the said sealed shallow container 7 [i.e. the said gaseous form of the said organic material (or organic compound) does not chemically react with, nor adsorb onto the said surfaces of the said numerous small pores of the said suitable porous material contained in the said container 24 of an appropriate size].

Version 19C4: According to this version of the invention, the said container 24 of an appropriate size as described in version 19C, contains suitable small particles which allow the said gaseous form of the said vehicle 19 (above the said compact monolayer 23) as described in version 19C to be adsorbed onto the surfaces of the said small particles, while the said suitable small particles contained in the said container 24 of an appropriate size are “inert” towards the said gaseous form of the said organic material (or organic compound) which is present in the said gaseous layer above the said compact monolayer 23 inside the said sealed shallow container 7 [i.e. the said gaseous form of the said organic material (or organic compound) does not chemically react with, nor adsorb onto the said surfaces of the said suitable small particles contained in the said container 24 of an appropriate size].

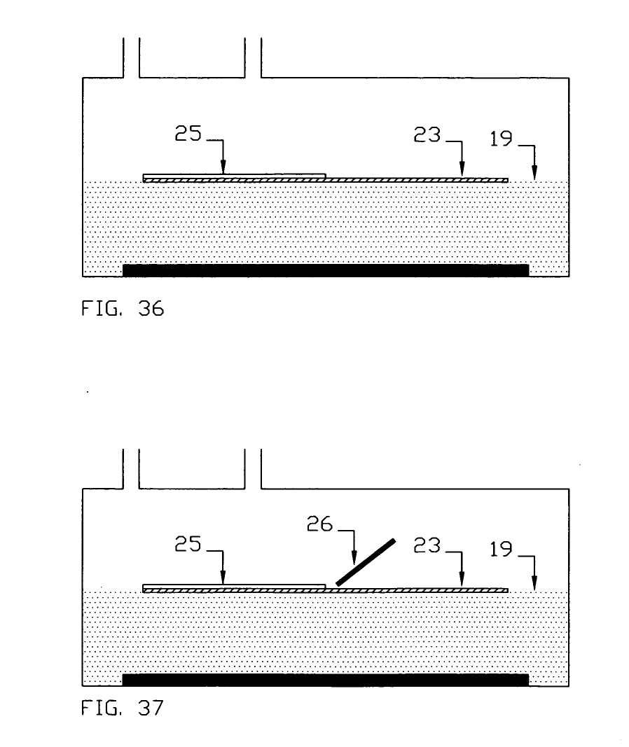

Version 20: Referring to FIG. 36: This version of the invention is comprised of a method of “separating” or removing the said compact monolayer 23 [made up of a suitable organic material (or organic compound)] from the top surface of the said vehicle 19 {where the said compact monolayer 23 which is floating on top of the said vehicle 19 is first produced by one of the conventional methods and then “compressed” [inside the said sealed shallow container 7 according to “Stage 1: Preparing a compact monolayer (FIG. 32)”]), by means of “adding/introducing” a suitable transparent or opaque substance 25 over the top surface of the said compact monolayer 23 in order to aid the said separation.

The said suitable transparent or opaque substance 25 should possess the following properties:
a) The said suitable transparent or opaque substance 25 should not react chemically with the said organic material (or organic compound) which makes up the said compact monolayer 23;
b) The said suitable transparent or opaque substance 25 should not dissolve, nor should it suspend in the said organic material (or organic compound) which makes up the said compact monolayer 23;
c) The said suitable transparent or opaque substance 25 should not allow the said organic material (or organic compound) which makes up the said compact monolayer 23 to be dissolved or suspended in the said suitable transparent or opaque substance 25;
d) The said suitable transparent or opaque substance 25 should be capable of adhering itself to the top surface of the said compact monolayer 23; and
e) The said suitable transparent or opaque substance 25 should be able to “set”, upon “standing”, into a transparent or an opaque, (preferably flexible) film.

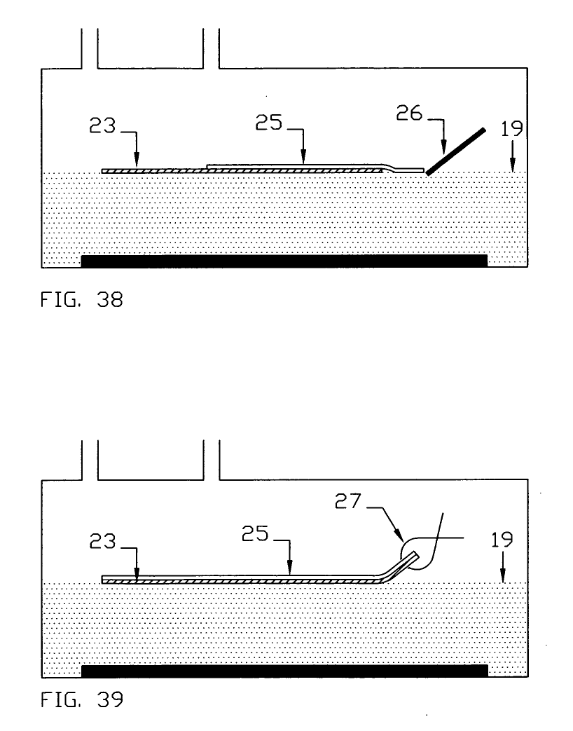

In order to ensure that the “structural integrity” of the said compact monolayer 23 is retained during the said “addition/introduction”, the said suitable transparent or opaque substance 25 is “added/introduced” over the surface of the said compact monolayer 23 by one of the following two methods:
A. According to this method, the said suitable transparent or opaque substance 25 is sprayed on top of the said compact monolayer 23 until a thin layer of the said suitable transparent or opaque substance 25 is formed above the upper surface of the said compact monolayer 23.
B. According to this method, an adequate amount of the said suitable transparent or opaque substance 25 in a liquid form is gently added to the top of the said compact monolayer 23 until a thin layer of the said suitable transparent or opaque substance 25 is formed above the upper surface of the said compact monolayer 23, according to the following two methods:
   1. Referring to FIG. 37: One method of achieving the said gentle addition of the said suitable transparent or opaque substance 25 is by having a plate 26 of suitable dimensions held at a suitable angle on top of the said compact monolayer 23 in such a manner that one end of the said plate 26 which is proximal to the said compact monolayer 23 just barely touches the latter at an appropriate angle.
   Then, the said suitable liquid form of the said transparent or opaque substance 25 is “added/introduced”, drop by drop or as a very “slow stream” to the other end of the said plate 26 (the end which is not proximal to the said compact monolayer 23) and allowed to slide down the said plate 26 and onto the top of the said compact monolayer 23, without “breaking” the latter.
   The said slow addition of the said liquid form of the said suitable transparent or opaque substance 25 is stopped when a layer of desired thickness of the latter is formed above the upper surface of the said compact monolayer 23.
   2. Referring to FIG. 38: Another method of achieving the said gentle addition of the said suitable transparent or opaque substance 25 is by having the said plate 26 of suitable dimensions held at a suitable angle on top of the said vehicle 19 (on an area beyond the boundary of the said compact monolayer 23, where the surface of the said vehicle 19 is not covered by the said compact monolayer 23) in such a manner that one end of the said plate 26 which is proximal to the said vehicle 19 just barely touches the surface of the latter at an appropriate angle.
   Then, the said suitable liquid form of the said suitable transparent or opaque substance 25 is “added/introduced”, drop by drop or as a very “slow stream” to the other end of the said plate 26 (the end which is not proximal to the said vehicle 19) and allowed to slide down the said plate 26 and onto the top of the said vehicle 19, in such a manner that any “ripple effect” thus created does not cause the said compact monolayer 23 to break or rupture.
   The said slow addition of the said suitable transparent or opaque substance 25 is continued so as to allow the latter to flow over the said compact monolayer 23 and cover the upper surface of the latter.
   The said slow addition of the said liquid form of the said suitable transparent or opaque substance 25 is stopped when a layer of desired thickness of the latter is formed above the upper surface of the said compact monolayer 23.

Following the said slow addition/introduction of the said adequate amount of the said transparent or opaque substance 25 onto the top of the said compact monolayer 23 by any of the methods described above, an adequate length of time is allowed to pass in order to allow the said transparent or opaque substance 25 to “set” and form a film whose lower surface is adhered to the upper surface of the said compact monolayer 23.

Next, the said “set” film, with the said compact monolayer 23 adhered to its lower surface, is separated from the top surface of the said vehicle 19 by one of the methods described in versions 20A, 20B or 20C, below:

Version 20A: Referring to FIG. 39: According to this version of the invention, the said “set” film (the said transparent or opaque substance 25 which is set and formed a film upon standing) with the said compact monolayer 23 adhered to its lower surface as described in version 20 above, is “mechanically” removed from the top of the said vehicle 19 by “grasping” (e.g. by means of suitable tweezers or pliers 27) and “peeling off” the newly formed film from the top of the said vehicle 19.

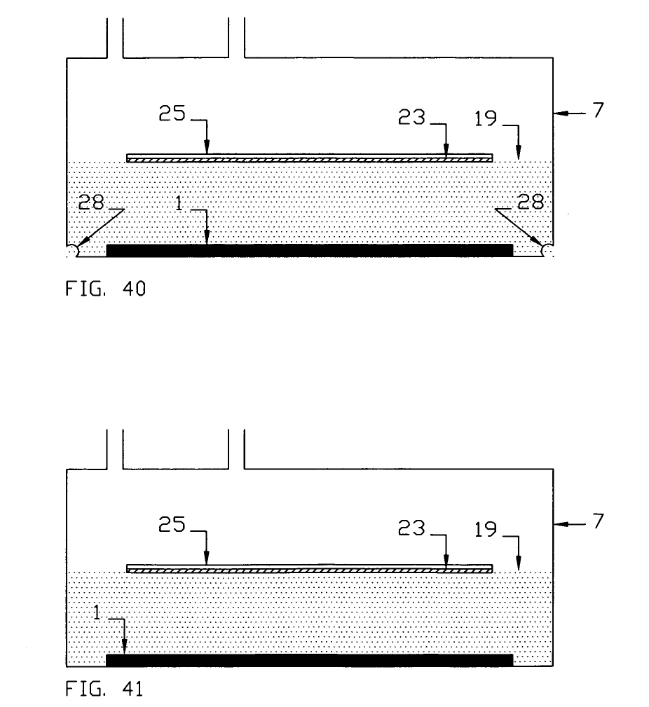

Version 20B: Referring to FIG. 40: According to this version of the invention, the said vehicle 19 [which is positioned below the said “set” film (the said transparent or opaque substance 25 which is set and formed a film upon standing) with the said compact monolayer 23 adhered to its lower surface as described in version 20 above], is allowed to be gently drained at a suitable rate out of the said sealed shallow container 7, through a suitable number of holes 28 at the bottom of the said sealed shallow container 7, leaving behind the said “set” film (the said transparent or opaque substance 25 which is set and formed a film upon standing) with the said compact monolayer 23 adhered to its lower surface, thus enabling the latter to spread/deposit directly on the upper surface of a suitable substrate 1 which had previously been placed at the bottom of the said sealed shallow container 7.

Version 20C: Referring to FIG. 41: This version of the invention comprises the “removal” of the said vehicle 19 [which is positioned below the said “set” film (the said transparent or opaque substance 25 which is set and formed a film upon standing) with the said compact monolayer 23 adhered to its lower surface as described in version 20 above] from beneath the said “set” film [the said transparent or opaque substance 25 which is set and formed a film upon standing (by employing methods identical to the procedures described in versions 19A, 19B, 19C, 19C1, 19C2, 19C3, and 19C4], thus allowing the said “set” film (the said transparent or opaque substance 25 which is set and formed a film upon standing) with the said compact monolayer 23 adhered to its lower surface to be spread/deposited directly on the upper surface of a suitable substrate 1 which had previously been placed at the bottom of the said sealed shallow container 7.

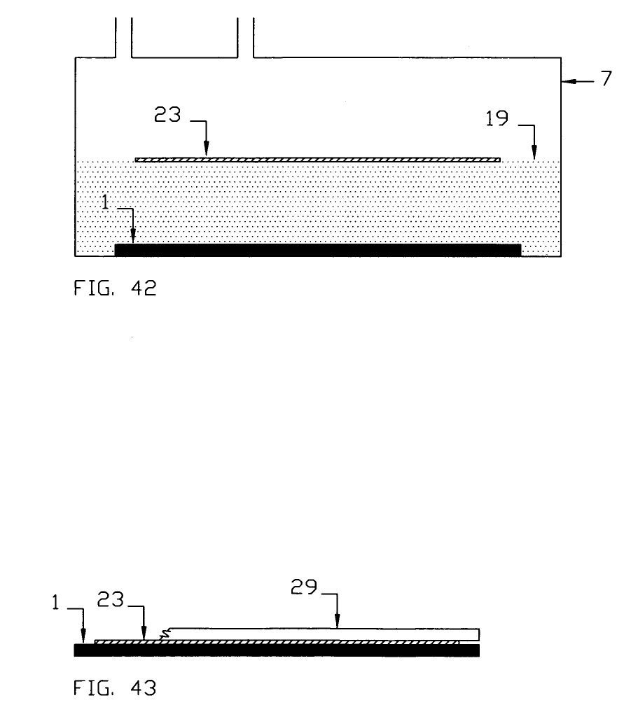

Version 21: Referring to FIG. 42: This version of the invention is comprised of a method of “separating” or removing the said compact monolayer 23 [made up of a suitable organic material (or organic compound)] which is in a frozen state, from the top surface of the said vehicle 19 which is in a liquid state {where the said compact monolayer 23 which is in a frozen state, floating on top of the said vehicle 19, is first produced by one of the conventional methods and then “compressed” [inside the said sealed shallow container 7 according to “Stage 1: Preparing a compact monolayer (FIG. 32)”], before being frozen}, by the method described below.

The said vehicle 19 which is used in this version of the invention in the preparation of the said compact monolayer 23 should have a lower freezing point than that of the organic material (or organic compound) which makes up the said compact monolayer 23.

After preparing the said compact monolayer 23 [inside the said sealed shallow container 7 (as described in claim 13) by a conventional method], the next step is to reduce the temperature of the contents inside the said sealed shallow container 7 at a suitable rate down to a level that causes the said suitable organic material (or organic compound) which makes up the said compact monolayer 23 to freeze, while allowing the said vehicle 19 to remain in a liquid phase.

In order to preserve “structural integrity” of the said compact monolayer 23 during this stage of the process, the vapor pressure of the said organic material (or organic compound) which makes up the said compact monolayer 23 inside the said sealed shallow container 7 is constantly kept at a value that ensures the net amount of the said organic material (or organic compound) which makes up the said compact monolayer 23 remains unchanged at every point during the said reduction of the temperature of the contents inside the said sealed shallow container 7 [i.e. the amount of the said organic material (or organic compound) which makes up the said compact monolayer 23 which is evaporated and removed from the said compact monolayer 23 into the “gaseous layer” above the said compact monolayer 23 equals the amount of the said organic material (or organic compound) which is liquefied from the said gaseous layer and added/deposited onto the said compact monolayer 23].

It is also preferred that during this stage of the process, the vapor pressure of the said vehicle 19 inside the said sealed shallow container 7 is constantly kept at a value that ensures that the net amount of the said vehicle 19 present in the said sealed shallow container 7 remains unchanged at every point during the said reduction of the temperature of the contents inside the said sealed shallow container 7 [i.e. the amount of the said vehicle 19 which is evaporated into the “gaseous layer” above the said compact monolayer 23 equals the amount of the said vehicle 19 which is liquefied from the said gaseous layer and added/deposited into the said vehicle 19].

The next step is to “separate” the said compact monolayer 23 which is in a frozen state from the said vehicle 19 which is in a liquid phase by employing any of the methods described in versions 19, 19A, 19B, 19C, 19C1, 19C2, 19C3, 19C4, 20, 20A, 20B and 20C while making appropriate adjustments to the ambient atmospheric pressure, the vapor pressure of the said vehicle 19, the vapor pressure of the said organic material (or organic compound) which makes up the said compact monolayer 23 and the temperature of the contents of the said sealed shallow container 7 in order to ensure that the said compact monolayer 23 remains in the frozen state during the said “separation procedures”.

Version 22: According to this version of the invention, the said compact monolayer 23 [made up of a suitable organic material (or organic compound)] which is spread/deposited directly on the upper surface of a suitable substrate 1, as described in version 19 (FIG. 33), is doped by a suitable method, thus allowing a doped compact monolayer 23 to participate in any future “steps/procedures”.

Version 23: According to this version of the invention, a compact monolayer 23 [made up of a suitable organic material (or organic compound)] which is spread/deposited directly on the upper surface of a suitable substrate 1 (according to versions 19, 19A, 19B, 19C, 19C1, 19C2, 19C3, 19C4, 20, 20A, 20B, 20C and 21) is carbonized by means of a suitable “heat source” [as described in versions 23A and 23B, below], thus producing a graphene layer directly on the upper surface of the said suitable substrate 1 (FIG. 33 through FIG. 41).

Version 23A: According to this version of the invention, a compact monolayer 23 [made up of a suitable organic material (or organic compound)] which is spread/deposited directly on the upper surface of a suitable substrate 1 (according to versions 19, 19A, 19B, 19C, 19C1, 19C2, 19C3, 19C4, 20, 20A, 20B, 20C and 21) is carbonized by means of a suitable “radiation type beam” as the said suitable heat source mentioned in version 23 above, thus producing a graphene layer directly on the upper surface of the said suitable substrate 1 (FIG. 33 through FIG. 41).

The said suitable “radiation type beam” may either be comprised of a “single beam” of the said suitable “radiation type beam”, or, it may be comprised of more than one beam of the said suitable “radiation type beam” where the said beams are “positioned” adjacent to one another contiguously so as to allow the carbonization of a larger “area” of the said compact monolayer 23 (as described in method 6 below) to take place in one “pass” without leaving any uncarbonized matter “behind” in the said larger area just carbonized.

The said radiation type beam could be a suitable laser beam, or a suitable maser beam, or a suitable electron beam, any of which allows the application of a sudden searing “heat” extremely quickly so as to “instantaneously” turn the said organic material (or organic compound) which makes up the said compact monolayer 23 into solid carbon, before the said organic material (or organic compound) which makes up the said compact monolayer 23 “gets the chance” to evaporate as a result of its exposure to the said sudden searing heat.

The said carbonization may be carried out by one of the methods (1 to 6) below:
1. Method 1: According to this method, assuming that the said compact monolayer 23 [(which is spread/deposited directly on the upper surface of the said suitable substrate 1) as described in version 23, above] is present “roughly” in the shape of a rectangle, the said single beam radiation type beam is focused on a point at one of the four corners of the said rectangle and moves on a straight line along one of the sides of the said rectangle towards the other corner of the said rectangle, either horizontally or vertically, thereby carbonizing the said organic material (or organic compound) present on the said line.
When the said single beam radiation type beam reaches the end of the said line i.e. the other corner of the said compact monolayer 23 which is the other edge of the said suitable substrate 1, it moves a distance equal to the width of the said line (the width of the said single beam of the said radiation type beam), either horizontally or vertically, as the case may be, in the direction towards the center or main body of the said rectangle and starts to carbonize a “second line” of the said compact monolayer 23 in one of the following two ways:
   a) The said single beam radiation type beam starts to carbonize the said organic material (or organic compound) on a straight line in the direction which is opposite to that of the first line (i.e. the just recently carbonized line), in a manner that the adjacent edges of the said two newly carbonized lines overlap with one another, thus allowing no uncarbonized material to exist between the said two adjacent newly carbonized lines.
   b) The said single beam radiation type beam starts to carbonize the said organic material (or organic compound) on a straight line, beginning at a point adjacent to the original “starting point” (towards the center or main body of the said rectangle), in the same direction as that of the first line (i.e. the just recently carbonized line), in a manner that the adjacent edges of the said two newly carbonized lines overlap with one another, thus allowing no uncarbonized material to exist between the said two adjacent newly carbonized lines.
The process of carbonizing additional overlapping new lines continues to repeat itself until the entire surface of the said compact monolayer 23 (which is spread/deposited directly on the upper surface of the said suitable substrate 1) is carbonized, thus producing a graphene layer directly on the upper surface of the said suitable substrate 1.
2. Method 2: According to this method, the process of carbonization of the said organic material (or organic compound) [making up the said compact monolayer 23 (which is spread/deposited directly on the upper surface of the said suitable substrate 1) as described in version 23, above] is carried out in a similar manner to that described in method 1, above, except that in this method the said carbonization is carried out in a circular fashion (as opposed to the “line by line” fashion, as described in method 1, above).
According to this method, the said carbonization starts at a point at the periphery of an imaginary circle on the surface of the said compact monolayer 23, carbonizing the said organic material (or organic compound) which makes up the said compact monolayer 23 by means of the said single beam radiation type beam as mentioned in method 1 above, along an imaginary outermost line (representing the outermost periphery) of the said imaginary circle, until the outermost line of the said imaginary circle is carbonized in its entirety.
Then, the said single beam radiation type beam moves a distance equal to the width of the said line (the width of the said single beam of the said radiation type beam) in the direction towards the center or main body of the said circle and starts to carbonize a “second circle” of the said compact monolayer 23 in the same manner as described for the first circle in a manner that the adjacent edges of the said two newly carbonized lines making up the two concentric newly carbonized circles overlap with one another thus allowing no uncarbonized material to exist between the said two adjacent newly carbonized lines/circles.
This process of carbonizing additional overlapping new lines, or new overlapping concentric circles, continues to repeat itself until the entire surface of the said organic material (or organic compound) making up the said compact monolayer (which is spread/deposited directly on the upper surface of the said suitable substrate) is carbonized, thus producing a graphene layer directly on the upper surface of the said suitable substrate.
3. Method 3: According to this method, the process of carbonization of the said organic material (or organic compound) [making up the said compact monolayer 23 (which is spread/deposited directly on the upper surface of the said suitable substrate) as described in version 23, above] is carried out in a similar manner to that described in method 2, above, except that in this method the said carbonization is carried out in the “reverse order” to that described in method 2, above.
Thus, the starting point for the said carbonization is the center of the said “imaginary” circle on the surface of the said compact monolayer 23, and then the “immediate” area surrounding the said newly carbonized center is carbonized in a circular manner in a manner that no uncarbonized material are allowed to exist between the said newly carbonized center and the said newly carbonized “enveloping” circle.
Then a larger circle is carbonized in a manner that this larger circle “envelops” the said “recently” carbonized circle and the said two newly carbonized concentric circles touch one another at all points along the adjacent lines making up the said two newly carbonized circles, thus allowing no uncarbonized material to exist between the said two adjacent newly carbonized concentric circles.
The said process of carbonization of a larger circle to envelop the “recently” carbonized circle as described above repeats itself until the entire surface of the said organic material (or organic compound) making up the said compact monolayer 23 (which is spread/deposited directly on the upper surface of the said suitable substrate 1) is carbonized, thus producing a graphene layer directly on the upper surface of the said suitable substrate 1.
4. Method 4: According to this method, the process of carbonization of the said organic material (or organic compound) [making up the said compact monolayer 23 (which is spread/deposited directly on the upper surface of the said suitable substrate 1) as described in version 23, above] is carried out in a similar manner to that described in method 2, above, except that in this method the said carbonization is carried out in a “rectangular” fashion (as opposed to the said “circular” fashion, as described in method 2, above).
Thus, the said single beam radiation type beam starts the said carbonization at one of the four corners at the periphery of an imaginary rectangle on the surface of the said compact monolayer 23, and then moves on a straight line along one of the sides of the said rectangle towards the other corner of the said rectangle, either horizontally or vertically (as the case may be), thereby carbonizing the said organic material (or organic compound) that is present on the said line.
When the said single beam radiation type beam reaches the end of the said line, it stops and then continues the said carbonization at 90 degrees until it reaches the third corner of the said square, then it stops and then continues the said carbonization at 90 degrees until it reaches the fourth corner of the said square, then it stops and then continues the said carbonization at 90 degrees until it reaches the first corner of the said square, thereby completing the carbonization of the outermost sides of the said rectangle.
At this point, the said single beam radiation type beam moves a distance equal to the width of the said line (the width of the said single beam of the said radiation type beam), in the direction towards the center or main body of the said rectangle and starts to carbonize the said organic material (or organic compound) in a square fashion as described above, in a manner that the second rectangle is smaller than the first rectangle and fits inside the latter, and the edges of the said adjacent lines making up the said “concentric rectangles” overlap/touch one another at all points along the said lines, thus allowing no uncarbonized material to exist between the said two adjacent newly carbonized lines.
This process of carbonizing additional overlapping new rectangles, or new overlapping “concentric” rectangles, continues to repeat itself until the entire surface of the said organic material (or organic compound) making up the said compact monolayer 23 (which is spread/deposited directly on the upper surface of the said suitable substrate 1) is carbonized, thus producing a graphene layer directly on the upper surface of the said suitable substrate 1.
5. Method 5: According to this method, the process of carbonization of the said organic material (or organic compound) [making up the said compact monolayer 23 (which is spread/deposited directly on the upper surface of the said suitable substrate 1) as described in version 23, above] is carried out in a similar manner to that described in method 4, above, except that in this method the said carbonization is carried out in the “reverse order” to that described in method 4, above.
Thus, the starting point for the said carbonization is the “center” of the said “imaginary” rectangle on the surface of the said compact monolayer 23 as described in method 4, above, then the “immediate” area surrounding the said newly carbonized center is carbonized in a rectangular manner in a manner that no uncarbonized material is allowed to exist between the said newly carbonized center and the said newly carbonized “enveloping” rectangle.
Then a larger rectangle is carbonized in a manner that this larger rectangle “envelops” the said newly carbonized rectangle, and the said two newly carbonized rectangles touch one another at all points along the adjacent lines making up the sides of the said two newly carbonized rectangles, thus allowing no uncarbonized material to exist between the said two adjacent newly carbonized rectangles.
The said process of carbonization of a larger rectangle to envelop the newly carbonized rectangle as described above repeats itself until the entire surface of the said organic material (or organic compound) making up the said compact monolayer 23 (which is spread/deposited directly on the upper surface of the said suitable substrate 1) is carbonized, thus producing a graphene layer directly on the upper surface of the said suitable substrate 1.
6. Method 6: According to this method, the process of carbonization of the said organic material (or organic compound) [making up the said compact monolayer 23 (which is spread/deposited directly on the upper surface of the said suitable substrate 1) as described in version 23, above] is carried out in a similar manner to any of the methods 1 to 5 above, except that in this method, the radiation type beam is comprised of more than one beam of the said suitable “radiation type beam” (as described in version 23A, above).

Version 23A1: This version of the invention is comprised of the carbonization of an organic material (or organic compound) making up a compact monolayer 23 (which is spread/deposited directly on the upper surface of a suitable substrate 1) by a suitable “radiation type beam” (as described in version 23A) while ensuring that the point where the said suitable radiation type beam meets the said compact monolayer 23, plus the areas surrounding that point, are “kept” at a suitably low temperature.

The purpose of having the said “point plus its surrounding areas” kept at a suitably low temperature is to prevent the “loss” of the said compact monolayer 23 by evaporation (as a result of the “exposure” of the said compact monolayer 23 to the said radiation type beam) achieved through the use of a suitable non-carbon containing cold fluid, according to one of the following methods:
a. “Keep” the said suitable substrate 1 submerged (at a suitable depth) under a layer of a suitable non-carbon containing cold liquid throughout the process of carbonization of the said compact monolayer 23 by the said radiation type beam, where the latter passes through the said layer of the said suitable non-carbon containing cold liquid in order to carry out the said carbonization; or
b. Allow the said “layer of a suitable non-carbon containing cold liquid” (mentioned in method “a” above) to freeze, followed by carbonization of the said compact monolayer 23 by the said radiation type beam (mentioned in method “a” above), where the said radiation type beam passes through the resultant frozen layer in order to carry out the said carbonization; or
c. Pour a “continuous sheet” of a suitable non-carbon containing cold liquid over the entire surface of the said compact monolayer 23 throughout the process of carbonization of the said compact monolayer 23 by the said radiation type beam while the said suitable substrate 1, which is supporting the said compact monolayer 23, is held at a suitable angle so as to allow the non-carbon containing cold liquid which is “drained off” from the bottom of the said suitable substrate 1 to be collected; or
d. “Pour/introduce” a “continuous stream” of a suitable non-carbon containing cold fluid (a liquid or a gas or a mixture of a gas plus droplets of a liquid) over the said “point plus its surrounding areas” as mentioned above, through a tube which possesses a suitable internal diameter, throughout the process of carbonization of the said compact monolayer 23 by the said radiation type beam.

The said suitable non-carbon containing cold fluid, mentioned above, should possess the following properties:
a. It should not chemically react with the said organic material (or organic compound) which makes up the said compact monolayer 23.
b. It should not dissolve the said organic material (or organic compound) which makes up the said compact monolayer 23.
c. It should not suspend into the said organic material (or organic compound) which makes up the said compact monolayer 23.
d. It should ideally be “transparent” to the said radiation type beam (i.e. the said radiation type beam should pass through the said non-carbon containing cold fluid without being absorbed by the latter).
e. Finally, the said suitable non-carbon containing cold fluid should not allow the said organic material (or organic compound) which makes up the said compact monolayer 23 to be suspended into the said suitable non-carbon containing cold fluid.

Version 23A2: This version of the invention is comprised of the carbonization of an organic material (or organic compound) making up a compact monolayer 23, which is spread/deposited directly on the upper surface of a suitable substrate 1, by a suitable “radiation type beam(s)” (as described in version 23A) while ensuring that the said suitable substrate 1 is “kept” at a suitably low temperature during the said carbonization.

The above objective of keeping the said suitable substrate 1 at a suitably low temperature during the said carbonization may be achieved by convection or conduction methods of heat transfer, such as allowing the lower surface of the said suitable substrate 1 to be in “contact” with a suitable substance which is at a suitable temperature during the said carbonization (e.g. allow the lower surface of the said suitable substrate 1 to “float” on top of a suitable cold liquid); or, by placing the said suitable substrate 1 inside a suitable enclosed “chamber” where the ambient temperature and atmospheric pressure inside the said chamber are optimal during the said carbonization.

Version 23A3: According to this version of the invention, the said compact monolayer 23 [made up of a suitable organic material (or organic compound)] which is in a frozen state, as described in version 21, is carbonized by a suitable radiation type beam (by a method as described in version 23A) while the said compact monolayer 23, which is in a frozen state, is still floating on top of the said suitable vehicle 19.

Version 23A4: According to this version of the invention, the said suitable vehicle 19 beneath the said compact monolayer 23 [made up of a suitable organic material (or organic compound)] is frozen (while allowing the latter to remain in a liquid state), followed by carbonization of the said compact monolayer 23 by a suitable radiation type beam (by a method as described in version 23A4).

According to this claim, it is preferable to use a suitable non-carbon containing substance (e.g. water) as the said suitable vehicle used in the preparation of the said compact monolayer, so that there is no possibility of carbonization of the said suitable vehicle even if the said radiation type beam “passes through” the said compact monolayer and “penetrates” into the said suitable vehicle.

One of the properties of the said suitable vehicle 19 mentioned in this version of the invention is that the freezing point of the said suitable vehicle 19 must be higher than that of the said compact monolayer 23.

Version 23A5: According to this version of the invention, the said compact monolayer 23 [made up of a suitable organic material (or organic compound)] as well as the said suitable vehicle 19 beneath the latter are frozen, followed by carbonization of the said compact monolayer 23 by a suitable radiation type beam (by a method as described in version 23A).

According to this claim, it is preferable to use a suitable non-carbon containing substance (e.g. water) as the said suitable vehicle used in the preparation of the said compact monolayer, so that there is no possibility of carbonization of the said suitable vehicle even if the said radiation type beam “passes through” the said compact monolayer and “penetrates” into the said suitable vehicle.

Version 23B: According to this version of the invention, the said compact monolayer 23 [made up of a suitable organic material (or organic compound)] as mentioned in version 23, above, is carbonized by means of a suitably hot surface as the said suitable heat source mentioned in version 23 above, where the said suitably hot surface is provided by the said suitable plate 6 (as described in versions 7, 8, 9, 10, 11 and 12) or a hot roller.

The said suitably hot surface (the said suitable plate 6 or the said hot roller) is allowed to come into contact with the said compact monolayer 23 for an appropriate length of time, thus carbonizing the said organic material (or organic compound) which makes up the said compact monolayer 23, thereby converting the latter into a graphene layer.

Version 23B1: This version of the invention is comprised of a method of either facilitating the “detachment”, or conversely, hindering the said detachment (i.e. enhancing the “adherence”) of a graphene layer from the surface of the said suitable substrate 1 (as described in version 2 or 5 or the non-stick versions of the said version 2 or 5 as described in version 6), by means of altering the temperature of the said surface of the said suitable substrate 1.

The said change in the said temperature of the said surface of the said suitable substrate 1 as mentioned above may be achieved by allowing a suitable fluid, having a suitable temperature, to run through the said tube 3 which is below the said surface of the said suitable substrate 1 (as described in version 2 or 5 or the non-stick versions of the said version 2 or 5 as described in version 6), thus altering the surface temperature of the said suitable substrate 1, thereby making the separation of the said graphene layer from the said surface of the said suitable substrate 1 either easier or more difficult, depending on the temperature of the said suitable fluid.

Version 23B2: This version of the invention is comprised of a method of either facilitating the “detachment”, or conversely, hindering the said detachment (i.e. enhancing the “adherence”) of a graphene layer from the surface of the said plate 6 (as described in version 8 or 11 or the non-stick versions of the said version 8 or 11 as described in version 12), by means of altering the temperature of the said surface of the said plate 6.

The said change in the said temperature of the said surface of the said plate 6 as mentioned above may be achieved by allowing a suitable fluid, having a suitable temperature, to run through the said tube 3 which is below the said surface of the said plate 6 (as described in version 8 or 11 or the non-stick versions of the said version 8 or 11 as described in version 12), thus altering the surface temperature of the said plate 6, thereby making the separation of the said graphene layer from the said surface of the said plate 6 either easier or more difficult, depending on the temperature of the said suitable fluid.

Version 23B3: This version of the invention is comprised of a method of facilitating the “detachment” of a graphene layer, which is resting/spread on the upper surface of the said suitable substrate 1, from the said upper surface of the said suitable substrate 1, by means of the repulsive forces of electrostatic charges.

The above objective may be achieved by means of projecting an electrostatic charge (either positive or negative) by suitable method(s), onto the upper surface of the said suitable substrate 1 as well as the lower surface of the said compact monolayer 23 (that is deposited on the upper surface of the said suitable substrate 1) before the said compact monolayer 23 is carbonized by a suitable method, or alternatively, by projecting the said electrostatic charges onto the upper surface of the said suitable substrate 1 as well as the lower surface of the said graphene layer (that is resting/spread on the upper surface of the said suitable substrate 1).

As a result of the presence of the repulsive electrostatic forces between the said upper surface of the said suitable substrate 1 and the said lower surface of the said graphene layer (due to the presence of the said same sign electrostatic charges on both of the above-mentioned surfaces), the detachment of the said graphene layer from the said suitable substrate 1 is facilitated.

Version 23B4: This version of the invention is comprised of a method of “enhancing” the “adherence” of a graphene layer, which is resting/spread on the upper surface of the said suitable substrate 1, to the said upper surface of the said suitable substrate 1, by means of the attractive forces of electrostatic charges.

The above objective may be achieved by employing methods identical to the ones mentioned in version 23B3 above, except that according to this version of the invention, the said electrostatic charges are of opposite signs (i.e. the electrostatic charge projected onto the upper surface of the said suitable substrate 1 is of opposite sign to the electrostatic charge projected onto the lower surface of the said compact monolayer 23 or the said graphene layer, as the case may be).

As a result of the presence of the attractive electrostatic forces between the said upper surface of the said suitable substrate 1 and the said lower surface of the said graphene layer (due to the presence of the said opposite sign electrostatic charges on the above-mentioned surfaces), the adherence of the said graphene layer to the said suitable substrate 1 is enhanced.

Version 23B5: This version of the invention is comprised of a method of facilitating the “detachment” of a graphene layer from (or, hindering the “attachment” of the said graphene layer to) the surface of the said suitable plate 6 (where the said suitable plate 6 is described in version 12) by means of the repulsive forces of electrostatic charges.

The above objective may be achieved by means of projecting an electrostatic charge (either positive or negative) by suitable method(s) onto the surface of the said suitable plate 6 (the surface which will come into contact with the said compact monolayer 23 in order to carbonize the latter) as well as the upper surface of the said compact monolayer 23 (that is deposited on the upper surface of the said suitable substrate 1) before the said compact monolayer 23 is carbonized by the said surface of the said suitable plate 6, or alternatively, by projecting the said electrostatic charges onto the said surface of the said suitable plate 6 as well as the surface of the graphene layer which is adhered to the said surface of the said suitable plate 6.

As a result of the presence of the repulsive electrostatic forces between the said surface of the said suitable plate 6 and the said surface of the said graphene layer (due to the presence of the said same sign electrostatic charges on both of the above-mentioned surfaces), the adherence of the said graphene layer to the said surface of the said suitable plate 6 is hindered.

Version 23B6: This version of the invention is comprised of a method of “enhancing” the “adherence” of a graphene layer to the surface of the said suitable plate 6 (where the said suitable plate 6 is described in version 12) by means of the attractive forces of electrostatic charges.

The above objective may be achieved by employing methods identical to the ones mentioned in version 23B5 above, except that according to this version of the invention, the said electrostatic charges are of opposite signs i.e. the electrostatic charge projected onto the said surface of the said suitable plate 6 is of the opposite sign to the electrostatic charge projected onto the upper surface of the said compact monolayer 23 (that is deposited on the upper surface of the said suitable substrate 1).

As a result of the presence of the attractive electrostatic forces between the said surface of the said suitable plate 6 and the said surface of the said graphene layer (due to the presence of the said opposite sign electrostatic charges on the above-mentioned surfaces), the adherence of the said graphene layer to the said surface of the said suitable plate 6 is enhanced.

Version 24: According to this version of the invention, a compact monolayer 23 [made up of a suitable organic material (or organic compound)] which is produced by one of the conventional methods while still resting/floating on top of a suitable vehicle 19, is carbonized by means of a suitable radiation type beam as described in version 23, according to one of the methods described in version 23A.

According to this version of the invention, it is preferable to use a suitable non-carbon containing substance (e.g. water) as the said suitable vehicle 19 used in the preparation of the said compact monolayer 23, so that there is no possibility of carbonization of the said suitable vehicle 19 even if the said radiation type beam “passes through” the said compact monolayer 23 and “penetrates” into the said suitable vehicle 19.

Version 24A: According to this version of the invention, a doped compact monolayer 23 [made up of a suitable doped organic material (or doped organic compound)] which is produced by one of the conventional methods and resting/floating on top of a suitable vehicle 19, is carbonized (while still floating on top of the said suitable vehicle 19) by means of a suitable radiation type beam as described in version 23, according to one of the methods described in version 23A.

According to this version of the invention, it is preferable to use a suitable non-carbon containing substance (e.g. water) as the said suitable vehicle 19 used in the preparation of the said doped compact monolayer 23, so that there is no possibility of carbonization of the said suitable vehicle 19 even if the said radiation type beam “passes through” the said doped compact monolayer 23 and “penetrates” into the said suitable vehicle 19.

Version 25: According to this version of the invention, a compact monolayer 23 [made up of a suitable organic material (or organic compound)] which is spread/deposited directly on the upper surface of a suitable substrate 1 (as described in version 19, 19A, 19B, 19C and 20) is carbonized according to a “desired pattern” by means of a suitable radiation type beam (as described in version 23A), using a method similar to the methods described in version 23A [except that only those “sections” of the said compact monolayer 23 which are a part of the said desired pattern are carbonized, while “leaving” the rest of the said compact monolayer 23 (those sections which are not a part of the said desired pattern) uncarbonized], thus producing a “patterned” graphene layer which is spread/deposited directly on the upper surface of the said suitable substrate 1.

The next stage in this version of the invention is the “removal” of the said uncarbonized sections of the said compact monolayer 23 present “within” the said patterned graphene layer (thus “leaving behind” solely the said patterned graphene layer spread/deposited directly on the upper surface of the said suitable substrate 1) according to one of the methods as described below:

Version 25A: According to this version of the invention, the removal of the said uncarbonized suitable organic material (or organic compound) present “within” the said patterned graphene layer (as described in version 25, above) is achieved by evaporating the said uncarbonized suitable organic material (or organic compound) by means of the application of heat of suitable intensity at a suitable “pace/rate” (e.g. the flame of a suitable torch, or a fan driven heated air current from a device similar to a hair dryer) to the said patterned graphene layer, thus leaving behind solely the said patterned graphene layer spread/deposited on the upper surface of the said suitable substrate 1.

Version 25B: According to this version of the invention, the removal of the said uncarbonized suitable organic material (or organic compound) present “within” the said patterned graphene layer (as described in version 25, above) is achieved by “washing away” the said uncarbonized suitable organic material (or organic compound) by means of a suitable chemical agent (possessing an appropriate “flow pressure” and being at an appropriate temperature), thus leaving behind solely the said patterned graphene layer spread/deposited on the upper surface of the said suitable substrate 1.

Version 25C: According to this version of the invention, the removal of the said uncarbonized suitable organic material (or organic compound) present “within” the said patterned graphene layer (as described in version 25, above) is achieved by dissolving the said uncarbonized suitable organic material (or organic compound) into a suitable solvent, followed by discarding the said suitable solvent containing the said dissolved material, thus leaving behind solely the said patterned graphene layer spread/deposited on the upper surface of the said suitable substrate 1.

Version 25D: According to this version of the invention, the removal of the said uncarbonized suitable organic material (or organic compound) present “within” the said patterned graphene layer (as described in version 25, above) is achieved by the addition of a suitable chemical agent that chemically reacts with the said uncarbonized suitable organic material (or organic compound) in order to form a chemical substance that can then be washed away or removed by another suitable chemical agent, thus leaving behind solely the said patterned graphene layer spread/deposited on the upper surface of the said suitable substrate 1.

Version 26: According to this version of the invention, a doped compact monolayer 23 [made up of a suitable doped organic material (or doped organic compound)] spread/deposited directly on the upper surface of a suitable substrate 1 (as described in version 22) is carbonized by employing methods described in versions 23, 23A, 23B, or 25, above, thus producing a doped graphene layer (or a doped patterned graphene layer, if the said carbonization is carried out according to version 25) which is spread/deposited directly on the upper surface of the said suitable substrate 1.

Where a method according to version 25 is employed, the next step is the “removal” of the said uncarbonized sections of the said doped compact monolayer 23 present “within” the said doped patterned graphene layer according to one of the methods described in versions 25A, 25B, 25C or 25D, thus “leaving behind” solely the said doped patterned graphene layer spread/deposited on the upper surface of the said suitable substrate 1.

Version 27: Referring to FIG. 43: According to this version of the invention, a compact monolayer 23 [made up of a suitable organic material (or organic compound)] spread/deposited directly on the upper surface of a suitable substrate 1 (as described in the previous versions) is removed from the said surface of the said suitable substrate 1 by means of a “Hamid Substrate” 29, followed by carbonization of the said compact monolayer 23 according to one of the methods as described in versions 23A, 23B or 25.

To achieve the said removal of the said compact monolayer 23 as mentioned above, the adhesive surface of a Hamid Substrate 29 is allowed to come into contact with and spread itself over the upper surface of the said compact monolayer 23 (which is spread/deposited directly on the upper surface of the said suitable substrate 1) so as to cause the said adhesive surface of the said Hamid Substrate 29 to adhere to the said upper surface of the said compact monolayer 23.

In order to ensure a complete “contact” between the said adhesive surface of the said Hamid Substrate 29 and the said upper surface of the said compact monolayer 23, and to “drive out” any “bubbles” that may have been trapped between the said adhesive surface of the said Hamid Substrate 29 and the said upper surface of the said compact monolayer 23, it may be desirable to apply an adequate amount of pressure on the adhesive-free side of the said Hamid Substrate 29, either by means of a suitable “roller” which is allowed to roll over the adhesive-free side of the said Hamid Substrate 29, or by means of allowing a “padded plate” to impart the said pressure over the entire area of the said adhesive-free side of the said Hamid Substrate 29.

Next, the said roller (or the said padded plate) is removed from the said adhesive-free side of the said Hamid Substrate 29.

Next, the said Hamid Substrate 29 is removed/“moved away” from the said suitable substrate 1, thus obtaining a Hamid Substrate 29 with a compact monolayer 23 adhered to its “adhesive side”.

Next, the said compact monolayer 23 (adhered to the said adhesive side of the said Hamid Substrate 29) is carbonized (by a method similar to those described in versions 23A, 23B or 25) while ensuring that the intensity of the said heat source and the duration of the application of the said heat source are at optimum values so as to carbonize only the said compact monolayer 23, and avoid the carbonization of the adhesive material beneath the said compact monolayer 23.

Where the method according to version 25 is employed, the next step is the “removal” of the said uncarbonized sections of the said compact monolayer 23 present “within” the said patterned graphene layer according to one of the methods as described in versions 25A, 25B, 25C or 25D, thus “leaving behind” solely the said patterned graphene layer adhered to the said adhesive surface of the said Hamid Substrate 29.

The said surface of the said Hamid Substrate 29 bearing the said patterned or un-patterned graphene layer may then be “covered” by a “protective layer” so as to protect as well as prevent the contamination of the said graphene layer, according to one of the methods described in versions 27A, 27B or 27C, below:

Version 27A: According to this version of the invention, the said protective layer as described in version 27, above, may be another Hamid Substrate 29, where the adhesive side of a “new” Hamid Substrate 29 is allowed to adhere to the said adhesive side of the said Hamid Substrate 29 which bears a graphene layer (as described in version 27, above), thus creating a “sandwich type structure” that consists of the said patterned or un-patterned graphene layer sandwiched between the adhesive sides of the said two Hamid Substrates 29.

A technique similar to the one in version 27 is used in order to ensure a complete “contact” between the said two Hamid Substrates 29 and to “drive out” any “bubbles” that may have been trapped between the said two Hamid Substrates 29 (i.e. the said sandwich type structure is placed on a “table”, then an adequate amount of pressure is exerted on the upper surface of the said sandwich type structure, either by means of a suitable “roller” which is allowed to roll over the said upper surface of the said sandwich type structure, or by means of allowing a “padded plate” to impart the said pressure over the entire area of the said upper surface of the said sandwich type structure).

Version 27B: According to this version of the invention, the said protective layer (as described in version 27, above) may be “provided” by the addition of a suitable (opaque or transparent) flexible film (made up of a suitable substance) onto the surface of the said Hamid Substrate 29 bearing the said patterned or un-patterned graphene layer (as described in version 27, above).

The said suitable (opaque or transparent) flexible film is made up of a suitable (liquid or gaseous) substance that “sets”, upon standing, into an opaque or a transparent flexible film.

The said suitable substance should not react with, nor dissolve, nor be dissolved in the said patterned or un-patterned graphene layer.

The said addition of the said suitable (opaque or transparent) flexible film (made up of a suitable material) onto the said surface of the said Hamid Substrate 29 bearing the said patterned or un-patterned graphene layer (as described in version 27, above) is achieved by one of the following methods:
1. According to this method, the said suitable (opaque or transparent) substance is added onto the said surface of the said Hamid Substrate 29 bearing the said patterned or un-patterned graphene layer (as described in version 27, above) by a direct application (e.g. spraying or brushing).
2. According to this method, the said Hamid Substrate 29 bearing the said patterned or un-patterned graphene layer (as described in version 27, above) is placed at the bottom of a shallow dish (with its patterned or un-patterned graphene bearing side facing up), followed by adding an adequate amount of the said suitable liquid material into the said shallow dish until a desired layer of the said suitable liquid material is “formed” on top of the said Hamid Substrate 29.
3. According to this method, a Hamid Substrate 29 bearing the said patterned or un-patterned graphene layer (as described in version 27, above) is placed at the bottom of an enclosed shallow dish (with its patterned or un-patterned graphene bearing side facing up), followed by adding an adequate amount of the said suitable material in a gaseous state into the said enclosed shallow dish while ensuring that the magnitude of the ambient atmospheric pressure inside the said enclosed shallow dish is adequate so as to liquefy the said gaseous substance, until a desired layer of the said liquefied suitable material is “formed” on top of the said Hamid Substrate 29.

Following the addition of a desired layer of the said suitable (opaque or transparent) substance onto the said surface of a Hamid Substrate 29 by any of the methods described above, an adequate length of time is allowed to pass in order to allow the said suitable (opaque or transparent) substance to set into an opaque or transparent flexible film.

Version 28: According to this version of the invention, a doped compact monolayer 23 [made up of a suitable doped organic material (or doped organic compound)] spread/deposited directly on the upper surface of a suitable substrate 1 (as described in version 22) is removed from the said upper surface of the said suitable substrate 1 (as described in version 27), then carbonized (as described in the version 27), followed by the procedures according to one of the methods described in versions 27A or 27B.

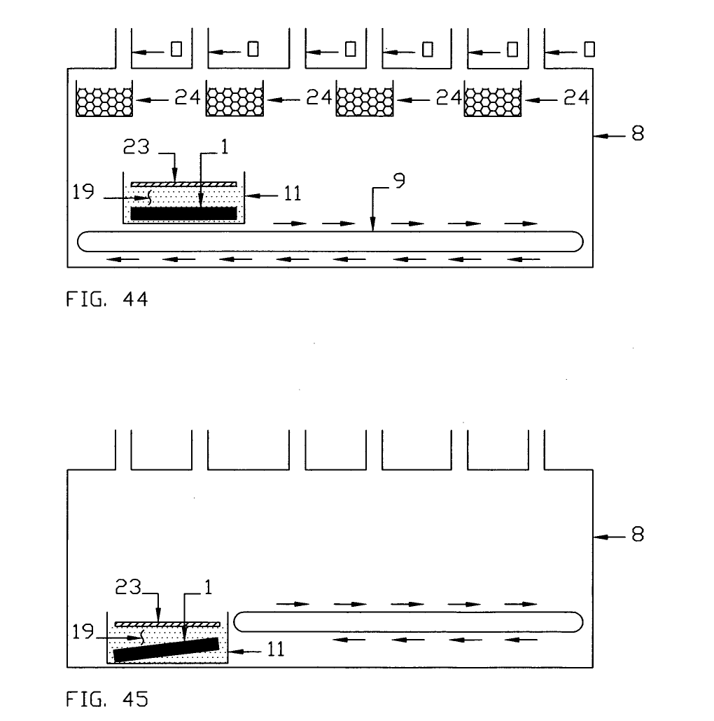

Version 29: Referring to FIG. 44: This version of the invention is comprised of a “continuous process” for the removal of a vehicle 19 from beneath a compact monolayer 23 [made up of a suitable organic material (or organic compound)] where the latter is floating on top of the said suitable vehicle 19.

A long sealed shallow container 8, as described in version 14, is used for the preparation of the said compact monolayer 23 according to this version of the invention.

First, a shallow tray 11 is placed over the conveyor belt 9 (inside the said long sealed shallow container 8) while the said conveyor belt 9 is switched off i.e. not moving.

Next, a suitable substrate 1 is placed at the bottom of the said shallow tray 11.

Then, a compact monolayer 23 [made up of a suitable organic material (or organic compound)] is produced in one piece (by a suitable conventional method, floating on top of a suitable vehicle 19) inside the said shallow tray 11.

Next, the said conveyor belt 9 is switched on [which starts to slowly move the said shallow tray 11 (with its contents) towards the other end of the said “long corridor” (as mentioned in version 14), without causing ripples or “disturbing” the said compact monolayer 23] while simultaneously the “conditions” inside the said long sealed shallow container 8 are optimized so as to allow the “removal” of the said suitable vehicle 19 from beneath the said compact monolayer 23 throughout the latter's journey from one end to the other end of the long corridor (as mentioned in version 14), by one of the methods described in versions 19A, 19B, 19C, 19C1, 19C2, 19C3 and 19C4 through the following modifications:

If the method of the removal of the said suitable vehicle 19 is to be carried out according to version 19B, then the said steady removal of the gaseous layer above the said compact monolayer 23 inside the said long sealed shallow container 8 as well as the “introduction” of the “fresh” mixture of gases in order to replace the said removed gaseous layer, as is required in version 19B, should take place at numerous locations along the entire length of the said long corridor (as mentioned in version 14), through their corresponding tubes O in such a manner as to satisfy the conditions required by version 19B throughout the length of the said long corridor (as mentioned in version 14) [i.e. the conditions required (as explained in version 19B) in order to prevent the net evaporation or the net liquefaction of the said organic material which makes up the compact monolayer 23; to prevent the said suitable vehicle 19 or the said organic material (or organic compound) which makes up the said compact monolayer 23 from coming to a boil; and to promote the continuous evaporation, at a desirable rate, of the said suitable vehicle 19 to take place only from the part of the surface of the said suitable vehicle 19 that is not covered by the said monolayer]. Thus, as the said shallow tray 11 travels along the length of the said long corridor (as mentioned in version 14), it is constantly travelling in an environment that encourages a steady removal of the said suitable vehicle 19 from beneath the said compact monolayer 23 while the latter remains qualitatively and quantitatively unchanged.

Similarly, if the method of the removal of the said suitable vehicle 19 is to be carried out according to any of the versions involved in version 19C (i.e. versions 19C1, 19C2, 19C3 or 19C4), then, in order to satisfy the conditions required by version 19B throughout the length of the said long corridor (as mentioned in version 14), an appropriate number of the said appropriate sized containers 24 (each containing the appropriate suitable material required in the respective version) are placed at numerous locations along the entire length of the said long corridor (as mentioned in version 14) at a level above the said compact monolayer 23 [i.e. if the method according version 19C1 is chosen, then, all the said appropriate sized containers 24 (which are placed at numerous locations along the entire length of the said long corridor—as mentioned in version 14—at a level above the said compact monolayer 23) should contain the said suitable material which is required by version 19C1].

The contents of the said appropriate sized containers 24 need to be replaced by “fresh” materials periodically, as needed.

Whichever of the methods mentioned above is chosen, the speed of the said conveyor belt 9 (i.e. the travelling speed of the said shallow tray 11) is adjusted so that by the time the said shallow tray 11 reaches the end of its journey [i.e. the opposite end of the said long corridor (as mentioned in version 14)], all the said suitable vehicle 19 has been removed from beneath the said compact monolayer 23 and the latter comes to rest/spread/deposit directly on the upper surface of the said suitable substrate 1.

Using the said conveyor belt system (and the methods mentioned above) allows a “row” of the said shallow trays 11 to be placed on the said conveyor belt 9 and thus allows for a continuous process for “industrial” production.

Version 30: Referring to FIG. 45: According to this version of the invention, a compact monolayer 23 [made up of a suitable organic material (or organic compound)] floating on top of a suitable vehicle 19 is “persuaded” to spread/deposit on the upper surface of a suitable substrate 1 by means of the attractive forces of electrostatic charges.

The above objective may be achieved by means of “projecting” an electrostatic charge (either positive or negative), by suitable method(s), onto the lower surface of the said compact monolayer 23 while “projecting” an electrostatic charge of opposite sign (to that of the said electrostatic charge projected onto the said lower surface of the said compact monolayer 23), by suitable method(s), onto the said upper surface of the said suitable substrate 1.

As a result of the presence of the attractive electrostatic forces between the said lower surface of the said compact monolayer 23 and the said upper surface of the said suitable substrate 1 (due to the presence of the said opposite sign electrostatic charges on the above-mentioned surfaces), the said compact monolayer 23 is “persuaded” to spread/deposit on the said upper surface of the said suitable substrate 1.

The said compact monolayer 23, the said suitable substrate 1, the said suitable vehicle 19, and the shallow tray 11 which are used in the preparation of the said compact monolayer 23 according to this version of the invention should have the properties listed below:

A property of the said compact monolayer 23 is that its surface is capable of “accepting” an electrostatic charge and “trapping”/“holding on to” the said electrostatic charge.

A property of the said suitable substrate 1 is that its surface is capable of “accepting” an electrostatic charge and “trapping”/“holding on to” the said electrostatic charge.

One of the properties of the said suitable vehicle 19 is that when the said compact monolayer 23 (which is floating on the top of the said suitable vehicle 19) is carrying an electrostatic charge on its surface, the said suitable vehicle 19 does not “adversely interfere” with the said electrostatic charge i.e. the said suitable vehicle 19 does not cause the said electrostatic charge carried by the said compact monolayer 23 to be “neutralized”.

Another property of the said suitable vehicle 19 is that when the said suitable substrate 1 is carrying an electrostatic charge on its surface, the said suitable vehicle 19 does not adversely interfere with the said electrostatic charge i.e. the said suitable vehicle 19 does not cause the said electrostatic charge carried by the said suitable substrate 1 to be “neutralized”.

A property of the said shallow tray 11 is that the latter does not adversely interfere with the electrostatic charges carried by the other components throughout the processes i.e. the said shallow tray 11 does not cause the said electrostatic charges carried by the said compact monolayer 23 or the said suitable substrate 1 to be “neutralized”.

The sequence of steps to prepare a compact monolayer 23 [made up of a suitable organic material (or organic compound)] spread/deposited on the upper surface of a suitable substrate 1 according to this version of the invention is as follows:

First, a long sealed shallow container is used that is identical to that described in version 15.

Then, a suitable substrate 1 is placed at the bottom of the said shallow tray 11 (as described in version 15.

Then, a compact monolayer 23 [made up of a suitable organic material (or organic compound)] is produced in one piece [(by one of the conventional methods), floating on top of a suitable vehicle 19] inside the said shallow tray 11.

Next, the said shallow tray 11 is placed on the floor, inside the said long sealed shallow container 8.

Next, an electrostatic charge is “projected” onto the lower surface of the said compact monolayer 23 [made up of a suitable organic material (or organic compound)] by suitable means.

Next, one side of the said suitable substrate 1 is raised slightly so that the said suitable substrate 1 is no longer completely horizontal i.e. there is now an “angle of inclination” between the “horizontal level” and the said suitable substrate 1.

Next, an electrostatic charge of opposite sign to that projected onto the lower surface of the said compact monolayer 23 [made up of a suitable organic material (or organic compound)] is projected onto the upper surface of the said suitable substrate 1 by suitable means i.e. if the said lower surface of the said compact monolayer 23 [made up of a suitable organic material (or organic compound)] carries a positive electrostatic charge, then the said upper surface of the said suitable substrate 1 should end up carrying a negative electrostatic charge.

Next, the entire “body” of the said charged suitable substrate 1 is raised “uniformly” in a very slow manner (in order to prevent causing ripples or “disturbing” the said charged compact monolayer 23) i.e. the magnitude of the said angle of inclination is kept constant throughout the said raising process of the said charged suitable substrate 1.

Eventually, as the said charged suitable substrate 1 rises, the said charged upper surface of the said raised side of the said charged suitable substrate 1 “breaks through” the surface of the liquid inside the said shallow tray 11 (i.e. breaks through the said vehicle 19 and the said charged compact monolayer 23), thus the said lower surface of the said charged compact monolayer 23 [made up of a suitable organic material (or organic compound)] comes into contact with the said oppositely charged upper surface of the said raised side of the said suitable substrate 1. As a result, the said lower surface of the said compact monolayer 23 [made up of a suitable organic material (or organic compound)] will be attracted to, and therefore, adhere to the said upper surface of the said raised side of the said suitable substrate 1, because the former and the latter carry electrostatic charges of opposite signs.

As the “gentle” raising of the said charged suitable substrate 1 proceeds, the said charged upper surface of the said suitable substrate 1 will progressively become “covered” with the said oppositely charged compact monolayer 23 [made up of a suitable organic material (or organic compound)] until the entire “body” of the said suitable substrate 1 is raised above the said liquid inside the said shallow tray 11 (i.e. above the said vehicle 19 and the said charged compact monolayer 23). The end result of the above process is that the said compact monolayer 23 [made up of a suitable organic material (or organic compound)] will come to rest/spread/deposit directly on the said upper surface of the said suitable substrate 1.

Next, both the said compact monolayer 23 [made up of a suitable organic material (or organic compound)] and the said suitable substrate 1 may be neutralized by a discharge (e.g. bleed off to ground).

The next step involves the removal of the last remnants/traces of the said vehicle 19 which might have been trapped between the said lower surface of the said compact monolayer 23 and the said upper surface of the said suitable substrate 1, which may be achieved by using methods described in version 29.

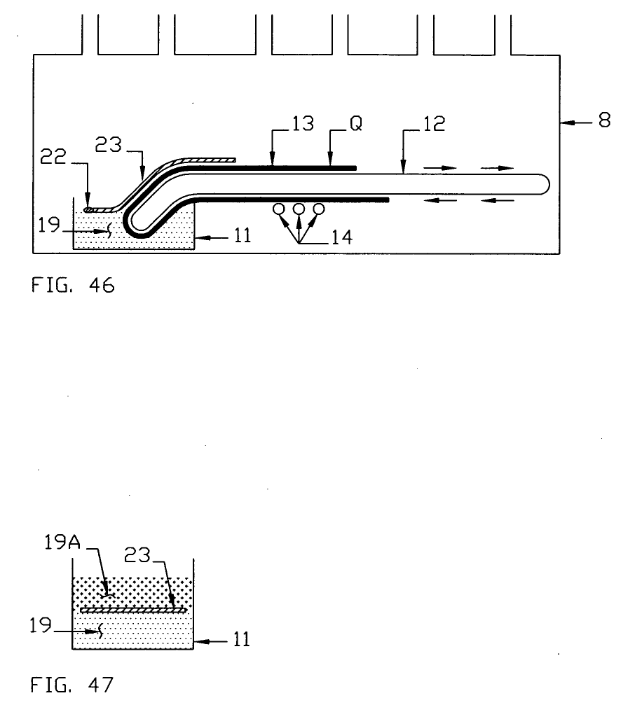

Version 31: Referring to FIG. 46: According to this version of the invention, a compact monolayer 23 [made up of a suitable organic material (or organic compound)] floating on top of a suitable vehicle 19 is “persuaded” to spread/deposit on the outward surface Q of a suitable substrate strip 13 (as described in version 16) by means of the attractive forces of electrostatic charges.

The above objective may be achieved by means of “projecting” an electrostatic charge (either positive or negative), by suitable method(s), onto the lower surface of the said compact monolayer 23 while “projecting” an electrostatic charge of opposite sign—to that of the said electrostatic charge projected onto the said lower surface of the said compact monolayer 23—by suitable method(s), onto the said outward surface Q of the said suitable substrate strip 13.

As a result of the presence of the attractive electrostatic forces between the said lower surface of the said compact monolayer 23 and the said outward surface Q of the said suitable substrate strip 13 (due to the presence of the said opposite sign electrostatic charges on the above-mentioned surfaces), the said compact monolayer 23 is “persuaded” to spread/deposit on the said outward surface Q of the said suitable substrate strip 13.

The said compact monolayer 23 [made up of a suitable organic material (or organic compound)], the “encircling instrument” 22 (used for pushing the outer periphery of the said compact monolayer 23 as described in version 18), the said substrate strip 13, the said suitable vehicle 19, the shallow tray 11, and the rollers 14 (holding the said substrate strip 13 in “place” as described in version 16) which are used in the preparation of the said compact monolayer 23 according to this version of the invention should have the properties listed below:

A property of the said compact monolayer 23 [made up of a suitable organic material (or organic compound)] is that its surface is capable of “accepting” an electrostatic charge and “trapping”/“holding on to” the said electrostatic charge.

One of the properties of the said suitable substrate strip 13 is that the latter as well as its outward surface Q are capable of “accepting” an electrostatic charge and “trapping”/“holding on to” the said electrostatic charge.

Another property of the said suitable substrate strip 13 is that its outward surface Q is made up of a material that does not carbonize when subjected to a heat source, as described in version 23.

One of the properties of the said suitable vehicle 19 is that when the said compact monolayer 23 (which is floating on the top of the said suitable vehicle 19) is carrying an electrostatic charge on its surface, the said suitable vehicle 19 does not “adversely interfere” with the said electrostatic charge i.e. the said suitable vehicle 19 does not cause the said electrostatic charge carried by the said compact monolayer 23 to be “neutralized”.

Another property of the said suitable vehicle 19 is that when the said suitable substrate strip 13 is carrying an electrostatic charge on its outward surface Q, the said suitable vehicle 19 does not “adversely interfere” with the said electrostatic charge i.e. the said suitable vehicle 19 does not cause the said electrostatic charge carried by the said outward surface Q of the said substrate strip 13 to be “neutralized”.

A property of the said shallow tray 11 is that the latter does not “adversely interfere” with the electrostatic charges carried by the other components throughout the processes i.e. the said shallow tray 11 does not cause the said electrostatic charges carried by the other components to be “neutralized”.

A property of the said “encircling instrument” 22 (used for pushing the outer periphery of the said compact monolayer 23 as described in version 18) is that the said encircling instrument 22 does not “adversely interfere” with the electrostatic charges carried by the other components throughout the processes i.e. the said encircling instrument 22 does not cause the said electrostatic charges carried by the other components to be “neutralized”.

A property of the said rollers 14 is that the latter do not “adversely interfere” with the electrostatic charges of the other components throughout the processes i.e. the said rollers 14 do not cause the said electrostatic charges carried by the other components to be “neutralized”.

The sequence of steps to prepare a compact monolayer 23 [made up of a suitable organic material (or organic compound)] spread/deposited on the said outward surface Q of a suitable substrate strip 13 according to version 31 is as follows:

First, a long sealed shallow container is used that is identical to that described in version 16.

Next, a compact monolayer 23 [made up of a suitable organic material (or organic compound)] is produced in one piece [(by one of the conventional methods), floating on top of a suitable vehicle 19] inside a shallow tray 11.

Next, the said shallow tray 11 is placed inside the said long sealed shallow container 8 close to one end of the long corridor as mentioned in version 16, in such a manner that the “sloped” end of the conveyor belt system 12, as mentioned in version 16(and consequently, the said outward surface Q of the said substrate strip 13) which is proximal to the said shallow tray 11, “dips” into the said shallow tray 11 and positions its tip/apex at a suitable level below the said compact monolayer 23 and inside the said vehicle 19.

Next, an electrostatic charge is “projected” onto the said lower surface of the said compact monolayer 23 [made up of a suitable organic material (or organic compound)] by a suitable method.

Next, an electrostatic charge of opposite sign to that projected onto the said lower surface of the said compact monolayer 23 [made up of a suitable organic material (or organic compound)] is “projected” onto the said outward surface Q of the said suitable substrate strip 13 by a suitable method i.e. if the said lower surface of the said compact monolayer 23 [made up of a suitable organic material (or organic compound)] carries a positive electrostatic charge, then the said outward surface Q of the said suitable substrate strip 13 should end up carrying a negative electrostatic charge.

Next, the said conveyor belt system 12 (as mentioned in version 16) is switched on which causes the said suitable substrate strip 13 to “travel” in the direction as described in version 16, while simultaneously the said compact monolayer 23 is “pushed”, at a controlled rate of speed, towards the said suitable substrate strip 13 by pushing the said “encircling instrument” 22 (used for pushing the outer periphery of the said compact monolayer 23 as described in version 18) in the direction towards the said suitable substrate strip 13.

As a result of the presence of the attractive electrostatic forces between the said lower surface of the said compact monolayer 23 and the said outward surface Q of the said suitable substrate strip 13 (due to the presence of the said opposite sign electrostatic charges on the above-mentioned surfaces), the said compact monolayer 23 is attracted to, and, adhere to the said outward surface Q of the said suitable substrate strip 13.

The speed of the said pushing of the said compact monolayer 23 towards the said suitable substrate strip 13, as described above, should be “controlled” to be at an “optimum magnitude”, because, if the said speed is too fast, then the said compact monolayer 23 will scrunch and result in a multi layered organic material (or organic compound) as the said suitable substrate strip 13 would be moving too slow relative to the said compact monolayer 23, conversely, if the said pushing is too slow, then the said compact monolayer 23 will “rupture”/break, as the said suitable substrate strip 13 would be moving too fast relative to the said compact monolayer 23.

Next, both the said compact monolayer 23 and the said suitable substrate strip 13 may be neutralized by a discharge (e.g. bleed off to ground).

The next step involves the removal of the last remnants/traces of the said suitable vehicle 19 which might have been trapped between the said lower surface of the said compact monolayer 23 and the said outward surface Q of the said suitable substrate strip 13, which may be achieved by using methods described in version 29.

Version 32: This version of the invention is identical to version 31, except that according to this version of the invention, a compact monolayer 23 [made up of a suitable organic material (or organic compound)] which is doped is used instead of the said compact monolayer 23 used in version 31, where the said doped compact monolayer 23 “participates” in all the steps as described in version 31.

Version 33: This version of the invention is identical to version 30, except that according to this version of the invention, a compact monolayer 23 [made up of a suitable organic material (or organic compound)] which is doped is used instead of the compact monolayer 23 used in version 30, where the said doped compact monolayer 23 “participates” in all the steps as described in version 30.

Version 34: Referring to FIG. 47: This version of the invention is comprised of “projecting” an electrostatic charge (either positive or negative), by suitable method(s), onto the lower surface of a compact monolayer 23 [made up of a suitable organic material (or organic compound)] where the latter is prepared according to a conventional method inside a shallow tray 11 in a manner such that the said compact monolayer 23 is “sandwiched” between 2 suitable vehicles 19 and 19A.

The said compact monolayer 23 possesses properties identical to those of the compact monolayer 23 mentioned in version 30, and similarly, each of the said suitable vehicles 19 and 19A possesses properties identical to those of the suitable vehicle mentioned in version 30.

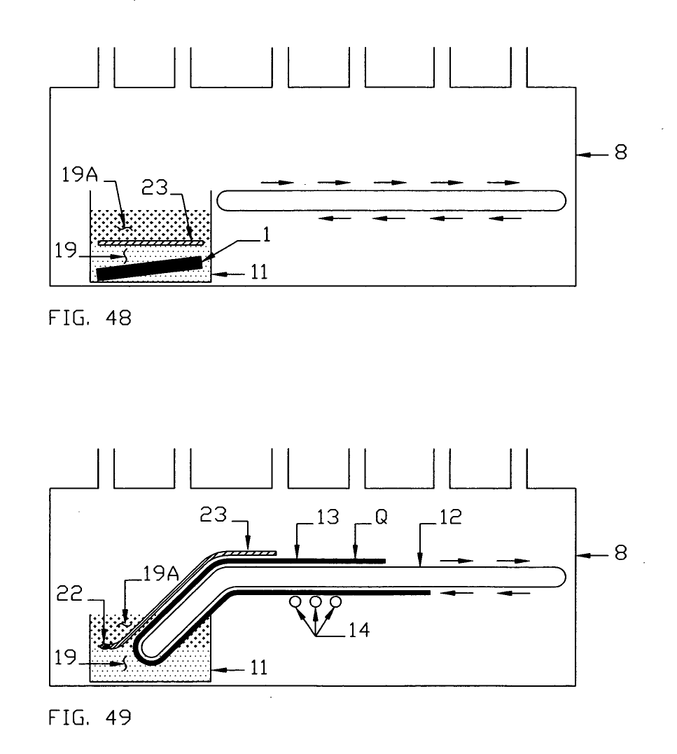

Version 35: Referring to FIG. 48: According to this version of the invention, a compact monolayer 23 [made up of a suitable organic material (or organic compound)] “sandwiched” between 2 suitable vehicles 19 and 19A, as described in version 34, is “persuaded” to spread/deposit on the upper surface of a suitable substrate 1 by means of the attractive forces of electrostatic charges.

The above objective may be achieved by means of “projecting” an electrostatic charge (either positive or negative), by suitable method(s), onto the lower surface of the said compact monolayer 23 while “projecting” an electrostatic charge of opposite sign—to that of the said electrostatic charge projected onto the said lower surface of the said compact monolayer 23—by suitable method(s), onto the said upper surface of the said suitable substrate 1.

The said compact monolayer 23, the said suitable substrate 1, the said suitable vehicles 19 and 19A, and the said shallow tray 11 which are used in this version of the invention should have the properties identical to those of the said compact monolayer 23, the said suitable substrate 1, the said suitable vehicle 19, and the said shallow tray 11 mentioned in version 30.

The sequence of steps to prepare a compact monolayer 23 [made up of a suitable organic material (or organic compound)] spread/deposited on the upper surface of a suitable substrate 1 according to this version of the invention are as follows:

First, a long sealed shallow container is used that is identical to that described in version-15.

Next, a suitable substrate 1 is placed at the bottom of a shallow tray 11 (as described in version 15).

Then, a compact monolayer 23 [made up of a suitable organic material (or organic compound)] is produced in one piece (inside the said shallow tray 11) according to a conventional method in a manner such that the said compact monolayer 23 is “sandwiched” between 2 suitable vehicles 19 and 19A.

Next, the said shallow tray 11 is placed on the floor, inside the said long sealed shallow container 8.

Next, an electrostatic charge is “projected” onto the lower surface of the said compact monolayer 23 by suitable means.

Next, one side of the said suitable substrate 1 is raised slightly so that the said suitable substrate 1 is no longer completely horizontal i.e. there is now an “angle of inclination” between the “horizontal level” and the said suitable substrate 1.

Next, an electrostatic charge of opposite sign to that projected onto the said lower surface of the said compact monolayer 23 is projected onto the upper surface of the said suitable substrate 1 by suitable means i.e. if the said lower surface of the said compact monolayer 23 carries a positive electrostatic charge, then the said upper surface of the said suitable substrate 1 should end up carrying a negative electrostatic charge.

Next, the entire “body” of the said charged suitable substrate 1 is raised “uniformly” in a very slow manner (in order to prevent causing ripples or “disturbing” the said charged compact monolayer 23) i.e. the magnitude of the said angle of inclination is kept constant throughout the said raising process of the said charged suitable substrate 1.

As the said charged suitable substrate 1 rises, the said charged upper surface of the said raised side of the said charged suitable substrate 1 comes into contact with the said oppositely charged lower surface of the said compact monolayer 23. As a result, the said lower surface of the said compact monolayer 23 will be attracted to, and therefore, adhere to the said upper surface of the said raised side of the said suitable substrate 1, because the former and the latter carry electrostatic charges of opposite signs.

As the “gentle” raising of the said charged suitable substrate 1 proceeds, the said charged upper surface of the said suitable substrate 1 will progressively become “covered” with the said oppositely charged compact monolayer 23 until all of the said upper surface of the said charged suitable substrate 1 is “covered” with the said compact monolayer 23 [made up of a suitable organic material (or organic compound)].

The end result of the above process is that the said compact monolayer 23 will come to rest/spread/deposit directly on the said upper surface of the said suitable substrate 1.

Next, the said raising of the said suitable substrate 1 is continued until the entire “body” of the said suitable substrate 1 has moved completely out of the said vehicles 19 and 19A, and the said suitable substrate 1 is removed from the said shallow tray 11.

Next, both the said compact monolayer 23 and the said suitable substrate 1 may be neutralized by a discharge (e.g. bleed off to ground).

The next step involves the removal of the last remnants/traces of the said vehicles 19 and 19A which might have been trapped between the said lower surface of the said compact monolayer 23 and the said upper surface of the said suitable substrate 1, which may be achieved by using methods described in version 29.

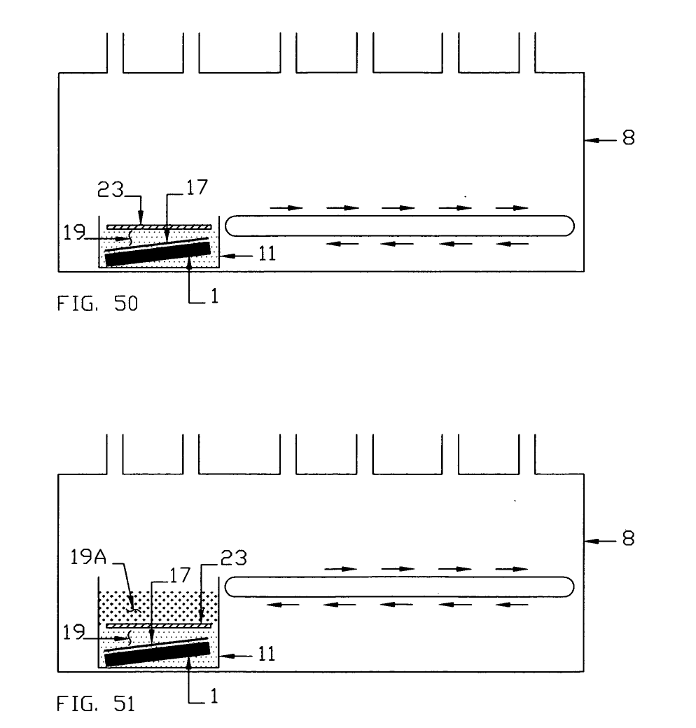

Version 36: Referring to FIG. 49: According to this version of the invention, a compact monolayer 23 [made up of a suitable organic material (or organic compound)] “sandwiched” between 2 suitable vehicles 19 and 19A, as described in version 34, is “persuaded” to spread/deposit on the outward surface Q of a suitable substrate strip 13 (as described in version 16) by means of the attractive forces of electrostatic charges.

The above objective may be achieved by means of “projecting” an electrostatic charge (either positive or negative), by suitable method(s), onto the lower surface of the said compact monolayer 23 while “projecting” an electrostatic charge of opposite sign—to that of the said electrostatic charge projected onto the said lower surface of the said compact monolayer 23—by suitable method(s), onto the said outward surface Q of the said suitable substrate strip 13.

The said compact monolayer 23, the “encircling instrument” 22 (used for pushing the said compact monolayer 23 as described in version 18), the said suitable substrate strip 13, the said suitable vehicles 19 and 19A, the shallow tray 11, and the rollers 14 (holding the said substrate strip 13 in “place” as described in version 16) which are used in this version of the invention should have the properties identical to those of the said compact monolayer 23, the said “encircling instrument” 22 (used for pushing the said compact monolayer 23), the said suitable substrate strip 13, the said suitable vehicle 19, the said shallow tray 11, and the said rollers 14 (holding the said substrate strip 1 in “place”) mentioned in version 31.

The sequence of steps to prepare a compact monolayer 23 spread/deposited on the outward surface Q of a suitable substrate strip 13 according to this version of the invention is as follows:

First, a long sealed shallow container 8 is used that is identical to that described in version 16.

Next, a compact monolayer 23 [made up of a suitable organic material (or organic compound)] is produced in one piece (inside a shallow tray 11) according to a conventional method in a manner such that the said compact monolayer 23 is “sandwiched” between 2 suitable vehicles 19 and 19A.

Next, the said shallow tray 11 is placed on the floor, inside the said long sealed shallow container 8 close to one end of the said long corridor as mentioned in version 16, in such a manner that the “sloped” end of the said conveyor belt system 12, as mentioned in version 16 (and consequently, the said outward surface Q of the said suitable substrate strip 13) which is proximal to the said shallow tray 11 “dips” into the said shallow tray 11 and positions its tip/apex at a suitable level below the said compact monolayer 23 and inside the said suitable vehicles 19 and 19A.

Next, an electrostatic charge is “projected” onto the lower surface of the said compact monolayer 23 by suitable means.

Next, an electrostatic charge of opposite sign to that projected onto the said lower surface of the said compact monolayer 23 is projected onto the said outward surface Q of the said suitable substrate strip 13 by suitable means i.e. if the said lower surface of the said compact monolayer 23 carries a positive electrostatic charge, then the said outward surface Q of the said suitable substrate strip 13 should end up carrying a negative electrostatic charge.

Next, the said conveyor belt system 12 (as mentioned in version 16) is switched on which causes the said suitable substrate strip 13 to “travel” in the direction as described in version 16, while simultaneously the said compact monolayer 23 is “pushed”, at a controlled rate of speed, towards the said suitable substrate strip 13 by pushing the “encircling instrument” 22 (used for pushing the outer periphery of the said compact monolayer 23 as described in version 18) in the direction towards the said suitable substrate strip 13.

As a result of the presence of the attractive electrostatic forces between the said lower surface of the said compact monolayer 23 and the said outward surface Q of the said suitable substrate strip 13 (due to the presence of the said opposite sign electrostatic charges on the above-mentioned surfaces), the said compact monolayer 23 is attracted to, and, adhere to the said outward surface Q of the said substrate strip 13 and thus is “persuaded” to spread/deposit on the said outward surface Q of the said substrate strip 13.

The speed of the said pushing of the said compact monolayer 23 towards the said suitable substrate strip 13, as described above, should be “controlled” to be at an “optimum magnitude”, because, if the said speed is too fast, then the said compact monolayer 23 will scrunch and result in a multi layered organic material (or organic compound) as the said suitable substrate strip 13 would be moving too slow relative to the said compact monolayer 23, conversely, if the said pushing is too slow, then the said compact monolayer 23 will “rupture”/break, as the said suitable substrate strip 13 would be moving too fast relative to the said compact monolayer 23.

Next, both the said compact monolayer 23 and the said suitable substrate strip 13 may be neutralized by a discharge (e.g. bleed off to ground).

The next step involves the removal of the last remnants/traces of the said vehicles 19 and 19A which might have been trapped between the said lower surface of the said compact monolayer 23 and the said outward surface Q of the said suitable substrate strip 13, which may be achieved by using methods described in version 29.

Version 37: Referring to FIG. 50: According to this version of the invention, a compact monolayer 23 [made up of a suitable organic material (or organic compound)] floating on top of a suitable vehicle 19 is “persuaded” to spread/deposit on the upper surface of a “temporary substrate” 17 by means of the attractive forces of electrostatic charges.

This version of the invention is identical to version 30 except that in this version of the invention, a “temporary substrate” 17 is positioned (and “held in place”) above (and in the proximity of) the said upper surface of the suitable substrate 1 used in version 30, by suitable means; therefore, the said suitable substrate 1 and the said temporary substrate 17 continue to keep their positions “unchanged” relative to one another throughout the processes involved in this version of the invention i.e. when the said suitable substrate 1 rises, then, the said temporary substrate 17 also rises at exactly the same rate of speed, thus keeping the distance separating them constant.

The said compact monolayer 23, the said suitable substrate 1, the said suitable vehicle 19, and the said shallow tray 11 which are used in this version of the invention should have the properties identical to those of the said compact monolayer 23, the said suitable substrate 1, the said suitable vehicle 19, and the said shallow tray 11 mentioned in version 30.

One of the properties of the said temporary substrate 17 and the “materials/instruments” that keep the said temporary substrate 17 in the proximity of the said suitable substrate 1 used in this version of the invention is that they should not adversely interfere with the electrostatic charges carried by the other components used in this version of the invention i.e. the above-mentioned temporary substrate 17 and the said “materials/instruments” should not cause the electrostatic charges carried by the said compact monolayer 23 or the said suitable substrate 1 to be “neutralized”.

One of the properties of the said temporary substrate 17 is that it should be adequately thin so as to allow the “passage/penetration” of “the electrostatic forces”—carried by the said lower surface of the said compact monolayer 23 and the said upper surface of the said suitable substrate 1, mentioned in version 30—to take place effectively and efficiently across its width.

The sequence of steps according to this version of the invention is similar to those of the version 30, as follows:

First, a long sealed shallow container is used that is identical to that described in version-15.

Next, a suitable substrate 1 is placed at the bottom of a shallow tray 11 (as described in version 15).

Next, a temporary substrate 17 is positioned (and “held in place”) above (and in the proximity of) the upper surface of the said suitable substrate 1.

Next, a compact monolayer 23 [made up of a suitable organic material (or organic compound)] is produced in one piece [(by one of the conventional methods), floating on top of a suitable vehicle 19] inside the said shallow tray 11.

Next, the said shallow tray 11 is placed on the floor, inside the said long sealed shallow container 8.

Next, an electrostatic charge is “projected” onto the lower surface of the said compact monolayer 23 by suitable means.

Next, one side of the said suitable substrate 1 is raised slightly so that the said suitable substrate 1 is no longer completely horizontal i.e. there is now an “angle of inclination” between the “horizontal level” and the said suitable substrate 1, keeping in mind that the said temporary substrate 17 simultaneously follows exactly every move that the said suitable substrate 1 makes.

Next, an electrostatic charge of opposite sign to that projected onto the said lower surface of the said compact monolayer 23 is projected onto the upper surface of the said suitable substrate 1 by suitable means i.e. if the said lower surface of the said compact monolayer 23 carries a positive electrostatic charge, then the said upper surface of the said suitable substrate 1 should end up carrying a negative electrostatic charge.

Next, the entire “body” of the said charged suitable substrate 1 (and therefore the said temporary substrate 17) is raised “uniformly” in a very slow manner (in order to prevent causing ripples or “disturbing” the said charged compact monolayer 23) i.e. the magnitude of the said angle of inclination is kept constant throughout the said raising process of the said charged suitable substrate 1 (and therefore the said raising process of the said temporary substrate 17).

Eventually, as the said charged suitable substrate 1 rises, the said upper surface of the said raised side of the said temporary substrate 17 comes into contact with the said oppositely charged lower surface of the said compact monolayer 23.

As the said temporary substrate 17 does not “interfere with” the various electrostatic forces present (i.e. it allows the attractive and/or repulsive forces to pass through freely), therefore, the said lower surface of the said compact monolayer 23 will be attracted to the said upper surface of the said raised side of the said suitable substrate 1, however, as the said temporary substrate 17 is positioned between the said compact monolayer 23 and the said suitable substrate 1, therefore, the said compact monolayer 23 will adhere to the said upper surface of the said raised side of the said temporary substrate 17.

As the “gentle” raising of the said charged suitable substrate 1 (and the said temporary substrate 17) proceeds, the said upper surface of the said temporary substrate 17 will progressively become “covered” with the said oppositely charged compact monolayer 23 until the entire said upper surface of the said temporary substrate 17 is “covered” with the said compact monolayer 23.

Next, the said raising of the said suitable substrate 1 (and the said temporary substrate 17) is continued until the entire “body” of the said suitable substrate 1 (and the said temporary substrate 17) has moved completely out of the said vehicle 19 and the said suitable substrate 1 (and the said temporary substrate 17) are removed from the said shallow tray 11.

The end result of the above process is that the said compact monolayer 23 has come to rest/spread/deposit directly on the said upper surface of the said temporary substrate 17.

Next, the said temporary substrate 17, with the said compact monolayer 23 spread/deposited on its upper surface, is “detached” and “moved away” from the said suitable substrate 1.

Next, both the said compact monolayer 23 and the said suitable substrate 1 may be neutralized by a discharge (e.g. bleed off to ground).

The next step involves the removal of the last remnants/traces of the said vehicle 19 which might have been trapped between the said lower surface of the said compact monolayer 23 and the said upper surface of the said temporary substrate 17, which may be achieved by using methods described in version 29.

Version 38: Referring to FIG. 51: According to this version of the invention, a compact monolayer 23 [made up of a suitable organic material (or organic compound)] “sandwiched” between 2 suitable vehicles 19 and 19A as described in version 34, is “persuaded” to spread/deposit on the upper surface of a “temporary substrate” 17 by means of the attractive forces of electrostatic charges.

This version of the invention is identical to version 35 except that in this version of the invention, a “temporary substrate” 17 is positioned (and “held in place”) above (and in the proximity of) the upper surface of a suitable substrate 1 as described in version 35, by suitable means; therefore, the said suitable substrate 1 and the said temporary substrate 17 continue to keep their positions “unchanged” relative to one another throughout the processes involved in this version of the invention i.e. when the said suitable substrate 1 rises, then, the said temporary substrate 17 also rises at exactly the same rate of speed, thus keeping the distance separating them constant.

The said compact monolayer 23, the said suitable substrate 1, the said suitable vehicles 19 and 19A, and the shallow tray 11 which are used in this version of the invention should have the properties identical to those of the said compact monolayer 23, the said suitable substrate 1, the said suitable vehicles 19 and 19A, and the said shallow tray 11 mentioned in version 35.

The said temporary substrate 17 and the “materials/instruments” that keep the said temporary substrate 17 in the proximity of the said suitable substrate 1 used in this version of the invention should have the properties identical to those of the said temporary substrate 17 and the said “materials/instruments” mentioned in version 37.

The sequence of steps to prepare a compact monolayer 23 [made up of a suitable organic material (or organic compound)] spread/deposited on the upper surface of a temporary substrate 17 according to this version of the invention are as follows:

First, a long sealed shallow container is used that is identical to that described in version 15.

Next a suitable substrate 1 is placed at the bottom of a shallow tray 11 (as described in version 15).

Next a temporary substrate 17 is positioned (and “held in place”) above (and in the proximity of) the upper surface of the said suitable substrate 1.

Then, a compact monolayer 23 [made up of a suitable organic material (or organic compound)] is produced in one piece (inside the said shallow tray 11, as described in version 15) according to a conventional method in a manner such that the said compact monolayer 23 is “sandwiched” between 2 suitable vehicles 19 and 19A.

Next, the said shallow tray 11 is placed on the floor, inside the said long sealed shallow container 8.

Next, an electrostatic charge is “projected” onto the lower surface of the said compact monolayer 23 by suitable means.

Next, one side of the said suitable substrate 1 is raised slightly so that the said suitable substrate 1 is no longer completely horizontal i.e. there is now an “angle of inclination” between the “horizontal level” and the said suitable substrate 1, keeping in mind that the said temporary substrate 17 simultaneously follows exactly every move that the said suitable substrate 1 makes.

Next, an electrostatic charge of opposite sign to that projected onto the said lower surface of the said compact monolayer 23 is projected onto the said upper surface of the said suitable substrate 1 by suitable means i.e. if the said lower surface of the said compact monolayer 23 carries a positive electrostatic charge, then the said upper surface of the said suitable substrate 1 should end up carrying a negative electrostatic charge.

Next, the entire “body” of the said charged suitable substrate 1 (and therefore the said temporary substrate 17) is raised “uniformly” in a very slow manner (in order to prevent causing ripples or “disturbing” the said charged compact monolayer 23) i.e. the magnitude of the said angle of inclination is kept constant throughout the said raising process of the said charged suitable substrate 1 (and therefore the said raising process of the said temporary substrate 17).

Eventually, as the said charged suitable substrate 1 rises, the said upper surface of the said raised side of the said temporary substrate 17 comes into contact with the said oppositely charged lower surface of the said compact monolayer 23.

As the said temporary substrate 17 does not “interfere with” the various electrostatic forces present (i.e. it allows the attractive and/or repulsive forces to pass through freely), therefore, the said lower surface of the said compact monolayer 23 will be attracted to the said upper surface of the said raised side of the said suitable substrate 1, however, as the said temporary substrate 17 is positioned between the said compact monolayer 23 and the said suitable substrate 1, therefore, the said compact monolayer 23 will adhere to the said upper surface of the said raised side of the said temporary substrate 17.

As the “gentle” raising of the said charged suitable substrate 1 (and the said temporary substrate 17) proceeds, the said upper surface of the said temporary substrate 17 will progressively become “covered” with the said oppositely charged compact monolayer 23 until the entire said upper surface of the said temporary substrate 17 is “covered” with the said compact monolayer 23.

Next, the said raising of the said suitable substrate 1 (and the said temporary substrate 17) is continued until the entire “body” of the said suitable substrate 1 (and the said temporary substrate 17) has moved completely out of the said vehicles 19 and 19A, and the said suitable substrate 1 (and the said temporary substrate 17) are removed from the said shallow tray 11.

The end result of the above process is that the said compact monolayer 23 has come to rest/spread/deposit directly on the said upper surface of the said temporary substrate 17.

Next, the said temporary substrate 17, with the said compact monolayer 23 spread/deposited on its upper surface, is “detached” and “moved away” from the said suitable substrate 1.

Next, the said compact monolayer 23 may be neutralized by a discharge (e.g. bleed off to ground).

The next step involves the removal of the last remnants/traces of the said vehicles 19 and 19A which might have been trapped between the said lower surface of the said compact monolayer 23 and the said upper surface of the said temporary substrate 17, which may be achieved by using methods described in version 29.

Version 39: Referring to FIG. 52: According to this version of the invention, a compact monolayer 23 [made up of a suitable organic material (or organic compound)] floating on top of a suitable vehicle 19 is “persuaded” to spread/deposit on the upper surface R of a “temporary substrate strip” 18 by means of the attractive forces of electrostatic charges.

This version of the invention is identical to version 31 except that in this version of the invention, a “temporary substrate strip” 18 is positioned (and “held in place”) in the proximity of the outward surface Q of the suitable substrate strip 13 used in version 31, by suitable means.

The said temporary substrate strip 18 and the said suitable substrate strip 13 continue to keep their positions “unchanged” relative to one another throughout the processes involved in this version of the invention i.e. when the said suitable substrate strip 13 moves (in the direction mentioned in version 31), then, the said temporary substrate strip 18 also moves in the same direction as the said suitable substrate strip 13 at exactly the same rate of speed while keeping the distance separating them constant.

The said compact monolayer 23, the said suitable substrate strip 13, the said suitable vehicle 19, the shallow tray 11, the said “encircling instrument” 22 as described in version 18, and the rollers 14 (holding the said substrate strip 13 in “place” as described in version 16) which are used in this version of the invention should have the properties identical to those of the said compact monolayer 23, the said suitable substrate strip 13, the said suitable vehicle 19, the said shallow tray 11, the said “encircling instrument” 22, and the said rollers 14 mentioned in version 31.

One of the properties of the said temporary substrate strip 18 and the “materials/instruments” that keep the said temporary substrate strip 18 in the proximity of the said suitable substrate strip 13 used in this version of the invention is that they should not adversely interfere with the electrostatic charges carried by the other components used in this version of the invention i.e. the above-mentioned temporary substrate strip 18 and the said “materials/instruments” should not cause the electrostatic charges carried by the said compact monolayer 23 or the said suitable substrate strip 13 to be “neutralized”.

One of the properties of the said temporary substrate strip 18 is that it should be adequately thin so as to allow the “passage/penetration” of “the electrostatic forces”—carried by the lower surface of the said compact monolayer 23 and the said suitable substrate strip 13, mentioned in version 31—to take place effectively and efficiently across its width.

The sequence of steps according to this version of the invention is similar to those of the version 31, as follows:

First, a long sealed shallow container is used that is identical to that described in the version 16.

Next, a compact monolayer 23 [made up of a suitable organic material (or organic compound)] is produced in one piece [(by one of the conventional methods), floating on top of a suitable vehicle 19] inside a tray 11.

Next a temporary substrate strip 18 is positioned (and “held in place”) in the proximity of the outward surface Q of a suitable substrate strip 13.

Next, the said shallow tray 11 is placed on the floor, inside the said long sealed shallow container 8 close to one end of the said long corridor as mentioned in version 16, in such a manner that the “sloped” end of the said conveyor belt system 12, as described in the version 16, (and consequently, the said outward surface Q of the said substrate strip 13 and the said temporary substrate strip 18) which is proximal to the said shallow tray 11 “dips” into the said shallow tray 11 and positions its tip/apex at a suitable level below the said compact monolayer 23 and inside the said suitable vehicle 19, as described in version 31.

Next, an electrostatic charge is “projected” onto the lower surface of the said compact monolayer 23 by suitable means.

Next, an electrostatic charge of opposite sign to that projected onto the said lower surface of the said compact monolayer 23 is projected onto the said outward surface Q of the said suitable substrate strip 13 by suitable means i.e. if the said lower surface of the said compact monolayer 23 carries a positive electrostatic charge, then the said outward surface Q of the said suitable substrate strip 13 should end up carrying a negative electrostatic charge.

Next, the said conveyor belt system 12 (as mentioned in version 16) is switched on which causes the said suitable substrate strip 13 (and therefore the said temporary substrate strip 18) to “travel” in the direction as described in version 16, while simultaneously the said compact monolayer 23 is “pushed”, at a controlled rate of speed, towards the said temporary substrate strip 18 by pushing the “encircling instrument” 22 (used for pushing the outer periphery of the said compact monolayer 23 as described in version 18) in the direction towards the said temporary substrate strip 18.

Eventually, the said lower surface of the said charged compact monolayer 23 comes into contact with the said upper surface R of the said temporary substrate strip 18; and as the said temporary substrate strip 18 does not “interfere with” the various electrostatic forces present (i.e. it allows the attractive and/or repulsive forces to pass through freely), therefore, the said lower surface of the said compact monolayer 23 will be attracted to the said outward surface Q of the said suitable substrate strip 13, however, as the said temporary substrate strip 18 is positioned between the said compact monolayer 23 and the said suitable substrate strip 13, therefore, the said compact monolayer 23 will adhere to the said upper surface R of the said temporary substrate strip 18.

The end result of the above process is that the said compact monolayer 23 will come to rest/spread/deposit directly on the said upper surface R of the said temporary substrate strip 18.

The speed of the said pushing of the said compact monolayer 23 towards the said temporary substrate strip 18, as described above, should be “controlled” to be at an “optimum magnitude”, because, if the said speed is too fast, then the said compact monolayer 23 will scrunch and result in a multi layered organic material (or organic compound) as the said temporary substrate strip 18 would be moving too slow relative to the said compact monolayer 23, conversely, if the said pushing is too slow, then the said compact monolayer 23 will “rupture”/break, as the said temporary substrate strip 18 would be moving too fast relative to the said compact monolayer 23.

Next, the said temporary substrate strip 18, with the said compact monolayer 23 spread/deposited on its upper surface R, is “detached” and “moved away” from the said suitable substrate strip 13.

Next, the said compact monolayer 23 spread/deposited on the said upper surface R of the said temporary substrate strip 18 may be neutralized by a discharge (e.g. bleed off to ground).

The next step involves the removal of the last remnants/traces of the said vehicle 19 which might have been trapped between the said lower surface of the said compact monolayer 23 and the said upper surface R of the said temporary substrate strip 18, which may be achieved by using methods described in version 29.

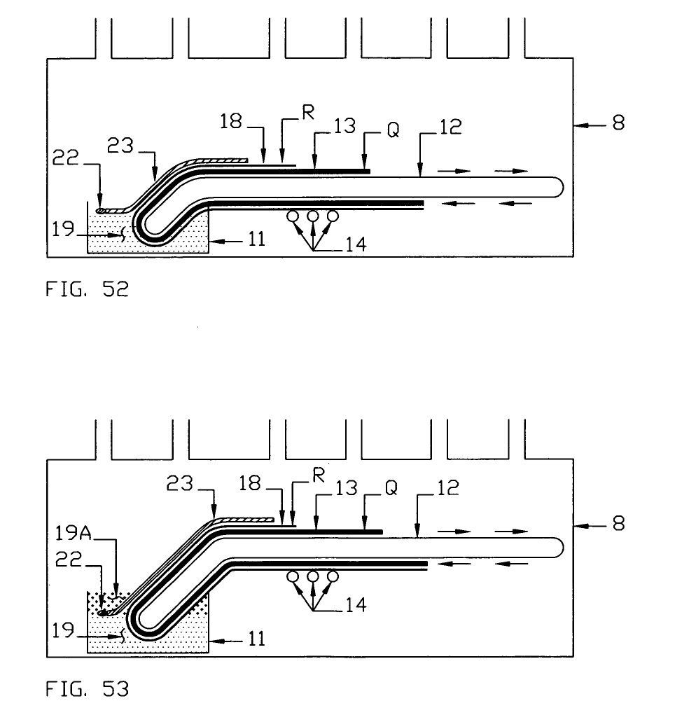

Version 40: Referring to FIG. 53: According to this version of the invention, a compact monolayer 23 [made up of a suitable organic material (or organic compound)] “sandwiched” between 2 suitable vehicles 19 and 19A is “persuaded” to spread/deposit on the upper surface R of a “temporary substrate strip” 18 by means of the attractive forces of electrostatic charges.

This version of the invention is identical to version 36 except that in this version of the invention, a “temporary substrate strip” 18 is positioned in the proximity of the outward surface Q of the suitable substrate strip 13 used in version 36, by suitable means.

The said temporary substrate strip 18 and the said suitable substrate strip 13 continue to keep their positions “unchanged” relative to one another throughout the processes involved in this version of the invention i.e. when the said suitable substrate strip 13 moves (in the direction mentioned in version 36), then, the said temporary substrate strip 18 also moves in the same direction as the said suitable substrate strip 13 at exactly the same rate of speed while keeping the distance separating them constant.

The said compact monolayer 23, the said suitable substrate strip 13, the said temporary substrate strip 18, the “materials/instruments” that keep the said temporary substrate strip 18 in the proximity of the said suitable substrate strip 13, the said suitable vehicles 19 and 19A, the shallow tray 11, the “encircling instrument” 22 as described in version 18, and the rollers 14 (holding the said substrate strip 13 in “place” as described in version 16) which are used in this version of the invention should have the properties identical to those of the said compact monolayer 23, the said suitable substrate strip 13, the said temporary substrate strip 18, the “materials/instruments” that keep the said temporary substrate strip 18 in the proximity of the said suitable substrate strip 13, the said suitable vehicle 19, the said shallow tray 11, the said “encircling instrument” 22, and the said rollers 14 mentioned in version 39.

The sequence of steps according to this version of the invention is similar to those of the version 36, as follows:

First, a long sealed shallow container is used that is identical to that described in the version 16.

Next, a compact monolayer 23 [made up of a suitable organic material (or organic compound)] is produced in one piece (inside a shallow tray 11) according to a conventional method in a manner such that the said compact monolayer 23 is “sandwiched” between 2 suitable vehicles 19 and 19A.

Next, a temporary substrate strip 18 is positioned (and “held in place”) in the proximity of the outward surface Q of a suitable substrate strip 13.

Next, the said shallow tray 11 is placed on the floor, inside the said long sealed shallow container 8 close to one end of the said long corridor as mentioned in version 16, in such a manner that the “sloped” end of the said conveyor belt system 12 (and consequently, the said outward surface Q of the said substrate strip 13 and the said temporary substrate strip 18) which is proximal to the said shallow tray 11 “dips” into the said shallow tray 11 and positions its tip/apex at a suitable level below the said compact monolayer 23 and inside the said suitable vehicles 19 and 19A, as described in version 36.

Next, an electrostatic charge is “projected” onto the lower surface of the said compact monolayer 23 by suitable means.

Next, an electrostatic charge of opposite sign to that projected onto the said lower surface of the said compact monolayer 23 is projected onto the said outward surface Q of the said suitable substrate strip 13 by suitable means i.e. if the said lower surface of the said compact monolayer 23 carries a positive electrostatic charge, then the said outward surface Q of the said suitable substrate strip 13 should end up carrying a negative electrostatic charge.

Next, the said conveyor belt system 12 (as mentioned in version 16) is switched on which causes the said suitable substrate strip 13 (and therefore the said temporary substrate strip 18) to “travel” in the direction as described in version 16, while simultaneously the said compact monolayer 23 is “pushed”, at a controlled rate of speed, towards the said temporary substrate strip 18 by pushing the “encircling instrument” 22 (used for pushing the outer periphery of the said compact monolayer 23 as described in version 18) in the direction towards the said temporary substrate strip 18.

Eventually, the said lower surface of the said charged compact monolayer 23 comes into contact with the said upper surface R of the said temporary substrate strip 18; and as the said temporary substrate strip 18 does not “interfere with” the various electrostatic forces present (i.e. it allows the attractive and/or repulsive forces to pass through freely), therefore, the said lower surface of the said compact monolayer 23 will be attracted to the said outward surface Q of the said suitable substrate strip 13, however, as the said temporary substrate strip 18 is positioned between the said compact monolayer 23 and the said suitable substrate strip 13, therefore, the said compact monolayer 23 will adhere to the said upper surface R of the said temporary substrate strip 18.

The end result of the above process is that the said compact monolayer 23 will come to rest/spread/deposit directly on the said upper surface R of the said temporary substrate strip 18.

The speed of the said pushing of the said compact monolayer 23 towards the said temporary substrate strip 18, as described above, should be “controlled” to be at an “optimum magnitude”, because, if the said speed is too fast, then the said compact monolayer 23 will scrunch and result in a multi layered organic material (or organic compound) as the said temporary substrate strip 18 would be moving too slow relative to the said compact monolayer 23, conversely, if the said pushing is too slow, then the said compact monolayer 23 will “rupture”/break, as the said temporary substrate strip 18 would be moving too fast relative to the said compact monolayer 23.

Next, the said temporary substrate strip 18, with the said compact monolayer 23 spread/deposited on its upper surface R, is “detached” and “moved away” from the said suitable substrate strip 13.

Next, both the said compact monolayer 23 and the said suitable substrate strip 13 may be neutralized by a discharge (e.g. bleed off to ground).

The next step involves the removal of the last remnants/traces of the said vehicles 19 and 19A which might have been trapped between the said lower surface of the said compact monolayer 23 and the said upper surface R of the said temporary substrate strip 18, which may be achieved by using methods described in version 29.

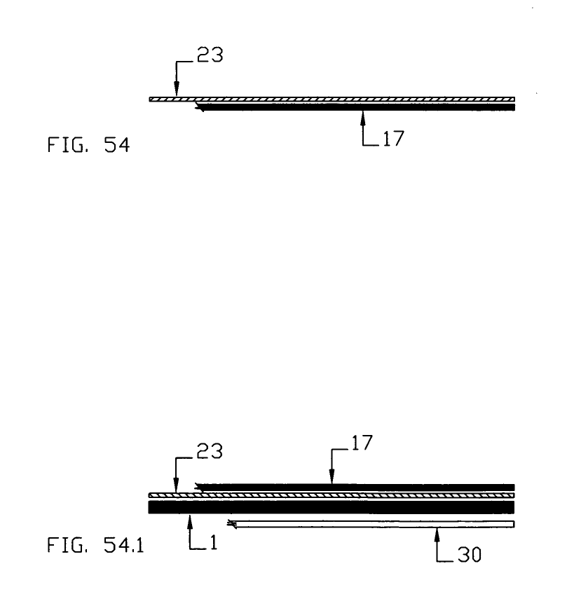

Version 41: Referring to FIG. 54 and FIG. 54.1: According to this version of the invention, an electrostatically charged compact monolayer 23 [made up of a suitable organic material (or organic compound)] spread/deposited directly on the surface of a temporary substrate 17, as described in version 37, or a temporary substrate strip as described in version 38, is “persuaded” to spread/deposit on the upper surface of a suitable substrate 1 by means of the attractive forces of electrostatic charges.

One of the properties of the said suitable substrate 1 is that it allows the “passage/penetration” of “electrostatic forces”—carried by the said compact monolayer 23 and a charged pane (see below)—to take place effectively and efficiently across its width.

The sequence of steps according to this version of the invention is as follows:

First, the said surface of the said temporary substrate 17 with the said charged compact monolayer 23 is rotated so that the latter is “brought into contact” with the “upper surface” of another suitable substrate 1 (it may be preferable to remove the suitable vehicle 19 at the beginning of this stage of the invention).

Next, a pane 30 which “carries” an electrostatic charge opposite to that “carried by” the said charged compact monolayer 23 is positioned in the proximity of the “lower surface” of the said suitable substrate 1 in a manner such that the said suitable substrate 1 is “sandwiched” between the said charged compact monolayer 23 and the said oppositely charged pane 30.

Next, the said charged compact monolayer 23 “attaches” itself to the said upper surface of the said suitable substrate 1 due to the electrostatic attraction between the said oppositely charged compact monolayer 23 and the said pane 30 (as the said suitable substrate 1 allows the “passage/penetration” of “electrostatic forces” to take place effectively and efficiently across its width).

As a result, the said compact monolayer 23 will spread/deposit on the upper surface of the said suitable substrate 1.

Version 42: Referring to FIG. 45: According to this version of the invention, a compact monolayer 23 [made up of a suitable organic material (or organic compound)] floating on top of a suitable vehicle 19 is “persuaded” to spread/deposit on the upper surface of a suitable substrate 1 by means of “magnetic attraction forces”.

The said compact monolayer 23 used in this version of the invention is made up of a suitable organic material (or organic compound) which contains ferromagnetic and/or paramagnetic materials within its chemical makeup/composition.

The said suitable substrate 1 used in this version of the invention is a magnet (a permanent magnet or a temporary magnet/electromagnet where an electric current is used).

The sequence of steps to prepare a compact monolayer 23 spread/deposited on the upper surface of a suitable substrate 1 according to this version of the invention is as follows:

First, a long sealed shallow container 8 is used that is identical to that described in version 15.

Then, a suitable substrate 1, having the above-mentioned property of being a permanent or a temporary magnet, is placed at the bottom of a shallow tray 11 (as described in version 15).

Then, a compact monolayer 23 [made up of a suitable organic material (or organic compound)], which contains ferromagnetic and/or paramagnetic materials within its chemical makeup/composition, as described above, is produced in one piece [(by one of the conventional methods), floating on top of a suitable vehicle 19] inside the said shallow tray 11.

Next, the said shallow tray 11 is placed on the floor, inside the said long sealed shallow container 8.

As this version of the invention requires that the said suitable substrate 1 acts as a magnet, thus this next step is applicable if the said suitable substrate 1 is a temporary magnet, in which case, the said suitable substrate 1 is “converted” so as to behave as a magnet e.g. the electric current which converts the said suitable substrate 1 into a magnet is “switched on”, thus the said suitable substrate 1 will behave as a magnet for as long as the said electric current is “flowing”; or alternatively, a second magnet is brought into the proximity of the said suitable substrate 1 in a manner such that the latter is positioned “within” the magnetic field of the said second magnet, therefore the said suitable substrate 1 will behave as a magnet for as long as the said suitable substrate 1 remains in the said magnetic field of the said second magnet. The said second magnet is allowed to “hold” its position relative to the said suitable substrate 1, by suitable means, through most of the processes according to this version of the invention i.e. as the said suitable substrate 1 moves, then, the said second magnet also “moves along with” the said suitable substrate 1.

Next, one side of the said suitable substrate 1 is raised slightly so that the said suitable substrate 1 is no longer completely horizontal i.e. there is now an “angle of inclination” between the “horizontal level” and the said suitable substrate 1.

Next, the entire “body” of the said suitable substrate 1 is raised “uniformly” in a very slow manner—in order to prevent causing ripples or “disturbing” the said compact monolayer 23—i.e. the magnitude of the said angle of inclination is kept constant throughout the said raising process of the said suitable substrate 1.

As the said suitable substrate 1 rises, the said upper surface of the said raised side of the said suitable substrate 1 “breaks through” the surface of the liquid inside the said shallow tray 11—i.e. the said vehicle 19 and the said compact monolayer 23—thus the said lower surface of the said compact monolayer 23 [made up of a suitable organic material (or organic compound)] comes into contact with the said upper surface of the said raised side of the said suitable substrate 1. As a result, the said lower surface of the said compact monolayer 23, which contains ferromagnetic and/or paramagnetic materials within its chemical makeup/composition, as described above, will be attracted to, and therefore, adhere to the said upper surface of the said raised side of the said suitable substrate 1, because the former will be attracted to the latter due to the presence of the said magnetic attraction forces.

As the “gentle” raising of the said suitable substrate 1 proceeds, the said upper surface of the said suitable substrate 1 will progressively become “covered” with the said compact monolayer 23 until the entire “body” of the said suitable substrate 1 is raised above the said liquid inside the said shallow tray 11—i.e. above the said vehicle 19 and the said compact monolayer 23.

The end result of the above process is that the said compact monolayer 23 will come to rest/spread/deposit directly on the said upper surface of the said suitable substrate 1.

This next step is applicable if the said suitable substrate 1 is a temporary magnet, in which case, the said suitable substrate 1 is “reverted” back to its “original state” of ceasing to behave as a temporary magnet e.g. the electric current which converted the said suitable substrate 1 into a magnet is “switched off”, thus the said suitable substrate 1 will cease to behave as a magnet; alternatively, if a second magnet was used (as described above), then the said second magnet is removed from the proximity of the said suitable substrate 1, therefore the said suitable substrate 1 will cease to behave as a magnet.

Next, if desired, the said compact monolayer 23, which contains ferromagnetic and/or paramagnetic materials within its chemical makeup/composition, as described above, may undergo suitable chemical reactions in order to “remove” the said ferromagnetic and/or paramagnetic material from the chemical makeup/composition of the said compact monolayer 23.

The next step involves the removal of the last remnants/traces of the said vehicle 19 which might have been trapped between the said lower surface of the said compact monolayer 23 and the said upper surface of the said suitable substrate 1, which may be achieved by using methods described in version 29.

Version 43: Referring to FIG. 50: According to this version of the invention, a compact monolayer 23 [made up of a suitable organic material (or organic compound)] floating on top of a suitable vehicle 19 is “persuaded” to spread/deposit on the upper surface of a “temporary substrate” 17 by means of “magnetic attraction forces”.

The said compact monolayer 23 used in this version of the invention is made up of a suitable organic material (or organic compound) which contains ferromagnetic and/or paramagnetic materials within its chemical makeup/composition.

This version of the invention is identical to version 42 except that in this version of the invention, a “temporary substrate” 17 is positioned (and “held in place”) above (and in the proximity of) the upper surface of the suitable substrate 1 used in version 42, by suitable means; therefore, the said suitable substrate 1 and the said temporary substrate 17 continue to keep their positions “unchanged” relative to one another throughout the processes involved in this version of the invention i.e. when the said suitable substrate 1 rises, then, the said temporary substrate 17 also rises at exactly the same rate of speed, thus keeping the distance separating them constant.

One of the properties of the said temporary substrate 17 is that it should be adequately thin so as to allow the “passage/penetration” of the magnetic field “possessed/produced” by the said suitable substrate 1, according to version 42, to take place effectively and efficiently across its width.

The sequence of steps according to this version of the invention is similar to those of the version 42, as follows:

First, a long sealed shallow container 8 is used that is identical to that described in version 15.

Then, a suitable substrate 1, having the above-mentioned property of being a permanent or a temporary magnet, is placed at the bottom of a shallow tray 11 (as described in version 15).

Next, a temporary substrate 17 is positioned (and “held in place”) above (and in the proximity of) the upper surface of the said suitable substrate 1.

Then, a compact monolayer 23 [made up of a suitable organic material (or organic compound)], which contains ferromagnetic and/or paramagnetic materials within its chemical makeup/composition, as described above, is produced in one piece [(by one of the conventional methods), floating on top of a suitable vehicle 19] inside the said shallow tray 11.

Next, the said shallow tray 11 is placed on the floor, inside the said long sealed shallow container 8.

As this version of the invention requires that the said suitable substrate 1 acts as a magnet, thus this next step is applicable if the said suitable substrate 1 is a temporary magnet, in which case, the said suitable substrate 1 is “converted” so as to behave as a magnet e.g. the electric current which converts the said suitable substrate 1 into a magnet is “switched on”, thus the said suitable substrate 1 will behave as a magnet for as long as the said electric current is “flowing”; or alternatively, a second magnet is brought into the proximity of the said suitable substrate 1 in a manner such that the latter is positioned “within” the magnetic field of the said second magnet, therefore the said suitable substrate 1 will behave as a magnet for as long as the said suitable substrate 1 remains in the said magnetic field of the said second magnet. The said second magnet is allowed to “hold” its position relative to the said suitable substrate 1, by suitable means, through most of the processes according to this version of the invention i.e. as the said suitable substrate 1 moves, then, the said second magnet also “moves along with” the said suitable substrate 1.

Next, one side of the said suitable substrate 1 is raised slightly so that the said suitable substrate 1 is no longer completely horizontal i.e. there is now an “angle of inclination” between the “horizontal level” and the said suitable substrate 1, keeping in mind that the said temporary substrate 17 simultaneously follows exactly every move that the said suitable substrate 1 makes.

Next, the entire “body” of the said suitable substrate 1 (and therefore the said temporary substrate 17) is raised “uniformly” in a very slow manner—in order to prevent causing ripples or “disturbing” the said compact monolayer 23—i.e. the magnitude of the said angle of inclination is kept constant throughout the said raising process of the said suitable substrate 1 (and therefore the said raising process of the said temporary substrate 17).

As the said suitable substrate 1 rises, the said upper surface of the said raised side of the said temporary substrate 17 comes into contact with the said lower surface of the said compact monolayer 23.

As the said temporary substrate 17 does not “interfere with” the magnetic attraction forces present (i.e. it allows the attractive forces to pass through freely), therefore, the said lower surface of the said compact monolayer 23, which contains ferromagnetic and/or paramagnetic materials within its chemical makeup/composition, as described above, will be attracted to the said upper surface of the said raised side of said suitable substrate 1, however, as the said temporary substrate 17 is positioned between the said compact monolayer 23 and the said suitable substrate 1, therefore, the said compact monolayer 23 will adhere to the said upper surface of the said raised side of said temporary substrate 17.

As the “gentle” raising of the said suitable substrate 1 (and the said temporary substrate 17) proceeds, the said upper surface of the said temporary substrate 17 will progressively become “covered” with the said compact monolayer 23 until the entire said upper surface of the said temporary substrate 17 is “covered” with the said compact monolayer 23.

Next, the said raising of the said suitable substrate 1 (and the said temporary substrate 17) is continued until the entire “body” of the said suitable substrate 1 (and the said temporary substrate 17) has moved completely out of the said vehicle 19 and the said suitable substrate 1 (and the said temporary substrate 17) are removed from the said shallow tray 11.

The end result of the above process is that the said compact monolayer 23 has come to rest/spread/deposit directly on the said upper surface of the said temporary substrate 17.

Next, the said temporary substrate 17, with the said compact monolayer 23 spread/deposited on its upper surface, is “detached” and “moved away” from the said suitable substrate 1.

Next, if desired, the said compact monolayer 23, which contains ferromagnetic and/or paramagnetic materials within its chemical makeup/composition, as described above, may undergo suitable chemical reactions in order to “remove” the said ferromagnetic and/or paramagnetic material from the chemical makeup/composition of the said compact monolayer 23.

The next step involves the removal of the last remnants/traces of the said vehicle 19 which might have been trapped between the said lower surface of the said compact monolayer 23 and the said upper surface of the said temporary substrate 17, which may be achieved by using methods described in version 29.

Version 44: Referring to FIG. 46: According to this version of the invention, a compact monolayer 23 [made up of a suitable organic material (or organic compound)] floating on top of a suitable vehicle 19 is “persuaded” to spread/deposit on the outward surface Q of a suitable substrate strip 13 (as described in version 16) by means of “magnetic attraction forces”.

The said compact monolayer 23 used in this version of the invention is made up of a suitable organic material (or organic compound) which contains ferromagnetic and/or paramagnetic materials within its chemical makeup/composition.

The said suitable substrate strip 13 used in this version of the invention is a magnet (a permanent magnet or a temporary magnet/electromagnet where an electric current is used).

The sequence of steps to prepare a compact monolayer 23 [made up of a suitable organic material (or organic compound)] spread/deposited on the outward surface Q of a suitable substrate strip 13 according to this version of the invention is as follows:

First, a long sealed shallow container 8 is used that is identical to that described in the version 16.

Next, a compact monolayer 23 [made up of a suitable organic material (or organic compound)], which contains ferromagnetic and/or paramagnetic materials within its chemical makeup/composition, as described above, is produced in one piece [(by one of the conventional methods), floating on top of a suitable vehicle 19] inside a shallow tray 11.

Next, the said shallow tray 11 is placed on the floor, inside the said long sealed shallow container 8 close to one end of the said long corridor as mentioned in version 16, in such a manner that the “sloped” end of the said conveyor belt system 12 as mentioned in version 16(and consequently, the said outward surface Q of the said suitable substrate strip 13) which is proximal to the said shallow tray 11 “dips” into the said shallow tray 11 and positions its tip/apex at a suitable level below the said compact monolayer 23 and inside the said vehicle 19.

As this version of the invention requires that the said suitable substrate strip 13 acts as a magnet, thus this next step is applicable if the said suitable substrate strip 13 is a temporary magnet, in which case, the said suitable substrate strip 13 is “converted” so as to behave as a magnet e.g. the electric current which converts the said suitable substrate strip 13 into a magnet is “switched on”, thus the said suitable substrate strip 13 will behave as a magnet for as long as the said electric current is “flowing”; or alternatively, a second magnet is brought into the proximity of the said suitable substrate strip 13 in a manner such that the latter is positioned “within” the magnetic field of the said second magnet, therefore the said suitable substrate strip 13 will behave as a magnet for as long as the said suitable substrate strip 13 remains in the said magnetic field of the said second magnet.

Next, the said conveyor belt system 12 (as mentioned in version 16) is switched on which causes the said suitable substrate strip 13 to “travel” in the direction as described in version 16, while simultaneously the said compact monolayer 23 is “pushed”, at a controlled rate of speed, towards the said suitable substrate strip 13 by pushing the “encircling instrument” 22—(used for pushing the outer periphery of the said compact monolayer 23 as described in version 18) in the direction towards the said suitable substrate strip 13.

As a result of the presence of the magnetic attraction forces, the said compact monolayer 23, which contains ferromagnetic and/or paramagnetic materials within its chemical makeup/composition, as described above, is attracted to, and, adhere to the said outward surface Q of the said suitable substrate strip 13. The end result of the above process is that the said compact monolayer 23 will come to rest/spread/deposit directly on the said outward surface Q of the said suitable substrate strip 13.

The speed of the said pushing of the said compact monolayer 23 towards the said suitable substrate strip 13, as described above, should be “controlled” to be at an “optimum magnitude”, because, if the said speed is too fast, then the said compact monolayer 23 will scrunch and result in a multi layered organic material (or organic compound) as the said suitable substrate strip 13 would be moving too slow relative to the said compact monolayer 23, conversely, if the said pushing is too slow, then the said compact monolayer 23 will “rupture”/break, as the said suitable substrate strip 13 would be moving too fast relative to the said compact monolayer 23.

This next step is applicable if the said suitable substrate strip 13 is a temporary magnet, in which case, the said suitable substrate strip 13 is “reverted” back to its “original state” of ceasing to behave as a temporary magnet e.g. the electric current which converted the said suitable substrate strip 13 into a magnet is “switched off”, thus the said suitable substrate strip 13 will cease to behave as a magnet; alternatively, if a second magnet was used (as described above), then the said second magnet is removed from the proximity of the said suitable substrate strip 13, therefore the said suitable substrate strip 13 will cease to behave as a magnet.

Next, if desired, the said compact monolayer 23 (which contains ferromagnetic and/or paramagnetic materials within its chemical makeup/composition, as described above) may undergo suitable chemical reactions in order to “remove” the said ferromagnetic and/or paramagnetic material from the chemical makeup/composition of the said compact monolayer 23.

The next step involves the removal of the last remnants/traces of the said vehicle 19 which might have been trapped between the said lower surface of the said compact monolayer 23 and the said outward surface Q of the said suitable substrate strip 13, which may be achieved by using methods described in version 29.

Version 45: Referring to FIG. 52: According to this version of the invention, a compact monolayer 23 [made up of a suitable organic material (or organic compound)] floating on top of a suitable vehicle 19 is “persuaded” to spread/deposit on the upper surface R of a “temporary substrate strip” 18 by means of “magnetic attraction forces”.

The said compact monolayer 23 used in this version of the invention is made up of a suitable organic material (or organic compound) which contains ferromagnetic and/or paramagnetic materials within its chemical makeup/composition.

This version of the invention is identical to version 44 except that in this version of the invention, a “temporary substrate strip” 18 is positioned (and “held in place”) in the proximity of the outward surface Q of the suitable substrate strip 13 used in version 44, by suitable means.

The said temporary substrate strip 18 and the said suitable substrate strip 13 continue to keep their positions “unchanged” relative to one another throughout the processes involved in this version of the invention i.e. when the said suitable substrate strip 13 moves (in the direction mentioned in version 31), then, the said temporary substrate strip 18 also moves in the same direction as the said suitable substrate strip 13 at exactly the same rate of speed while keeping the distance separating them constant.

One of the properties of the said temporary substrate strip 18 is that it should be adequately thin so as to allow the “passage/penetration” of the magnetic field “possessed/produced” by the said suitable substrate strip 13, according to version 44, to take place effectively and efficiently across its width.

The sequence of steps according to this version of the invention is similar to those of the version 44, as follows:

First, a long sealed shallow container 8 is used that is identical to that described in the version 16.

Next, a compact monolayer 23 [made up of a suitable organic material (or organic compound)], which contains ferromagnetic and/or paramagnetic materials within its chemical makeup/composition, as described above, is produced in one piece [(by one of the conventional methods), floating on top of a suitable vehicle 19] inside a shallow tray 11.

Next, a temporary substrate strip 18 is positioned (and “held in place”) in the proximity of the outward surface Q of a suitable substrate strip 13.

Next, the said shallow tray 11 is placed on the floor, inside the said long sealed shallow container 8 close to one end of the long corridor as mentioned in version 16, in such a manner that the “sloped” end of the conveyor belt system 12 (and consequently, the said outward surface Q of the said suitable substrate strip 13 and the said temporary substrate strip 18) which is proximal to the said shallow tray 11 “dips” into the said shallow tray 11 and positions its tip/apex at a suitable level below the said compact monolayer 23 and inside the said suitable vehicle 19.

As this version of the invention requires that the said suitable substrate strip 13 acts as a magnet, thus this next step is applicable if the said suitable substrate strip 13 is a temporary magnet, in which case, the said suitable substrate strip 13 is “converted” so as to behave as a magnet e.g. the electric current which converts the said suitable substrate strip 13 into a magnet is “switched on”, thus the said suitable substrate strip 13 will behave as a magnet for as long as the said electric current is “flowing”; or alternatively, a second magnet is brought into the proximity of the said suitable substrate strip 13 in a manner such that the latter is positioned “within” the magnetic field of the said second magnet, therefore the said suitable substrate strip 13 will behave as a magnet for as long as the said suitable substrate strip 13 remains in the said magnetic field of the said second magnet.

Next, the said conveyor belt system 12 (as mentioned in version 16) is switched on which causes the said substrate strip 13 (and therefore the said temporary substrate strip 18) to “travel” in the direction as described in version 16, while simultaneously the said compact monolayer 23 is “pushed”, at a controlled rate of speed, towards the said temporary substrate strip 18 by pushing the “encircling instrument” 22—(used for pushing the outer periphery of the said compact monolayer 23 as described in version 18) in the direction towards the said temporary substrate strip 18.

Eventually, the said lower surface of the said compact monolayer 23 comes into contact with the upper surface R of the said temporary substrate strip 18; and as the said temporary substrate strip 18 does not “interfere with” the magnetic attraction forces present (i.e. it allows the attractive forces to pass through freely), therefore, the said lower surface of the said compact monolayer 23, which contains ferromagnetic and/or paramagnetic materials within its chemical makeup/composition, will be attracted to the said outward surface Q of the said suitable substrate strip 13, however, as the said temporary substrate strip 18 is positioned between the said compact monolayer 23 and the said suitable substrate strip 13, therefore, the said compact monolayer 23 will adhere to the said upper surface R of the said temporary substrate strip 18.

The end result of the above process is that the said compact monolayer 23 will come to rest/spread/deposit directly on the said upper surface R of the said temporary substrate strip 18.

The speed of the said pushing of the said compact monolayer 23 towards the said temporary substrate strip 18, as described above, should be “controlled” to be at an “optimum magnitude”, because, if the said speed is too fast, then the said compact monolayer 23 will scrunch and result in a multi layered organic material (or organic compound) as the said temporary substrate strip 18 would be moving too slow relative to the said compact monolayer 23, conversely, if the said pushing is too slow, then the said compact monolayer 23 will “rupture”/break, as the said temporary substrate strip 18 would be moving too fast relative to the said compact monolayer 23.

Next, the said temporary substrate strip 18, with the said compact monolayer 23 spread/deposited on its upper surface R, is “detached” and “moved away” from the said suitable substrate strip 13.

Next, if desired, the said compact monolayer 23, which contains ferromagnetic and/or paramagnetic materials within its chemical makeup/composition, as described above, may undergo suitable chemical reactions in order to “remove” the said ferromagnetic and/or paramagnetic material from the chemical makeup/composition of the said compact monolayer 23.

The next step involves the removal of the last remnants/traces of the said vehicle 19 which might have been trapped between the said lower surface of the said compact monolayer 23 and the said upper surface R of the said temporary substrate strip 18, which may be achieved by using methods described in version 29.

Version 46: Referring to FIG. 55: According to this version of the invention, a compact monolayer 23 [made up of a suitable organic material (or organic compound)] floating on top of a suitable vehicle 19 is “persuaded” to spread/deposit on the upper surface of a suitable substrate 1 by means of “magnetic repulsive forces”.

The said compact monolayer 23 used in this version of the invention is made up of a suitable organic material (or organic compound) which contains diamagnetic materials within its chemical makeup/composition.

The sequence of steps to prepare a compact monolayer 23 [made up of a suitable organic material (or organic compound)] spread/deposited on the upper surface of a suitable substrate 1 according to this version of the invention is as follows:

First, a long sealed shallow container is used that is identical to that described in version 15.

Then, a suitable substrate 1 is placed at the bottom of a shallow tray 11 (as described in version 15.

Then, a compact monolayer 23 [made up of a suitable organic material (or organic compound)], which contains diamagnetic materials within its chemical makeup/composition, is produced in one piece [(by one of the conventional methods), floating on top of a suitable vehicle 19] inside the said shallow tray 11.

Next, the said shallow tray 11 is placed on the floor, inside the said long sealed shallow container 8.

Next, a “suitably strong” magnet 31 is positioned (and “held in place”) above (and in the proximity of) the upper surface of the said compact monolayer 23. The said magnet 31 may be a permanent magnet or a temporary magnet/electromagnet where an electric current is used—if the said magnet 31 used in this version of the invention is a temporary magnet, then the latter is “converted” so as to behave as a magnet i.e. the electric current which converts the said temporary magnet/electromagnet into a magnet is “switched on”, thus the said temporary magnet/electromagnet will behave as a magnet for as long as the said electric current is “flowing”.

Next, one side of the said suitable substrate 1 is raised slightly so that the said suitable substrate 1 is no longer completely horizontal i.e. there is now an “angle of inclination” between the “horizontal level” and the said suitable substrate 1.

Next, the entire “body” of the said suitable substrate 1 is raised “uniformly” in a very slow manner (in order to prevent causing ripples or “disturbing” the said compact monolayer 23) i.e. the magnitude of the said angle of inclination is kept constant throughout the said raising process of the said suitable substrate 1; while simultaneously, if the said magnet 31 used in this invention is a temporary magnet, then the latter is “converted” so as to behave as a magnet i.e. the electric current which converts the said suitable substrate 1 (temporary magnet) into a magnet is “switched on”, thus the said substrate 1 (temporary magnet) will behave as a magnet for as long as the said electric current is “flowing”.

Eventually, as the said suitable substrate 1 rises, the said upper surface of the said raised side of the said suitable substrate 1 “breaks through” the surface of the liquid inside the said shallow tray 11—i.e. the said vehicle 19 and the said compact monolayer 23—thus the lower surface of the said compact monolayer 23 comes into contact with the said upper surface of the said raised side of the said suitable substrate 1.

Due to the presence of the magnetic field produced by the said magnet 31, the said compact monolayer 23, which contains diamagnetic materials within its chemical makeup/composition, as described above, is “pushed away” from the said magnet 31, and thus, the said compact monolayer 23 is “pushed” towards the said upper surface of the said suitable substrate 1; as a result, the said compact monolayer 23 is “persuaded” to rest/spread/deposit directly on the said upper surface of the said suitable substrate 1.

As the “gentle” raising of the said suitable substrate 1 proceeds, the said upper surface of the said suitable substrate 1 will progressively become “covered” with the said compact monolayer 23 until the entire “body” of the said suitable substrate 1 is raised above the said liquid inside the said shallow tray 11—i.e. above the said vehicle 19 and the said compact monolayer 23.

The end result of the above process is that the said compact monolayer 23 will come to rest/spread/deposit directly on the said upper surface of the said suitable substrate 1.

Next, if desired, the said compact monolayer 23, which contains diamagnetic materials within its chemical makeup/composition, as described above, may undergo suitable chemical reactions in order to “remove” the said diamagnetic material from the chemical makeup/composition of the said compact monolayer 23.

The next step involves the removal of the last remnants/traces of the said vehicle 19 which might have been trapped between the said lower surface of the said compact monolayer 23 and the said upper surface of the said suitable substrate 1, which may be achieved by using methods described in version 29.

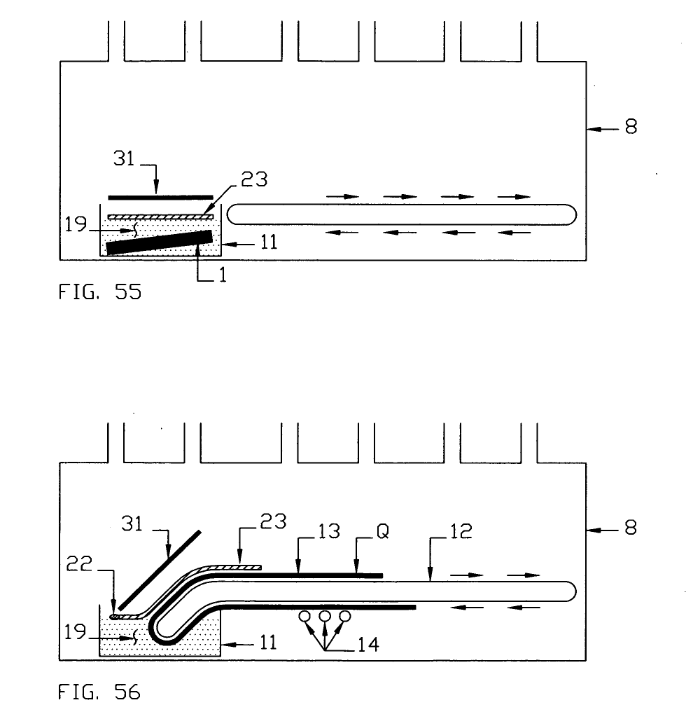

Version 47: Referring to FIG. 56: According to this version of the invention, a compact monolayer 23 [made up of a suitable organic material (or organic compound)] floating on top of a suitable vehicle 19 is “persuaded” to spread/deposit on the outward surface Q of a suitable substrate strip 13 (as described in version 16) by means of “magnetic repulsive forces”.

The said compact monolayer 23 used in this version of the invention is made up of a suitable organic material (or organic compound) which contains diamagnetic materials within its chemical makeup/composition.

The sequence of steps to prepare a compact monolayer 23 [made up of a suitable organic material (or organic compound)] spread/deposited on the outward surface Q of a suitable substrate strip 13 according to this version of the invention is as follows:

First, a long sealed shallow container is used that is identical to that described in the version 16.

Next a compact monolayer 23 [made up of a suitable organic material (or organic compound)], which contains diamagnetic materials within its chemical makeup/composition, as described above, is produced in one piece [(by one of the conventional methods), floating on top of a suitable vehicle 19] inside a shallow tray 11.

Next, the said shallow tray 11 is placed on the floor, inside the said long sealed shallow container 8 close to one end of the said long corridor as mentioned in version 16, in such a manner that the “sloped” end of the said conveyor belt system 12 (and consequently, the said outward surface Q of the said suitable substrate strip 13) which is proximal to the said shallow tray “dips” into the said shallow tray 11 and positions its tip/apex at a suitable level below the said compact monolayer 23 and inside the said vehicle 19.

Next a “suitably strong” magnet 31 is positioned (and “held in place”) above (and in the proximity of) the upper surface of the said compact monolayer 23. The said magnet 31 may be a permanent magnet or a temporary magnet/electromagnet where an electric current is used—if the said magnet 31 used in this invention is a temporary magnet, then the latter is “converted” so as to behave as a magnet i.e. the electric current which converts the said temporary magnet/electromagnet into a magnet is “switched on”, thus the said temporary magnet/electromagnet will behave as a magnet for as long as the said electric current is “flowing”.

Next, the said conveyor belt system 12 (as mentioned in version 16) is switched on which causes the said suitable substrate strip 13 to “travel” in the direction as described in version 16, while simultaneously the said compact monolayer 23 is “pushed”, at a controlled rate of speed, towards the said suitable substrate strip 13 by pushing the “encircling instrument” 22 (used for pushing the outer periphery of the said compact monolayer 23 as described in version 18) in the direction towards the said suitable substrate strip 13.

Eventually, the lower surface of the said compact monolayer 23 comes into contact with the said outward surface Q of the said suitable substrate strip 13.

Due to the presence of the magnetic field produced by the said magnet 31, the said compact monolayer 23, which contains diamagnetic materials within its chemical makeup/composition, as described above, is “pushed away” from the said magnet 31, and thus, the said compact monolayer 23 is “pushed” towards the said outward surface Q of the said suitable substrate strip 13; as a result, the said compact monolayer 23 is “persuaded” to rest/spread/deposit directly on the said outward surface Q of the said suitable substrate strip 13.

The speed of the said pushing of the said compact monolayer 23 towards the said suitable substrate strip 13, as described above, should be “controlled” to be at an “optimum magnitude”, because, if the said speed is too fast, then the said compact monolayer 23 will scrunch and result in a multi layered organic material (or organic compound) as the said suitable substrate strip 13 would be moving too slow relative to the said compact monolayer 23, conversely, if the said pushing is too slow, then the said compact monolayer 23 will “rupture”/break, as the said suitable substrate strip 13 would be moving too fast relative to the said compact monolayer 23.

Next, if desired, the said compact monolayer 23, which contains diamagnetic materials within its chemical makeup/composition, as described above, may undergo suitable chemical reactions in order to “remove” the said diamagnetic material from the chemical makeup/composition of the said compact monolayer 23.

The next step involves the removal of the last remnants/traces of the said vehicle 19 which might have been trapped between the said lower surface of the said compact monolayer 23 and the said outward surface Q of the said suitable substrate strip 13, which may be achieved by using methods described in version 29.

Version 48: Referring to FIG. 48: According to this version of the invention, a compact monolayer 23 [made up of a suitable organic material (or organic compound)] “sandwiched” between 2 suitable vehicles 19 and 19A, as described in version 34, is “persuaded” to spread/deposit on the upper surface of a suitable substrate 1 by means of “magnetic attraction forces”.

The said compact monolayer 23 used in this version of the invention is made up of a suitable organic material (or organic compound) which contains ferromagnetic and/or paramagnetic materials within its chemical makeup/composition.

The said suitable substrate 1 used in this version of the invention is a magnet (a permanent magnet or a temporary magnet/electromagnet where an electric current is used).

The sequence of steps to prepare a compact monolayer 23 [made up of a suitable organic material (or organic compound)] spread/deposited on the upper surface of a suitable substrate 1 according to this version of the invention is as follows:

First, a long sealed shallow container 8 is used that is identical to that described in version 15.

Then, a suitable substrate 1, having the above-mentioned property of being a permanent or a temporary magnet, is placed at the bottom of a shallow tray 11 (as described in version 15).

Then, a compact monolayer 23 [made up of a suitable organic material (or organic compound)], which contains ferromagnetic and/or paramagnetic materials within its chemical makeup/composition, as described above, is produced in one piece (inside the said shallow tray 11) according to a conventional method in a manner such that the said compact monolayer 23 is “sandwiched” between 2 suitable vehicles 19 and 19A.

Next, the said shallow tray 11 is placed on the floor, inside the said long sealed shallow container 8.

As this version of the invention requires that the said suitable substrate 1 acts as a magnet, thus this next step is applicable if the said suitable substrate 1 is a temporary magnet, in which case, the said suitable substrate 1 is “converted” so as to behave as a magnet e.g. the electric current which converts the said suitable substrate 1 into a magnet is “switched on”, thus the said suitable substrate 1 will behave as a magnet for as long as the said electric current is “flowing”; or alternatively, a second magnet is brought into the proximity of the said suitable substrate 1 in a manner such that the latter is positioned “within” the magnetic field of the said second magnet, therefore the said suitable substrate 1 will behave as a magnet for as long as the said suitable substrate 1 remains in the said magnetic field of the said second magnet. The said second magnet is allowed to “hold” its position relative to the said suitable substrate 1, by suitable means, through most of the processes according to this version of the invention i.e. as the said suitable substrate 1 moves, then, the said second magnet also “moves along with” the said suitable substrate 1.

Next, one side of the said suitable substrate 1 is raised slightly so that the said suitable substrate 1 is no longer completely horizontal i.e. there is now an “angle of inclination” between the “horizontal level” and the said suitable substrate 1.

Next, the entire “body” of the said suitable substrate 1 is raised “uniformly” in a very slow manner (in order to prevent causing ripples or “disturbing” the said compact monolayer 23) i.e. the magnitude of the said angle of inclination is kept constant throughout the said raising process of the said suitable substrate 1.

As the said suitable substrate 1 rises, the said upper surface of the said raised side of the said suitable substrate 1 comes into contact with the lower surface of the said compact monolayer 23. As a result, the said lower surface of the said compact monolayer 23, which contains ferromagnetic and/or paramagnetic materials within its chemical makeup/composition, as described above, will be attracted to, and therefore, adhere to the said upper surface of the said raised side of the said suitable substrate 1, because the former will be attracted to the latter due to the presence of the said magnetic attraction forces.

As the “gentle” raising of the said suitable substrate 1 proceeds, the said upper surface of the said suitable substrate 1 will progressively become “covered” with the said compact monolayer 23 until the entire “body” of the said suitable substrate 1 is raised above the said liquid inside the said shallow tray 11 (i.e. above the said vehicles 19 and 19A and the said compact monolayer 23).

The end result of the above process is that the said compact monolayer 23 will come to rest/spread/deposit directly on the said upper surface of the said suitable substrate 1.

This next step is applicable if the said suitable substrate 1 is a temporary magnet, in which case, the said suitable substrate 1 is “reverted” back to its “original state” of ceasing to behave as a temporary magnet e.g. the electric current which converted the said suitable substrate 1 into a magnet is “switched off”, thus the said suitable substrate will cease to behave as a magnet; alternatively, if a second magnet was used (as described above), then the said second magnet is removed from the proximity of the said suitable substrate 1, therefore the said suitable substrate will cease to behave as a magnet.

Next, if desired, the said compact monolayer 23, which contains ferromagnetic and/or paramagnetic materials within its chemical makeup/composition, as described above, may undergo suitable chemical reactions in order to “remove” the said ferromagnetic and/or paramagnetic material from the chemical makeup/composition of the said compact monolayer 23.

The next step involves the removal of the last remnants/traces of the said vehicles 19 and 19A which might have been trapped between the said lower surface of the said compact monolayer 23 and the said upper surface of the said suitable substrate 1, which may be achieved by using methods described in version 29.

Version 49: Referring to FIG. 51: According to this version of the invention, a compact monolayer 23 [made up of a suitable organic material (or organic compound)] “sandwiched” between 2 suitable vehicles 19 and 19A, as described in version 34, is “persuaded” to spread/deposit on the upper surface of a “temporary substrate” 17 by means of “magnetic attraction forces”.

The said compact monolayer 23 used in this version of the invention is made up of a suitable organic material (or organic compound) which contains ferromagnetic and/or paramagnetic materials within its chemical makeup/composition.

This version of the invention is identical to version 48 except that in this version of the invention, a “temporary substrate” 17 is positioned (and “held in place”) above (and in the proximity of) the upper surface of the suitable substrate 1 used in version 48, by suitable means; therefore, the said suitable substrate 1 and the said temporary substrate 17 continue to keep their positions “unchanged” relative to one another throughout the processes involved in this version of the invention i.e. when the said suitable substrate 1 rises, then, the said temporary substrate 17 also rises at exactly the same rate of speed, thus keeping the distance separating them constant.

One of the properties of the said temporary substrate 17 is that it should be adequately thin so as to allow the “passage/penetration” of the magnetic field “possessed/produced” by the said suitable substrate 1, according to version 48, to take place effectively and efficiently across its width.

The sequence of steps according to this version of the invention is similar to those of the version 48, as follows:

First, a long sealed shallow container 8 is used that is identical to that described in version 15.

Then, a suitable substrate 1, having the above-mentioned property of being a permanent or a temporary magnet, is placed at the bottom of a shallow tray 11 (as described in version 15).

Next, a temporary substrate 17 is positioned (and “held in place”) above (and in the proximity of) the upper surface of the said suitable substrate 1.

Then, a compact monolayer 23 [made up of a suitable organic material (or organic compound)], which contains ferromagnetic and/or paramagnetic materials within its chemical makeup/composition, is produced in one piece (inside the said shallow tray 11, as described in version 15) according to a conventional method in a manner such that the said compact monolayer 23 is “sandwiched” between 2 suitable vehicles 19 and 19A.

Next, the said shallow tray 11 is placed on the floor, inside the said long sealed shallow container 8.

As this version of the invention requires that the said suitable substrate 1 acts as a magnet, thus this next step is applicable if the said suitable substrate 1 is a temporary magnet, in which case, the said suitable substrate 1 is “converted” so as to behave as a magnet e.g. the electric current which converts the said suitable substrate 1 into a magnet is “switched on”, thus the said suitable substrate 1 will behave as a magnet for as long as the said electric current is “flowing”; or alternatively, a second magnet is brought into the proximity of the said suitable substrate 1 in a manner such that the latter is positioned “within” the magnetic field of the said second magnet, therefore the said suitable substrate 1 will behave as a magnet for as long as the said suitable substrate remains in the said magnetic field of the said second magnet. The said second magnet is allowed to “hold” its position relative to the said suitable substrate 1, by suitable means, through most of the processes according to this version of the invention i.e. as the said suitable substrate 1 moves, then, the said second magnet also “moves along with” the said suitable substrate 1.

Next, one side of the said suitable substrate 1 is raised slightly so that the said suitable substrate 1 is no longer completely horizontal i.e. there is now an “angle of inclination” between the “horizontal level” and the said suitable substrate 1, keeping in mind that the said temporary substrate 17 simultaneously follows exactly every move that the said suitable substrate 1 makes.

Next, the entire “body” of the said suitable substrate 1 (and therefore the said temporary substrate 17) is raised “uniformly” in a very slow manner (in order to prevent causing ripples or “disturbing” the said compact monolayer 23) i.e. the magnitude of the said angle of inclination is kept constant throughout the said raising process of the said suitable substrate 1 (and therefore the said raising process of the said temporary substrate 17).

As the said suitable substrate 1 rises, the said upper surface of the said raised side of the said temporary substrate 17 comes into contact with the lower surface of the said compact monolayer 23.

As the said temporary substrate 17 does not “interfere with” the magnetic attraction forces present (i.e. it allows the attractive forces to pass through freely), therefore, the said lower surface of the said compact monolayer 23, which contains ferromagnetic and/or paramagnetic materials within its chemical makeup/composition, as described above, will be attracted to the said upper surface of the said raised side of said suitable substrate 1 (as the latter acts as a magnet, as described above), however, as the said temporary substrate 17 is positioned between the said compact monolayer 23 and the said suitable substrate 1, therefore, the said compact monolayer 23 will adhere to the said upper surface of the said raised side of the said temporary substrate 17.

As the “gentle” raising of the said suitable substrate 1 (and the said temporary substrate 17) proceeds, the said upper surface of the said temporary substrate 17 will progressively become “covered” with the said compact monolayer 23 until the entire said upper surface of the said temporary substrate 17 is “covered” with the said compact monolayer 23.

Next, the said raising of the said suitable substrate 1 (and the said temporary substrate 17) is continued until the entire “body” of the said suitable substrate 1 (and the said temporary substrate 17) has moved completely out of the said vehicles 19 and 19A, and the said suitable substrate 1 (and the said temporary substrate 17) are removed from the said shallow tray 11.

The end result of the above process is that the said compact monolayer 23 has come to rest/spread/deposit directly on the said upper surface of the said temporary substrate 17.

Next, the said temporary substrate 17, with the said compact monolayer 23 spread/deposited on its upper surface, is “detached” and “moved away” from the said suitable substrate 1.

Next, if desired, the said compact monolayer 23, which contains ferromagnetic and/or paramagnetic materials within its chemical makeup/composition, as described above, may undergo suitable chemical reactions in order to “remove” the said ferromagnetic and/or paramagnetic material from the chemical makeup/composition of the said compact monolayer 23.

The next step involves the removal of the last remnants/traces of the said vehicles 19 and 19A which might have been trapped between the said lower surface of the said compact monolayer 23 and the said upper surface of the said temporary substrate 17, which may be achieved by using methods described in version 29.

Version 50: Referring to FIG. 49: According to this version of the invention, a compact monolayer 23 [made up of a suitable organic material (or organic compound)] “sandwiched” between 2 suitable vehicles 19 and 19A, as described in version 34, is “persuaded” to spread/deposit on the outward surface Q of a suitable substrate strip 13 (as described in version-16) by means of “magnetic attraction forces”.

The said compact monolayer 23 used in this version of the invention is made up of a suitable organic material (or organic compound) which contains ferromagnetic and/or paramagnetic materials within its chemical makeup/composition.

The said suitable substrate strip 13 used in this version of the invention is a magnet (a permanent magnet or a temporary magnet/electromagnet where an electric current is used).

The sequence of steps to prepare a compact monolayer 23 [made up of a suitable organic material (or organic compound)] spread/deposited on the outward surface Q of a suitable substrate strip 13 according to this version of the invention is as follows:

First, a long sealed shallow container 8 is used that is identical to that described in version 16.

Next, a compact monolayer 23 [made up of a suitable organic material (or organic compound)], which contains ferromagnetic and/or paramagnetic materials within its chemical makeup/composition, as described above, is produced in one piece (inside a shallow tray 11) according to a conventional method in a manner such that the said compact monolayer 23 is “sandwiched” between 2 suitable vehicles 19 and 19A.

Next, the said shallow tray 11 is placed on the floor, inside the said long sealed shallow container 8 close to one end of the said long corridor as mentioned in version 16, in such a manner that the “sloped” end of the said conveyor belt system 12 as mentioned in version 16(and consequently, the said outward surface Q of the said suitable substrate strip 13) which is proximal to the said shallow tray 11 “dips” into the said shallow tray 11 and positions its tip/apex at a suitable level below the said compact monolayer 23 and inside the said suitable vehicles 19 and 19A.

As this version of the invention requires that the said suitable substrate strip 13 acts as a magnet, thus this next step is applicable if the said suitable substrate strip 13 is a temporary magnet, in which case, the said suitable substrate strip 13 is “converted” so as to behave as a magnet e.g. the electric current which converts the said suitable substrate strip 13 into a magnet is “switched on”, thus the said suitable substrate strip 13 will behave as a magnet for as long as the said electric current is “flowing”; or alternatively, a second magnet is brought into the proximity of the said suitable substrate strip 13 in a manner such that the latter is positioned “within” the magnetic field of the said second magnet, therefore the said suitable substrate strip 13 will behave as a magnet for as long as the said suitable substrate strip remains in the said magnetic field of the said second magnet.

Next, the said conveyor belt system 12 (as mentioned in version 16) is switched on which causes the said suitable substrate strip 13 to “travel” in the direction as described in version 16, while simultaneously the said compact monolayer 23 is “pushed”, at a controlled rate of speed, towards the said suitable substrate strip 13 by pushing the “encircling instrument” 22 (used for pushing the outer periphery of the said compact monolayer 23 as described in version 18) in the direction towards the said suitable substrate strip 13.

As a result of the presence of the magnetic attraction forces, the said compact monolayer 23, which contains ferromagnetic and/or paramagnetic materials within its chemical makeup/composition, is attracted to, and, adhere to the said outward surface Q of the said suitable substrate strip 13.

The end result of the above process is that the said compact monolayer 23 will come to rest/spread/deposit directly on the said outward surface Q of the said suitable substrate strip 13.

The speed of the said pushing of the said compact monolayer 23 towards the said suitable substrate strip 13, as described above, should be “controlled” to be at an “optimum magnitude”, because, if the said speed is too fast, then the said compact monolayer 23 will scrunch and result in a multi layered organic material (or organic compound) as the said suitable substrate strip 13 would be moving too slow relative to the said compact monolayer 23, conversely, if the said pushing is too slow, then the said compact monolayer 23 will “rupture”/break, as the said suitable substrate strip 13 would be moving too fast relative to the said compact monolayer 23.

Next, if desired, the said compact monolayer 23, which contains ferromagnetic and/or paramagnetic materials within its chemical makeup/composition, as described above, may undergo suitable chemical reactions in order to “remove” the said ferromagnetic and/or paramagnetic material from the chemical makeup/composition of the said compact monolayer 23.

The next step involves the removal of the last remnants/traces of the said vehicles 19 and 19A which might have been trapped between the said lower surface of the said compact monolayer 23 and the said outward surface Q of the said suitable substrate strip 13, which may be achieved by using methods described in version 29.

Version 51: Referring to FIG. 53: According to this version of the invention, a compact monolayer 23 [made up of a suitable organic material (or organic compound)] “sandwiched” between 2 suitable vehicles 19 and 19A, is “persuaded” to spread/deposit on the outward surface R of a “temporary substrate strip” 18 by means of “magnetic attraction forces”.

The said compact monolayer 23 used in this version of the invention is made up of a suitable organic material (or organic compound) which contains ferromagnetic and/or paramagnetic materials within its chemical makeup/composition.

This version of the invention is identical to version 50 except that in this version of the invention, a “temporary substrate strip” 18 is positioned (and “held in place”) in the proximity of the outward surface Q of the suitable substrate strip 13 used in version 50, by suitable means.

The said temporary substrate strip 18 and the said suitable substrate strip 13 continue to keep their positions “unchanged” relative to one another throughout the processes involved in this version of the invention i.e. when the said suitable substrate strip 13 moves (in the direction mentioned in version 50), then, the said temporary substrate strip 18 also moves in the same direction as the said suitable substrate strip 13 at exactly the same rate of speed while keeping the distance separating them constant.

One of the properties of the said temporary substrate 18 is that it should be adequately thin so as to allow the “passage/penetration” of the magnetic field “possessed/produced” by the said suitable substrate strip 13, according to version 50, to take place effectively and efficiently across its width.

The sequence of steps according to this version of the invention is similar to those of the version 50, as follows:

First, a long sealed shallow container 8 is used that is identical to that described in the version 16.

Next, a compact monolayer 23 [made up of a suitable organic material (or organic compound)], which contains ferromagnetic and/or paramagnetic materials within its chemical makeup/composition, is produced in one piece (inside a shallow tray 11) according to a conventional method in a manner such that the said compact monolayer 23 is “sandwiched” between 2 suitable vehicles 19 and 19A.

Next, a temporary substrate strip 18 is positioned (and “held in place”) in the proximity of the outward surface Q of a suitable substrate strip 13.

Next, the said shallow tray 11 is placed on the floor, inside the said long sealed shallow container 8 close to one end of the said long corridor as mentioned in version 16, in such a manner that the “sloped” end of the said conveyor belt system 12 (and consequently, the said outward surface Q of the said substrate strip 13 and the said temporary substrate strip 18) which is proximal to the said shallow tray 11 “dips” into the said shallow tray 11 and positions its tip/apex at a suitable level below the said compact monolayer 23 and inside the said suitable vehicles 19 and 19A, as described in version 36.

As this version of the invention requires that the said suitable substrate strip 13 acts as a magnet, thus this next step is applicable if the said suitable substrate strip 13 is a temporary magnet, in which case, the said suitable substrate strip 13 is “converted” so as to behave as a magnet e.g. the electric current which converts the said suitable substrate strip 13 into a magnet is “switched on”, thus the said suitable substrate strip 13 will behave as a magnet for as long as the said electric current is “flowing”; or alternatively, a second magnet is brought into the proximity of the said suitable substrate strip 13 in a manner such that the latter is positioned “within” the magnetic field of the said second magnet, therefore the said suitable substrate strip 13 will behave as a magnet for as long as the said suitable substrate strip 13 remains in the said magnetic field of the said second magnet.

Next, the said conveyor belt system 12 (as mentioned in version 16) is switched on which causes the said substrate strip 13 (and therefore the said temporary substrate strip 18) to “travel” in the direction as described in version 16, while simultaneously the said compact monolayer 23 is “pushed”, at a controlled rate of speed, towards the said temporary substrate strip 18 by pushing the “encircling instrument” 22 (used for pushing the outer periphery of the said compact monolayer 23 as described in version 18) in the direction towards the said temporary substrate strip 18.

Eventually, the lower surface of the said compact monolayer 23 comes into contact with the upper surface R of the said temporary substrate strip 18; and as the said temporary substrate strip 18 does not “interfere with” the magnetic attraction forces present (i.e. it allows the attractive forces to pass through freely), therefore, the said lower surface of the said compact monolayer 23, which contains ferromagnetic and/or paramagnetic materials within its chemical makeup/composition, will be attracted to the said outward surface Q of the said suitable substrate strip 13, however, as the said temporary substrate strip 18 is positioned between the said compact monolayer 23 and the said suitable substrate strip 13, therefore, the said compact monolayer 23 will adhere to the said upper surface R of the said temporary substrate strip 18.

The end result of the above process is that the said compact monolayer 23 will come to rest/spread/deposit directly on the said upper surface R of the said temporary substrate strip 18.

The speed of the said pushing of the said compact monolayer 23 towards the said temporary substrate strip 18, as described above, should be “controlled” to be at an “optimum magnitude”, because, if the said speed is too fast, then the said compact monolayer 23 will scrunch and result in a multi layered organic material (or organic compound) as the said temporary substrate strip 18 would be moving too slow relative to the said compact monolayer 23, conversely, if the said pushing is too slow, then the said compact monolayer 23 will “rupture”/break, as the said temporary substrate strip 18 would be moving too fast relative to the said compact monolayer 23.

Next, the said temporary substrate strip 18, with the said compact monolayer 23 spread/deposited on its upper surface R, is “detached” and “moved away” from the said suitable substrate strip 13.

Next, if desired, the said compact monolayer 23, which contains ferromagnetic and/or paramagnetic materials within its chemical makeup/composition, as described above, may undergo suitable chemical reactions in order to “remove” the said ferromagnetic and/or paramagnetic material from the chemical makeup/composition of the said compact monolayer 23.

The next step involves the removal of the last remnants/traces of the said vehicles 19 and 19A which might have been trapped between the said lower surface of the said compact monolayer 23 and the said upper surface R of the said temporary substrate strip 18, which may be achieved by using methods described in version 29.

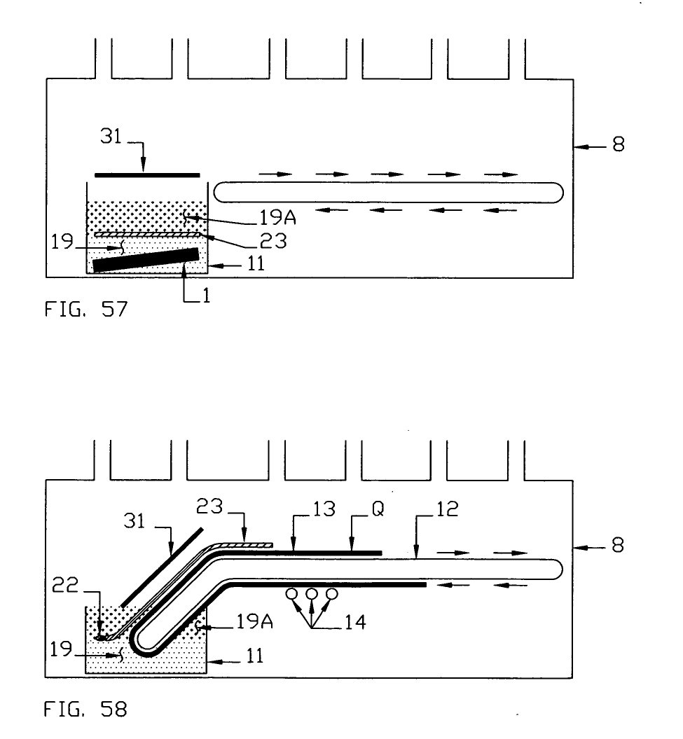

Version 52: Referring to FIG. 57: According to this version of the invention, a compact monolayer 23 [made up of a suitable organic material (or organic compound)] “sandwiched” between 2 suitable vehicles 19 and 19A, is “persuaded” to spread/deposit on the upper surface of a suitable substrate 1 by means of “magnetic repulsive forces”.

The said compact monolayer 23 used in this version of the invention is made up of a suitable organic material (or organic compound) which contains diamagnetic materials within its chemical makeup/composition.

The sequence of steps to prepare a compact monolayer 23 [made up of a suitable organic material (or organic compound)] spread/deposited on the upper surface of a suitable substrate 1 according to this version of the invention is as follows:

First, a long sealed shallow container 8 is used that is identical to that described in version 15.

Then, a suitable substrate 1 is placed at the bottom of a shallow tray 11 (as described in version 15).

Then, a compact monolayer 23 [made up of a suitable organic material (or organic compound)], which contains diamagnetic materials within its chemical makeup/composition, as described above, is produced in one piece (inside the said shallow tray 11) according to a conventional method in a manner such that the said compact monolayer 23 is “sandwiched” between 2 suitable vehicles 19 and 19A.

Next, the said shallow tray 11 is placed on the floor, inside the said long sealed shallow container 8.

Next, a “suitably strong” magnet 31 is positioned (and “held in place”) above (and in the proximity of) the upper surface of the said compact monolayer 23. The said magnet 31 may be a permanent magnet or a temporary magnet/electromagnet where an electric current is used—if the said magnet 31 used in this version of the invention is a temporary magnet, then the latter is “converted” so as to behave as a magnet i.e. the electric current which converts the said temporary magnet/electromagnet into a magnet is “switched on”, thus the said temporary magnet/electromagnet will behave as a magnet for as long as the said electric current is “flowing”.

Next, one side of the said suitable substrate 1 is raised slightly so that the said suitable substrate 1 is no longer completely horizontal i.e. there is now an “angle of inclination” between the “horizontal level” and the said suitable substrate 1.

Next, the entire “body” of the said suitable substrate 1 is raised “uniformly” in a very slow manner (in order to prevent causing ripples or “disturbing” the said compact monolayer 23) i.e. the magnitude of the said angle of inclination is kept constant throughout the said raising process of the said suitable substrate 1; while simultaneously, if the said magnet 31 used in this invention is a temporary magnet, then the latter is “converted” so as to behave as a magnet e.g. the electric current which converts the said temporary magnet into a magnet is “switched on”, thus the said temporary magnet will behave as a magnet for as long as the said electric current is “flowing”.

As the said suitable substrate 1 rises, the said upper surface of the said raised side of the said suitable substrate 1 comes into contact with the lower surface of the said compact monolayer 23.

Due to the presence of the magnetic field produced by the said magnet 31, the said compact monolayer 23, which contains diamagnetic materials within its chemical makeup/composition, as described above, is “pushed away” from the said magnet 31, and thus, the said compact monolayer 23 is “pushed” towards the said upper surface of the said suitable substrate 1; as a result, the said compact monolayer 23 is “persuaded” to rest/spread/deposit directly on the said upper surface of the said suitable substrate strip 1.

As the “gentle” raising of the said suitable substrate 1 proceeds, the said upper surface of the said suitable substrate 1 will progressively become “covered” with the said compact monolayer 23 until the entire “body” of the said suitable substrate 1 is raised above the said liquid inside the said shallow tray 11 (i.e. above the said vehicles 19 and 19A and the said compact monolayer 23).

The end result of the above process is that the said compact monolayer 23 will come to rest/spread/deposit directly on the said upper surface of the said suitable substrate 1.

Next, if desired, the said compact monolayer 23, which contains diamagnetic materials within its chemical makeup/composition, as described above, may undergo suitable chemical reactions in order to “remove” the said diamagnetic material from the chemical makeup/composition of the said compact monolayer 23.

The next step involves the removal of the last remnants/traces of the said vehicles 19 and 19A which might have been trapped between the said lower surface of the said compact monolayer 23 and the said upper surface of the said suitable substrate 1, which may be achieved by using methods described in version 29.

Version 53: Referring to FIG. 58: According to this version of the invention, a compact monolayer 23 [made up of a suitable organic material (or organic compound)] “sandwiched” between 2 suitable vehicles 19 and 19A, is “persuaded” to spread/deposit on the outward surface Q of a suitable substrate strip 13 (as described in version 16) by means of “magnetic repulsive forces”.

The said compact monolayer 23 used in this version of the invention is made up of a suitable organic material (or organic compound) which contains diamagnetic materials within its chemical makeup/composition.

The sequence of steps to prepare a compact monolayer 23 [made up of a suitable organic material (or organic compound)] spread/deposited on the outward surface Q of a suitable substrate strip 13 according to this version of the invention is as follows:

First, a long sealed shallow container 8 is used that is identical to that described in the version 16.

Next, a compact monolayer 23 [made up of a suitable organic material (or organic compound)], which contains diamagnetic materials within its chemical makeup/composition, as described above, is produced in one piece (inside a shallow tray 11) according to a conventional method in a manner such that the said compact monolayer 23 is “sandwiched” between 2 suitable vehicles 19 and 19A.

Next, the said shallow tray 11 is placed on the floor, inside the said long sealed shallow container 8 close to one end of the said long corridor as mentioned in version 16, in such a manner that the “sloped” end of the said conveyor belt system 12 as mentioned in version 16(and consequently, the said outward surface Q of the said suitable substrate strip 13) which is proximal to the said shallow tray 11 “dips” into the said shallow tray and positions its tip/apex at a suitable level below the said compact monolayer 23 and inside the said vehicles 19 and 19A.

Next, a “suitably strong” magnet 31 is positioned (and “held in place”) above (and in the proximity of) the upper surface of the said compact monolayer 23. The said magnet 31 may be a permanent magnet or a temporary magnet/electromagnet where an electric current is used—if the said magnet used in this version of the invention is a temporary magnet, then the latter is “converted” so as to behave as a magnet i.e. the electric current which converts the said temporary magnet/electromagnet into a magnet is “switched on”, thus the said temporary magnet/electromagnet will behave as a magnet for as long as the said electric current is “flowing”.

Next, the said conveyor belt system 12 (as mentioned in version 16) is switched on which causes the said suitable substrate strip 13 to “travel” in the direction as described in version 16, while simultaneously the said compact monolayer 23 is “pushed”, at a controlled rate of speed, towards the said suitable substrate strip 13 by pushing the “encircling instrument” 22 (used for pushing the outer periphery of the said compact monolayer 23 as described in version 18) in the direction towards the said suitable substrate strip 13.

Eventually, the lower surface of the said compact monolayer 23 comes into contact with the said outward surface Q of the said suitable substrate strip 13.

Due to the presence of the magnetic field produced by the said magnet 31, the said compact monolayer 23, which contains diamagnetic materials within its chemical makeup/composition, as described above, is “pushed away” from the said magnet 31, and thus, the said compact monolayer 23 is “pushed” towards the said outward surface Q of the said suitable substrate strip 13; as a result, the said compact monolayer 23 is “persuaded” to rest/spread/deposit directly on the said outward surface Q of the said suitable substrate strip 13.

The speed of the said pushing of the said compact monolayer 23 towards the said suitable substrate strip 13, as described above, should be “controlled” to be at an “optimum magnitude”, because, if the said speed is too fast, then the said compact monolayer 23 will scrunch and result in a multi layered organic material (or organic compound) as the said suitable substrate strip 13 would be moving too slow relative to the said compact monolayer 23, conversely, if the said pushing is too slow, then the said compact monolayer 23 will “rupture”/break, as the said suitable substrate strip 13 would be moving too fast relative to the said compact monolayer 23.

Next, if desired, the said compact monolayer 23, which contains diamagnetic materials within its chemical makeup/composition, as described above, may undergo suitable chemical reactions in order to “remove” the said diamagnetic material from the chemical makeup/composition of the said compact monolayer 23.

The next step involves the removal of the last remnants/traces of the said vehicles 19 and 19A which might have been trapped between the said lower surface of the said compact monolayer 23 and the said outward surface Q of the said suitable substrate 13, which may be achieved by using methods described in version 29.

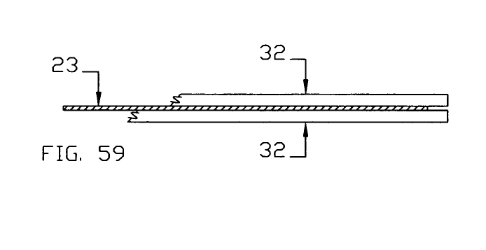

Version 54: Referring to FIG. 59: According to this version of the invention, a compact monolayer 23 [made up of a suitable organic material (or organic compound)] “sandwiched” between two “suitable surfaces” 32 is carbonized by placing the said “sandwiched compact monolayer 23” in a “hot environment”.

The said suitable surfaces 32 mentioned above may be two suitable substrates (as described in versions 1, 2, 3, 4, 5, and 6), or two suitable plates (as described in versions 7, 8, 9, 10, 11, and 12), or one suitable substrate (as described in versions 1, 2, 3, 4, 5, and 6) and one suitable plate (as described in versions 7, 8, 9, 10, 11, and 12).

The said hot environment mentioned above may be a kiln/oven/furnace.

Version 55: This version of the invention is comprised of a very thin substrate (made up of a suitable material which is capable of being dissolved in a suitable reagent) the upper surface of which may be smooth or it may possess “raised” patterns or “carved/etched” patterns, similar to substrates C and D as described in versions 3 and 4 respectively—the said very thin substrate mentioned above could replace the said substrates C and D when desired.

Version 56: This version of the invention is comprised of a very thin plate (made up of a suitable material which is capable of being dissolved in a suitable reagent) the upper surface of which may be smooth or it may possess “raised” patterns or “carved/etched” patterns, similar to plates I and J as described in versions 9 and 10 respectively—the said very thin plate mentioned above could replace the said plates I and J when desired.

The said very thin plate is capable of being heated to suitably high temperatures.

1: According to this claim, the upper surface of a substrate (made up of a suitable material) is coated, by a suitable method, with a layer of a suitable material/substance where the latter may be a suitable non-stick material (e.g. Teflon) or a suitable “dissolvable” substance.
The non-stick surface of a “non-stick coated” substrate, as described above, enables an easy removal of any material(s) that is/are spread/deposited on the said non-stick surface.
Where a substrate coated with a suitable dissolvable substance is used, any material(s) that is/are spread/deposited/adhered on the surface of the said substrate could be “removed”/detached from the said “dissolvable coating/surface” by dissolving the said “dissolvable coating/surface” using (a) suitable chemical reagent(s). It may be desirable to initially “peel off”/“cut out”/separate the said dissolvable coating/surface [with the said spread/deposited material(s) still adhered to the said dissolvable coating/surface] from the said substrate before the said chemical treatment.

2: This claim is comprised of a substrate (made up of a suitable material) of appropriate thickness which possesses a hollow tube within its body, just below its upper surface, where the said tube runs “back and forth” across the “width/sides” of the said substrate.
The function of the said tube is to allow the flow of a suitable fluid of desired temperature (hot or cold) through it so as to raise or reduce the temperature of the said upper surface of the said substrate, thereby facilitating or hindering the removal of any material(s) that is/are spread/deposited over the said upper surface of the said substrate.

3: This claim is comprised of a substrate (made up of a suitable material), the upper surface of which possesses suitably “raised” patterns, where the latter may assume the patterns of minute electrical circuits or that of any other “desirable” patterns.
The function of the said raised patterns on the said surface of the said substrate is (as described in claim 23B) to allow the “instantaneous” carbonization of any organic material (or organic compound) such as a compact monolayer which is resting/deposited on the said surface of the said substrate to take place, upon coming into contact with a suitably hot plate (as described in claims 7, 8, 9, 10 and 11), only in the said raised areas, thus producing a “patterned graphene”.

4: This claim is comprised of a substrate (made up of a suitable material), the upper surface of which possesses suitably “carved/etched” patterns, where the latter may assume the patterns of minute electrical circuits or that of any other “desirable” patterns.
The function of the said carved/etched patterns on the said surface of the said substrate is (as described in claim 23B) to allow the “instantaneous” carbonization of any organic material (or organic compound), such as a compact monolayer, which is resting/deposited on the said surface of the said substrate to take place, upon coming into contact with a suitably hot plate (as described in claims 7, 8, 9, 10 and 11), in all the areas of the said organic material (or organic compound) except in the said carved/etched areas, thus “converting” the said organic material (or organic compound) into a graphene layer possessing within it “uncarbonized patterns” where the latter correspond to the said carved/etched patterns.

5: This claim is comprised of substrates which are identical to the substrates as described in claims 3 and 4 above, except that in this version of the claim, the said substrates possess hollow tubes within their bodies just below their surfaces, where the said tubes run “back and forth” across “width/sides” of the said substrates.
The function of the said tubes are to allow the flow of a suitable fluid of desired temperature (hot or cold) through them so as to raise or reduce the temperature of the said surfaces of the said substrates, thereby facilitating or hindering the removal of any material(s) that is/are “residing” on the said surfaces.

6: This claim is comprised of substrates which are identical to the substrates as described in claims 2, 3, 4 and 5 above, except that in this version of the claim, the said surfaces of the said substrates are coated, by a suitable method, with a layer of a suitable material/substance where the latter may be a suitable non-stick material (e.g. Teflon) or a suitable “dissolvable” substance.
The non-stick surface of a “non-stick coated” substrate, as described above, enables an easy removal of any material(s) that is/are spread/deposited on the said non-stick surface.
Where a substrate coated with a suitable dissolvable substance is used, any material(s) that is/are spread/deposited/adhered on the surface of the said substrate could be “removed”/detached from the said “dissolvable coating/surface” by dissolving the said “dissolvable coating/surface” using (a) suitable chemical reagent(s). It may be desirable to initially “peel off”/“cut out”/separate the said dissolvable coating/surface [with the said spread/deposited material(s) still adhered to the said dissolvable coating/surface] from the said substrate before the said chemical treatment.

7: This claim is comprised of a plate (made up of a suitable material which enables it to be heated to suitably high temperatures) with a smooth surface.
The function of the said plate is (after being initially heated to a suitable temperature by a suitable method) to “instantaneously” carbonize any organic material (or organic compound), such as a compact monolayer, which is resting/deposited on the surface of a substrate upon coming in contact with the latter (as described in claim 23B), thus “converting” the said organic material (or organic compound) into a graphene layer.

8: This claim is comprised of a plate (made up of a suitable material) of appropriate thickness which possesses a hollow tube within its body, just below its surface, where the said tube runs “back and forth” across the “width/sides” of the said plate.
The function of the said tube is to allow the flow of a suitable fluid of desired temperature (hot or cold) through it so as to raise or reduce the temperature of the said surface of the said plate, thereby facilitating or hindering the removal of any carbonized material(s) that is/are “residing” on the said surface.

9: This claim is comprised of a plate (made up of a suitable material which enables it to be heated to suitably high temperatures) possessing raised “patterns” on its surface, where the latter may assume the “patterns” of minute electrical circuits or that of any other “desirable” patterns.
The function of the said “patterned” plate is (after being initially heated to a suitable temperature by a suitable method) to “instantaneously” carbonize any organic material (or organic compound), such as a compact monolayer, which is resting/deposited on the surface of a substrate (as described in claim 23B) only in those raised “patterns” areas upon coming in contact with the said compact monolayer, thus “converting” the said organic material (or organic compound) into a “patterned” graphene layer.

10: This claim is comprised of a plate (made up of a suitable material which enables it to be heated to suitably high temperatures) possessing “carved/etched” patterns on its surface, where the said carved/etched patterns may assume the patterns of minute electrical circuits or that of any other “desirable” patterns.
The function of the said “patterned” plate is (after being initially heated to a suitable temperature by a suitable method) to “instantaneously” carbonize any organic material (or organic compound), such as a compact monolayer, which is resting/deposited on the surface of a substrate (as described in claim 23B) in all the areas of the said organic material (or organic compound) except in the said carved/etched areas, thus “converting” the said organic material (or organic compound) into a graphene layer possessing within it “uncarbonized patterns” where the latter correspond to the said carved/etched patterns.

11: This claim is comprised of plates which are identical to the plates as described in claims 9 and 10, except that in this version of the claim, the said plates possess hollow tubes within their bodies, just below their surfaces, where the said tubes run “back and forth” across “width/sides” of the said plates.
The function of the said tubes are to allow the flow of a suitable fluid of desired temperature (hot or cold) through them so as to raise or reduce the temperature of the said surfaces of the said plates, thereby facilitating or hindering the removal of any material(s) that is/are “residing” on the said surfaces.

12: This claim is comprised of plates which are identical to the plates as described in claims 7, 8, 9, 10 and 11, except that in this version of the claim, the said surfaces of the said plates are coated, by a suitable method, with a layer of a suitable material/substance where the latter may be a suitable non-stick material (e.g. Teflon) or a suitable “dissolvable” substance.
The non-stick surface of a “non-stick coated” plate, as described above, enables an easy removal of any material(s) that is/are “attached”/adhered to the said non-stick surface.
Where a plate coated with a suitable dissolvable substance is used, any material(s) that is/are spread/deposited/adhered on the said surface of the said plate could be “removed”/detached from the said “dissolvable coating/surface” by dissolving the said “dissolvable coating/surface” using (a) suitable chemical reagent(s). It may be desirable to initially “peel off”/“cut out”/separate the said dissolvable coating/surface [with the said spread/deposited material(s) still adhered to the said dissolvable coating/surface] from the said plate before the said chemical treatment.

13: A sealed shallow container, consisting of a shallow container and a lid which possesses 2 or more tubes, where the said lid can be secured to the top of the said shallow container so as to seal the latter.
The said sealed shallow container is used for preparing a compact monolayer, where the former is large enough to allow a suitable substrate to be placed on its “floor” horizontally.
The purpose of the said tubes in the said lid is to connect the inside of the said sealed shallow container to the outside, thus allow the introduction and the removal of gaseous materials into and out of the said sealed shallow container.

14: A long sealed shallow container with a conveyor belt system placed on its floor along its length, where the said long sealed shallow container consists of a long shallow container and a lid (that possesses a number of tubes) which can be secured to the top of the said long shallow container so as to seal the latter.
The said long sealed shallow container resembles the sealed shallow container as described in claim 13, above, except that in this version of the claim, the length of the said long sealed shallow container is many times greater than its width, thus the long portion of the said long sealed shallow container resembles a “long corridor”.
The purpose of the said conveyor belt system is to transport any object that is placed over it, from one end of the said long corridor to its other end.

15: A long sealed shallow container which is identical to the long sealed shallow container as described in claim 14, except that the length of the conveyor belt system which is used in this version of the claim is shorter than that of the said conveyor belt system in claim 14 by the magnitude of one of the sides of a shallow tray (in which a compact monolayer is prepared) in such a manner that when the said shallow tray is placed on the floor of the said long sealed shallow container, close to one of its ends, one end of the said conveyor belt system is positioned at the proximity of the side of the said shallow tray which is facing the said long corridor as describe in claim 14, while the other end of the said conveyor belt system is positioned at the proximity of the other end of the said long corridor.

16: A long sealed shallow container which is identical to the long sealed shallow container as described in claim 15, except that in this claim, a suitable substrate (as described in claims 1, 2, 3, 4, 5 and 6) in the shape of a long strip which is made up of a suitable material is positioned in the proximity of the surface of the said conveyor belt, while being held in place by means of a number of rollers, whereas a small portion of the end part of the said conveyor belt system (and the said substrate strip) that is proximal to the said shallow tray is “bent downwards”.
Upon switching on the said conveyor belt system, the portion of the said substrate strip that lies below the central axis of the former will continuously “travel” in the direction towards the end part (apex) of the said conveyor belt system, while the portion of the said substrate strip that lies above the said central axis travels in the direction away from the said end part (apex) of the said conveyor belt system.

17: This claim is comprised of a “temporary substrate” positioned (and “held in place”) above (and in the proximity of) the upper surface of a suitable substrate as described in claims 1, 2, 3, 4, 5 and 6, by suitable means; therefore, the said suitable substrate and the said temporary substrate continue to keep their positions “unchanged” relative to one another at all times i.e. when the said suitable substrate rises, then, the said temporary substrate also rises at exactly the same rate of speed, thus keeping the distance separating them constant.
One of the properties of the said temporary substrate is that it should be adequately thin so as to allow the “passage/penetration” of “electrostatic forces” or allow the “passage/penetration” of (a) magnetic field(s) [“possessed/produced” by (a) suitable magnet(s)] to take place effectively and efficiently across its width.
Another property of the said temporary substrate is that it does not adversely interfere with the electrostatic charges that might be carried by any other components that are involved in various processes (in the various claims) i.e. the said temporary substrate does not cause the electrostatic charges carried by any other components involved in various processes to be “neutralized”.

18: This claim is comprised of a “temporary substrate strip” positioned (and “held in place”) in the proximity of the outward surface of a suitable substrate strip as described in claim 16, by suitable means; therefore, the said temporary substrate strip and the said suitable substrate strip continue to keep their positions “unchanged” relative to one another throughout the processes involved in this version of the invention i.e. when the said suitable substrate strip moves (in the direction mentioned in claim 16), then, the said temporary substrate strip also moves in the same direction as the said suitable substrate strip at exactly the same rate of speed while keeping the distance separating them constant.
One of the properties of the said temporary substrate strip is that it should be adequately thin so as to allow the “passage/penetration” of “electrostatic forces” or allow the “passage/penetration” of (a) magnetic field(s) [“possessed/produced” by (a) suitable magnet(s)] to take place effectively and efficiently across its width.
Another property of the said temporary substrate strip is that it does not adversely interfere with the electrostatic charges that might be carried by any other components that are involved in various processes (in the various claims) i.e. the said temporary substrate strip does not cause the electrostatic charges carried by any other components involved in various processes to be “neutralized”.

19: Promoting a continuous evaporation, at a desirable rate, of a vehicle which is positioned beneath a compact monolayer [made up of a suitable organic material (or organic compound)] according to the method described in claim 19A bellow [where the said compact monolayer which is floating on top of the said vehicle is first produced by one of the conventional methods and then “compressed” (inside a sealed shallow container)], followed by the removal of the said continuously evaporated vehicle from inside the said sealed shallow container, by one of the methods described in claims 19B, 19C, 19C1, 19C2, 19C3, or 19C4 below, thus causing/allowing the said compact monolayer to be spread/deposited directly on a suitable substrate (as described in claims 1, 2, 3, 4, 5 and 6) which is “resting” at the bottom of the said enclosed shallow container.

19A: Promoting a continuous evaporation, at a desirable rate, of the said vehicle as described in claim 19 above (to take place only from the part of the surface of the said vehicle that is not covered by the said compact monolayer), while at the same time preventing the said compact monolayer from undergoing a net quantitative or a net qualitative change, as well as preventing the said compact monolayer and the said vehicle from coming to a boil, all achieved by ensuring the following conditions/criteria are met:
e) The temperature of the system (i.e. contents inside the said sealed shallow container) is kept at a value/magnitude that is lower than that of the boiling point of an immiscible mixture which is made up of the said vehicle and the said organic material (or organic compound) present in the said compact monolayer, under the ambient atmospheric pressure inside the said sealed shallow container.
f) The ambient atmospheric pressure inside the said sealed shallow container is kept at a value/magnitude which prevents the said compact monolayer or the said vehicle from coming to a boil at the temperature of the system (i.e. contents inside the said sealed shallow container).
g) The vapor pressure of the said organic material (or organic compound) inside the said sealed shallow container is constantly kept at a value that ensures the net amount of the said organic material (or organic compound) present in the said compact monolayer remains unchanged [i.e. the amount of the said organic material (or organic compound) which is evaporated and removed from the said compact monolayer into the “gaseous layer” above the said compact monolayer equals the amount of the said organic material (or organic compound) which is liquefied from the said gaseous layer and added/deposited onto the said compact monolayer].
h) The vapor pressure of the said vehicle inside the said sealed shallow container is constantly kept at a low enough magnitude in such a manner as to ensure a steady evaporation of the said vehicle, achieved by a constant and steady removal of the said gaseous form of the said vehicle from the said gaseous phase above the said compact monolayer inside the said sealed shallow container, through one of the methods as described in claims 19B, 19C, 19C1, 19C2, 19C3, and 19C4 below.

19B: Removal of the gaseous form of a vehicle (i.e. the portion of the vehicle which is evaporated, as described in claim 19A, above) from the gaseous layer above a compact monolayer inside a sealed shallow container (as described in claim 19A) [achieved by a steady removal, at a desired rate, of the entire said gaseous layer above the said compact monolayer, through a tube (in the lid of the said sealed shallow container), to the outside of the said sealed shallow container] while simultaneously replacing it [through another tube (in the lid of the said sealed shallow container) from outside of the said sealed shallow container] with a “fresh” mixture of gases [that contains the said vehicle and the said organic material (or organic compound) present in the said compact monolayer, both in gaseous form, plus other inert gases or “pure air”] while ensuring the following conditions/criteria are met:
3. The said fresh mixture of the said gases should contain zero or very small amounts of the said vehicle in a gaseous phase so that the vapor pressure of the said vehicle in the said fresh mixture of the said gases is either zero or at such a low value/magnitude that promotes the evaporation of the said vehicle (at the temperature inside the said sealed shallow container) while the said fresh mixture of the gases contains just enough of the said organic material (or organic compound) present in the said compact monolayer in gaseous form to impart a vapor pressure that is optimal in order to ensure that the net amount of the said organic material (or organic compound) present in the said compact monolayer remains unchanged [i.e. the amount of the said organic material (or organic compound) which is evaporated and removed from the said compact monolayer into the said gaseous layer equals the amount of the said organic material (or organic compound) which is liquefied from the said gaseous layer and added to the said compact monolayer], and
4. The temperature and the ambient atmospheric pressure of the “system” (i.e. the contents inside the said sealed shallow container) are constantly kept at a suitable level so as to prevent the said vehicle or the said compact monolayer from coming to a boil, as described below:
c) The ambient atmospheric pressure of the said system is kept at a value/magnitude which prevents the said compact monolayer and the said vehicle from coming to a boil at the temperature of the said system, and
d) The temperature of the said system is kept at a value/magnitude that is lower than the boiling point of an immiscible mixture which is made up of the said vehicle and the said organic material (or organic compound) present in the said compact monolayer under the said ambient atmospheric pressure of the said system.

19C: Removal of the gaseous form of a vehicle (i.e. the portion of the vehicle which is evaporated, as described in claim 19A, above) from the gaseous layer above a compact monolayer inside a sealed shallow container (as described in claim 19A) by “trapping” the said gaseous form of the said vehicle “within” the contents of a container of an appropriate size (which is placed inside the said sealed shallow container, at a level above the said compact monolayer), according to one of the following methods:

19C1: According to this claim, the said container of an appropriate size as described in claim 19C, contains a suitable material, in a liquid or a solid form, which chemically reacts with the said gaseous form of the said vehicle (above the said compact monolayer) as described in claim 19C to form a different substance, while the said suitable material contained in the said container of an appropriate size is “inert” towards the said gaseous form of the said organic material (or organic compound) which is present in the said gaseous layer above the said compact monolayer inside the said sealed shallow container [i.e. the said gaseous form of the said organic material (or organic compound) does not chemically react with the said suitable material contained in the said container of an appropriate size, neither does it dissolve in, nor suspend in the said suitable material, when the latter is in a liquid form].

19C2: According to this claim, the said container of an appropriate size as described in claim 19C, contains a suitable liquid which allows the said gaseous form of the said vehicle (above the said compact monolayer) as described in claim 19C to be dissolved in or suspended into the said suitable liquid, while the said suitable liquid material contained in the said container of an appropriate size is “inert” towards the said gaseous form of the said organic material (or organic compound) which is present in the said gaseous layer above the said compact monolayer inside the said sealed shallow container [i.e. the said gaseous form of the said organic material (or organic compound) does not chemically react with, nor dissolve in, nor suspend into the said suitable liquid material contained in the said container of an appropriate size].

19C3: According to this claim, the said container of an appropriate size as described in claim 19C, contains a suitable porous material that possesses numerous small pores which allows the said gaseous form of the said vehicle (above the said compact monolayer) as described in claim 19C to be adsorbed onto the surfaces of the said numerous small pores of the said porous material, while the said suitable porous material contained in the said container of an appropriate size is “inert” towards the said gaseous form of the said organic material (or organic compound) which is present in the said gaseous layer above the said compact monolayer inside the said sealed shallow container [i.e. the said gaseous form of the said organic material (or organic compound) does not chemically react with, nor adsorb onto the said surfaces of the said numerous small pores of the said suitable porous material contained in the said container of an appropriate size].

19C4: According to this claim, the said container of an appropriate size as described in claim 19C, contains suitable small particles which allow the said gaseous form of the said vehicle (above the said compact monolayer) as described in claim 19C to be adsorbed onto the surfaces of the said small particles, while the said suitable small particles contained in the said container of an appropriate size are “inert” towards the said gaseous form of the said organic material (or organic compound) which is present in the said gaseous layer above the said compact monolayer inside the said sealed shallow container [i.e. the said gaseous form of the said organic material (or organic compound) does not chemically react with, nor adsorb onto the said surfaces of the said suitable small particles contained in the said container of an appropriate size].

20: This claim is comprised of a method of “separating” or removing a compact monolayer [made up of a suitable organic material (or organic compound)] from the top surface of a vehicle [where the said compact monolayer which is floating on top of the said vehicle is first produced by one of the conventional methods and then “compressed” (inside a sealed shallow container)], by means of “adding/introducing” a suitable transparent or opaque substance over the top surface of the said compact monolayer in order to aid the said separation.
The said suitable transparent or opaque substance should possess the following properties:
a) The said suitable transparent or opaque substance should not react chemically with the said organic material (or organic compound) which makes up the said compact monolayer;
b) The said suitable transparent or opaque substance should not dissolve, nor should it suspend in the said organic material (or organic compound) which makes up the said compact monolayer;
c) The said suitable transparent or opaque substance should not allow the said organic material (or organic compound) which makes up the said compact monolayer to be dissolved or suspended in the said suitable transparent or opaque substance;
d) The said suitable transparent or opaque substance should be capable of adhering itself to the top surface of the said compact monolayer; and
e) The said suitable transparent or opaque substance should be able to “set”, upon “standing”, into a transparent or an opaque, (preferably flexible) film.
In order to ensure that the “structural integrity” of the said compact monolayer is retained during the said “addition/introduction”, the said suitable transparent or opaque substance is “added/introduced” over the surface of the said compact monolayer by one of the following two methods:
C. According to this method, the said suitable transparent or opaque substance is sprayed on top of the said compact monolayer until a thin layer of the said suitable transparent or opaque substance is formed above the upper surface of the said compact monolayer.
D. According to this method, an adequate amount of the said suitable transparent or opaque substance in a liquid form is gently added to the top of the said compact monolayer until a thin layer of the said suitable transparent or opaque substance is formed above the upper surface of the said compact monolayer, according to the following two methods:
1. One method of achieving the said gentle addition of the said suitable transparent or opaque substance is by having a plate of suitable dimensions held at a suitable angle on top of the said compact monolayer in such a manner that one end of the said plate which is proximal to the said compact monolayer just barely touches the latter at an appropriate angle.
Then, the said suitable liquid form of the said transparent or opaque substance is “added/introduced”, drop by drop or as a very “slow stream” to the other end of the said plate (the end which is not proximal to the said compact monolayer) and allowed to slide down the said plate and onto the top of the said compact monolayer, without “breaking” the latter.
The said slow addition of the said liquid form of the said suitable transparent or opaque substance is stopped when a layer of desired thickness of the latter is formed above the upper surface of the said compact monolayer.
2. Another method of achieving the said gentle addition of the said suitable transparent or opaque substance is by having a plate of suitable dimensions held at a suitable angle on top of the said vehicle (on an area beyond the boundary of the said compact monolayer, where the surface of the said vehicle is not covered by the said compact monolayer) in such a manner that one end of the said plate which is proximal to the said vehicle just barely touches the surface of the latter at an appropriate angle.
Then, the said suitable liquid form of the said transparent or opaque substance is “added/introduced”, drop by drop or as a very “slow stream” to the other end of the said plate (the end which is not proximal to the said vehicle) and allowed to slide down the said plate and onto the top of the said vehicle, in such a manner that any “ripple effect” thus created does not cause the said compact monolayer to break or rupture.
The said slow addition of the said suitable transparent or opaque substance is continued so as to allow the latter to flow over the said compact monolayer and cover the upper surface of the latter.
The said slow addition of the said liquid form of the said suitable transparent or opaque substance is stopped when a layer of desired thickness of the latter is formed above the upper surface of the said compact monolayer.
Following the said slow addition/introduction of the said adequate amount of the said transparent or opaque substance onto the top of the said compact monolayer by any of the methods described above, an adequate length of time is allowed to pass in order to allow the said transparent or opaque substance to “set” and form a film whose lower surface is adhered to the upper surface of the said compact monolayer.
Next, the said “set” film, with the said compact monolayer adhered to its lower surface, is separated from the top surface of the said vehicle by one of the methods described in claims 20A, 20B or 20C, below:

20A: According to this claim, the said “set” film with the said compact monolayer adhered to its lower surface as described in claim 20 above, is “mechanically” removed from the top of the said vehicle by “grasping” (e.g. by means of suitable tweezers or pliers) and “peeling off” the newly formed film from the top of the said vehicle.

20B: According to this claim, the said vehicle (which is positioned below the said “set” film with the said compact monolayer adhered to its lower surface as described in claim 20 above), is allowed to be gently drained at a suitable rate out of the said sealed shallow container, through a suitable number of holes at the bottom of the said sealed shallow container, leaving behind the said “set” film with the said compact monolayer adhered to its lower surface, thus enabling the latter to spread/deposit directly on the upper surface of a suitable substrate which had previously been placed at the bottom of the said sealed shallow container.

20C: This claim comprises the “removal” of the said vehicle (which is positioned below the said “set” film with the said compact monolayer adhered to its lower surface as described in claim 20 above) from beneath the said “set” film (by employing methods identical to the procedures described in claims 19A, 19B, 19C, 19C1, 19C2, 19C3, and 19C4), thus allowing the said “set” film with the said compact monolayer adhered to its lower surface to be spread/deposited directly on the upper surface of a suitable substrate which had previously been placed at the bottom of the said sealed shallow container.

21: This claim is comprised of a method of “separating” or removing a frozen compact monolayer [made up of a suitable organic material (or organic compound)] from the top surface of a vehicle which is in a liquid state [where the said frozen compact monolayer which is floating on top of the said vehicle is first produced by one of the conventional methods and then compacted (inside a sealed shallow container, before being frozen)], by the method described below.
The vehicle which is used in this version of the claim in the preparation of the said compact monolayer should have a lower freezing point than that of the organic material (or organic compound) which makes up the said compact monolayer.
After preparing a compact monolayer [inside a sealed shallow container (as described in claim 13) by a conventional method], the next step is to reduce the temperature of the contents inside the said sealed shallow container at a suitable rate down to a level that causes the said suitable organic material (or organic compound) which makes up the said compact monolayer to freeze, while allowing the said vehicle to remain in a liquid phase.
In order to preserve “structural integrity” of the said compact monolayer during this stage of the process, the vapor pressure of the said organic material (or organic compound) which makes up the said compact monolayer inside the said sealed shallow container is constantly kept at a value that ensures the net amount of the said organic material (or organic compound) which makes up the said compact monolayer remains unchanged at every point during the said reduction of the temperature of the contents inside the said sealed shallow container [i.e. the amount of the said organic material (or organic compound) which makes up the said compact monolayer which is evaporated and removed from the said compact monolayer into the “gaseous layer” above the said compact monolayer equals the amount of the said organic material (or organic compound) which is liquefied from the said gaseous layer and added/deposited onto the said compact monolayer].
It is also preferred that during this stage of the process, the vapor pressure of the said vehicle inside the said sealed shallow container is constantly kept at a value that ensures that the net amount of the said vehicle present in the said sealed shallow container remains unchanged at every point during the said reduction of the temperature of the contents inside the said sealed shallow container [i.e. the amount of the said vehicle which is evaporated into the “gaseous layer” above the said compact monolayer equals the amount of the said vehicle which is liquefied from the said gaseous layer and added/deposited into the said vehicle].
The next step is to “separate” the said frozen compact monolayer from the said vehicle which is in a liquid phase by employing any of the methods described in claims 19A, 19B, 19C, 19C1, 19C2, 19C3, 19C4, 20, 20A, 20B and 20C while making appropriate adjustments to the ambient atmospheric pressure, the vapor pressure of the said vehicle, the vapor pressure of the said organic material (or organic compound) which makes up the said compact monolayer and the temperature of the contents of the said sealed shallow container in order to ensure that the said compact monolayer remains in the frozen state during the said “separation procedures”.

22: According to this claim, a compact monolayer [made up of a suitable organic material (or organic compound)] which is spread/deposited directly on the upper surface of a suitable substrate, as described in claim 19, is doped by a suitable method, thus allowing a doped compact monolayer to participate in any future “steps/procedures”.

23: According to this claim, a compact monolayer [made up of a suitable organic material (or organic compound)] which is spread/deposited directly on the upper surface of a suitable substrate (according to claims 19, 19A, 19B, 19C, 19C1, 19C2, 19C3, 19C4, 20, 20A, 20B, 20C and 21) is carbonized by means of a suitable “heat source” (as described in claims 23A and 23B, below), thus producing a graphene layer directly on the upper surface of the said suitable substrate.

23A: According to this claim, a compact monolayer [made up of a suitable organic material (or organic compound)] which is spread/deposited directly on the upper surface of a suitable substrate (according to claims 19, 19A, 19B, 19C, 19C1, 19C2, 19C3, 19C4, 20, 20A, 20B, 20C and 21) is carbonized by means of a suitable “radiation type beam” as the said suitable heat source mentioned in claim 23 above, thus producing a graphene layer directly on the upper surface of the said suitable substrate.
The said suitable “radiation type beam” may either be comprised of a “single beam” of the said suitable “radiation type beam”, or, it may be comprised of more than one beam of the said suitable “radiation type beam” where the said beams are “positioned” adjacent to one another contiguously so as to allow the carbonization of a larger “area” of the said compact monolayer, (as described in method 6 below) to take place in one “pass” without leaving any uncarbonized matter “behind” in the said larger area just carbonized.
The said radiation type beam could be a suitable laser beam, or a suitable maser beam, or a suitable electron beam, any of which allows the application of a sudden searing “heat” extremely quickly so as to “instantaneously” turn the said organic material (or organic compound) which makes up the said compact monolayer into solid carbon, before the said organic material (or organic compound) which makes up the said compact monolayer “gets the chance” to evaporate as a result of its exposure to the said sudden searing heat.
The said carbonization may be carried out by one of the methods (1 to 6) below:
1. Method 1: According to this method, assuming that the said compact monolayer [(which is spread/deposited directly on the upper surface of the said suitable substrate) as described in claim 23, above] is present “roughly” in the shape of a rectangle, the said single beam radiation type beam is focused on a point at one of the four corners of the said rectangle and moves on a straight line along one of the sides of the said rectangle towards the other corner of the said rectangle, either horizontally or vertically, thereby carbonizing the said organic material (or organic compound) present on the said line.
When the said single beam radiation type beam reaches the end of the said line i.e. the other corner of the said compact monolayer which is the other edge of the said suitable substrate, it moves a distance equal to the width of the said line (the width of the said single beam of the said radiation type beam), either horizontally or vertically, as the case may be, in the direction towards the center or main body of the said rectangle and starts to carbonize a “second line” of the said compact monolayer in one of the following two ways:
c) The said single beam radiation type beam starts to carbonize the said organic material (or organic compound) on a straight line in the direction which is opposite to that of the first line (i.e. the just recently carbonized line), in a manner that the adjacent edges of the said two newly carbonized lines overlap with one another, thus allowing no uncarbonized material to exist between the said two adjacent newly carbonized lines.
d) The said single beam radiation type beam starts to carbonize the said organic material (or organic compound) on a straight line, beginning at a point adjacent to the original “starting point” (towards the center or main body of the said rectangle), in the same direction as that of the first line (i.e. the just recently carbonized line), in a manner that the adjacent edges of the said two newly carbonized lines overlap with one another, thus allowing no uncarbonized material to exist between the said two adjacent newly carbonized lines.
The process of carbonizing additional overlapping new lines continues to repeat itself until the entire surface of the said compact monolayer (which is spread/deposited directly on the upper surface of the said suitable substrate) is carbonized, thus producing a graphene layer directly on the upper surface of the said suitable substrate.
2. Method 2: According to this method, the process of carbonization of the said organic material (or organic compound) [making up the said compact monolayer (which is spread/deposited directly on the upper surface of the said suitable substrate) as described in claim 23, above] is carried out in a similar manner to that described in method 1, above, except that in this method the said carbonization is carried out in a circular fashion (as opposed to the “line by line” fashion, as described in method 1, above).
According to this method, the said carbonization starts at a point at the periphery of an imaginary circle on the surface of the said compact monolayer, carbonizing the said organic material (or organic compound) which makes up the said compact monolayer by means of the said single beam radiation type beam as mentioned in method 1 above, along an imaginary outermost line (representing the outermost periphery) of the said imaginary circle, until the outermost line of the said imaginary circle is carbonized in its entirety.
Then, the said single beam radiation type beam moves a distance equal to the width of the said line (the width of the said single beam of the said radiation type beam) in the direction towards the center or main body of the said circle and starts to carbonize a “second circle” of the said compact monolayer in the same manner as described for the first circle in a manner that the adjacent edges of the said two newly carbonized lines making up the two concentric newly carbonized circles overlap with one another thus allowing no uncarbonized material to exist between the said two adjacent newly carbonized lines/circles.
This process of carbonizing additional overlapping new lines, or new overlapping concentric circles, continues to repeat itself until the entire surface of the said organic material (or organic compound) making up the said compact monolayer (which is spread/deposited directly on the upper surface of the said suitable substrate) is carbonized, thus producing a graphene layer directly on the upper surface of the said suitable substrate.
3. Method 3: According to this method, the process of carbonization of the said organic material (or organic compound) [making up the said compact monolayer (which is spread/deposited directly on the upper surface of the said suitable substrate) as described in claim 23, above] is carried out in a similar manner to that described in method 2, above, except that in this method the said carbonization is carried out in the “reverse order” to that described in method 2, above.
Thus, the starting point for the said carbonization is the center of the said “imaginary” circle on the surface of the said compact monolayer, and then the “immediate” area surrounding the said newly carbonized center is carbonized in a circular manner in a manner that no uncarbonized material are allowed to exist between the said newly carbonized center and the said newly carbonized “enveloping” circle.
Then a larger circle is carbonized in a manner that this larger circle “envelops” the said “recently” carbonized circle and the said two newly carbonized concentric circles touch one another at all points along the adjacent lines making up the said two newly carbonized circles, thus allowing no uncarbonized material to exist between the said two adjacent newly carbonized concentric circles.
The said process of carbonization of a larger circle to envelop the “recently” carbonized circle as described above repeats itself until the entire surface of the said organic material (or organic compound) making up the said compact monolayer (which is spread/deposited directly on the upper surface of the said suitable substrate) is carbonized, thus producing a graphene layer directly on the upper surface of the said suitable substrate.
4. Method 4: According to this method, the process of carbonization of the said organic material (or organic compound) [making up the said compact monolayer (which is spread/deposited directly on the upper surface of the said suitable substrate) as described in claim 23, above] is carried out in a similar manner to that described in method 2, above, except that in this method the said carbonization is carried out in a “rectangular” fashion (as opposed to the said “circular” fashion, as described in method 2, above).
Thus, the said single beam radiation type beam starts the said carbonization at one of the four corners at the periphery of an imaginary rectangle on the surface of the said compact monolayer, and then moves on a straight line along one of the sides of the said rectangle towards the other corner of the said rectangle, either horizontally or vertically (as the case may be), thereby carbonizing the said organic material (or organic compound) that is present on the said line.
When the said single beam radiation type beam reaches the end of the said line, it stops and then continues the said carbonization at 90 degrees until it reaches the third corner of the said square, then it stops and then continues the said carbonization at 90 degrees until it reaches the fourth corner of the said square, then it stops and then continues the said carbonization at 90 degrees until it reaches the first corner of the said square, thereby completing the carbonization of the outermost sides of the said rectangle.
At this point, the said single beam radiation type beam moves a distance equal to the width of the said line (the width of the said single beam of the said radiation type beam), in the direction towards the center or main body of the said rectangle and starts to carbonize the said organic material (or organic compound) in a square fashion as described above, in a manner that the second rectangle is smaller than the first rectangle and fits inside the latter, and the edges of the said adjacent lines making up the said “concentric rectangles” overlap/touch one another at all points along the said lines, thus allowing no uncarbonized material to exist between the said two adjacent newly carbonized lines.
This process of carbonizing additional overlapping new rectangles, or new overlapping “concentric” rectangles, continues to repeat itself until the entire surface of the said organic material (or organic compound) making up the said compact monolayer (which is spread/deposited directly on the upper surface of the said suitable substrate) is carbonized, thus producing a graphene layer directly on the upper surface of the said suitable substrate.
5. Method 5: According to this method, the process of carbonization of the said organic material (or organic compound) [making up the said compact monolayer (which is spread/deposited directly on the upper surface of the said suitable substrate) as described in claim 23, above] is carried out in a similar manner to that described in method 4, above, except that in this method the said carbonization is carried out in the “reverse order” to that described in method 4, above.
Thus, the starting point for the said carbonization is the “center” of the said “imaginary” rectangle on the surface of the said compact monolayer as described in method 4, above, then the “immediate” area surrounding the said newly carbonized center is carbonized in a rectangular manner in a manner that no uncarbonized material is allowed to exist between the said newly carbonized center and the said newly carbonized “enveloping” rectangle.
Then a larger rectangle is carbonized in a manner that this larger rectangle “envelops” the said newly carbonized rectangle, and the said two newly carbonized rectangles touch one another at all points along the adjacent lines making up the sides of the said two newly carbonized rectangles, thus allowing no uncarbonized material to exist between the said two adjacent newly carbonized rectangles.
The said process of carbonization of a larger rectangle to envelop the newly carbonized rectangle as described above repeats itself until the entire surface of the said organic material (or organic compound) making up the said compact monolayer (which is spread/deposited directly on the upper surface of the said suitable substrate) is carbonized, thus producing a graphene layer directly on the upper surface of the said suitable substrate.
6. Method 6: According to this method, the process of carbonization of the said organic material (or organic compound) [making up the said compact monolayer (which is spread/deposited directly on the upper surface of the said suitable substrate) as described in claim 23, above] is carried out in a similar manner to any of the methods 1 to 5 above, except that in this method, the radiation type beam is comprised of more than one beam of the said suitable “radiation type beam” (as described in claim 23A, above).

23A1: This claim is comprised of the carbonization of an organic material (or organic compound) making up a compact monolayer (which is spread/deposited directly on the upper surface of a suitable substrate) by a suitable “radiation type beam” (as described in claim 23A) while ensuring that the point where the said suitable radiation type beam meets the said compact monolayer, plus the areas surrounding that point, are “kept” at a suitably low temperature.
The purpose of having the said “point plus its surrounding areas” kept at a suitably low temperature is to prevent the “loss” of the said compact monolayer by evaporation (as a result of the “exposure” of the said compact monolayer to the said radiation type beam) achieved through the use of a suitable non-carbon containing cold fluid, according to one of the following methods:
a. “Keep” the said suitable substrate submerged (at a suitable depth) under a layer of a suitable non-carbon containing cold liquid throughout the process of carbonization of the said compact monolayer by the said radiation type beam, where the latter passes through the said layer of the said suitable non-carbon containing cold liquid in order to carry out the said carbonization; or
b. Allow the said “layer of a suitable non-carbon containing cold liquid” (mentioned in method “a” above) to freeze, followed by carbonization of the said compact monolayer by the said radiation type beam (mentioned in method “a” above), where the said radiation type beam passes through the resultant frozen layer in order to carry out the said carbonization; or
c. Pour a “continuous sheet” of a suitable non-carbon containing cold liquid over the entire surface of the said compact monolayer throughout the process of carbonization of the said compact monolayer by the said radiation type beam while the said suitable substrate, which is supporting the said compact monolayer, is held at a suitable angle so as to allow the non-carbon containing cold liquid which is “drained off” from the bottom of the said suitable substrate to be collected; or
d. “Pour/introduce” a “continuous stream” of a suitable non-carbon containing cold fluid (a liquid or a gas or a mixture of a gas plus droplets of a liquid) over the said “point plus its surrounding areas” as mentioned above, through a tube which possesses a suitable internal diameter, throughout the process of carbonization of the said compact monolayer by the said radiation type beam.
The said suitable non-carbon containing cold fluid, mentioned above, should possess the following properties:
a. It should not chemically react with the said organic material (or organic compound) which makes up the said compact monolayer.
b. It should not dissolve the said organic material (or organic compound) which makes up the said compact monolayer.
c. It should not suspend into the said organic material (or organic compound) which makes up the said compact monolayer.
d. It should ideally be “transparent” to the said radiation type beam (i.e. the said radiation type beam should pass through the said non-carbon containing cold fluid without being absorbed by the latter).
e. Finally, the said suitable non-carbon containing cold fluid should not allow the said organic material (or organic compound) which makes up the said compact monolayer to be suspended into the said suitable non-carbon containing cold fluid.

23A2: This claim is comprised of the carbonization of an organic compound (or organic compound) making up a compact monolayer, which is spread/deposited directly on the upper surface of a suitable substrate, by a suitable “radiation type beam(s)” (as described in claim 23A) while ensuring that the said suitable substrate is “kept” at a suitably low temperature during the said carbonization.
The above objective of keeping the said suitable substrate at a suitably low temperature during the said carbonization may be achieved by convection or conduction methods of heat transfer, such as allowing the lower surface of the said suitable substrate to be in “contact” with a suitable substance which is at a suitable temperature during the said carbonization (e.g. allow the lower surface of the said suitable substrate to “float” on top of a suitable cold liquid); or, by placing the said suitable substrate inside a suitable enclosed “chamber” where the ambient temperature and atmospheric pressure inside the said chamber are optimal during the said carbonization.

23A3: According to this claim, a frozen compact monolayer [made up of a suitable organic material (or organic compound)], as described in claim 21, is carbonized by a suitable radiation type beam (by a method as described in claim 23A) while the said frozen compact monolayer is still floating on top of a suitable vehicle.

23A4: According to this claim, the suitable vehicle beneath a compact monolayer [made up of a suitable organic material (or organic compound)] is frozen (while allowing the latter to remain in a liquid state), followed by carbonization of the said compact monolayer by a suitable radiation type beam (by a method as described in claim 23A4).
According to this claim, it is preferable to use a suitable non-carbon containing substance (e.g. water) as the said suitable vehicle used in the preparation of the said compact monolayer, so that there is no possibility of carbonization of the said suitable vehicle even if the said radiation type beam “passes through” the said compact monolayer and “penetrates” into the said suitable vehicle.
One of the properties of the said suitable vehicle mentioned in this claim is that the freezing point of the said suitable vehicle must be higher than that of the said compact monolayer.

23A5: According to this claim, a compact monolayer [made up of a suitable organic material (or organic compound)] as well as the suitable vehicle beneath the latter are frozen, followed by carbonization of the said compact monolayer by a suitable radiation type beam (by a method as described in claim 23A).
According to this claim, it is preferable to use a suitable non-carbon containing substance (e.g. water) as the said suitable vehicle used in the preparation of the said compact monolayer, so that there is no possibility of carbonization of the said suitable vehicle even if the said radiation type beam “passes through” the said compact monolayer and “penetrates” into the said suitable vehicle.

23B: According to this claim, the said compact monolayer as mentioned in claim 23, above, is carbonized by means of a suitably hot surface as the said suitable heat source mentioned in claim 23 above, where the said suitably hot surface is provided by a hot plate or a hot roller.
The said suitably hot surface is allowed to come into contact with the said compact monolayer for an appropriate length of time, thus carbonizing the said organic material (or organic compound) which makes up the said compact monolayer, thereby converting the latter into a graphene layer.

23B1: This claim is comprised of a method of either facilitating the “detachment”, or conversely, hindering the said detachment (i.e. enhancing the “adherence”) of a graphene layer from the surface of a substrate (as described in claim 2 or 5 or the non-stick versions of claim 2 or 5 as described in claim 6), by means of altering the temperature of the said surface of the said substrate.
The said change in the said temperature of the said surface of the said substrate as mentioned above may be achieved by allowing a suitable fluid, having a suitable temperature, to run through the tube which is below the said surface of the said substrate (as described in claim 2 or 5 or the non-stick versions of claim 2 or 5 as described in claim 6), thus altering the surface temperature of the said substrate, thereby making the separation of the said graphene layer from the said surface of the said substrate either easier or more difficult, depending on the temperature of the said suitable fluid.

23B2: This claim is comprised of a method of either facilitating the “detachment”, or conversely, hindering the said detachment (i.e. enhancing the “adherence”) of a graphene layer from the surface of a plate (as described in claim 8 or 11 or the non-stick versions of claim 8 or 11 as described in claim 12), by means of altering the temperature of the said surface of the said plate.
The said change in the said temperature of the said surface of the said plate as mentioned above may be achieved by allowing a suitable fluid, having a suitable temperature, to run through the tube which is below the said surface of the said plate (as described in claim 8 or 11 or the non-stick versions of claim 8 or 11 as described in claim 12), thus altering the surface temperature of the said plate, thereby making the separation of the said graphene layer from the said surface of the said plate either easier or more difficult, depending on the temperature of the said suitable fluid.

23B3: This claim is comprised of a method of facilitating the “detachment” of a graphene layer, which is resting/spread on the upper surface of a suitable substrate, from the said upper surface of the said suitable substrate, by means of the repulsive forces of electrostatic charges.
The above objective may be achieved by means of projecting an electrostatic charge (either positive or negative) by suitable method(s), onto the upper surface of the said suitable substrate as well as the lower surface of the said compact monolayer (that is deposited on the upper surface of the said suitable substrate) before the said compact monolayer is carbonized by a suitable method, or alternatively, by projecting the said electrostatic charges onto the upper surface of the said suitable substrate as well as the lower surface of the said graphene layer (that is resting/spread on the upper surface of the said suitable substrate).
As a result of the presence of the repulsive electrostatic forces between the said upper surface of the said suitable substrate and the said lower surface of the said graphene layer (due to the presence of the said same sign electrostatic charges on both of the above-mentioned surfaces), the detachment of the said graphene layer from the said suitable substrate is facilitated.

23B4: This claim is comprised of a method of “enhancing” the “adherence” of a graphene layer which is resting/spread on the upper surface of a suitable substrate, to the said upper surface of the said suitable substrate, by means of the attractive forces of electrostatic charges.
The above objective may be achieved by employing methods identical to the ones mentioned in claim 23B3 above, except that according to this claim, the said electrostatic charges are of opposite signs (i.e. the electrostatic charge projected onto the upper surface of the said suitable substrate is of opposite sign to the electrostatic charge projected onto the lower surface of the said compact monolayer or the said graphene layer, as the case may be).
As a result of the presence of the attractive electrostatic forces between the said upper surface of the said suitable substrate and the said lower surface of the said graphene layer (due to the presence of the said opposite sign electrostatic charges on the above-mentioned surfaces), the adherence of the said graphene layer to the said suitable substrate is enhanced.

23B5: This claim is comprised of a method of facilitating the “detachment” of a graphene layer from (or, hindering the “attachment” of the said graphene layer to) the surface of a suitable plate (where the said suitable plate is described in claim 12) by means of the repulsive forces of electrostatic charges.
The above objective may be achieved by means of projecting an electrostatic charge (either positive or negative) by suitable method(s) onto the surface of the said suitable plate (the surface which will come into contact with the said compact monolayer in order to carbonize the latter) as well as the upper surface of the said compact monolayer (that is deposited on the upper surface of a suitable substrate) before the said compact monolayer is carbonized by the said surface of the said suitable plate, or alternatively, by projecting the said electrostatic charges onto the said surface of the said suitable plate as well as the surface of the graphene layer which is adhered to the said surface of the said suitable plate.
As a result of the presence of the repulsive electrostatic forces between the said surface of the said suitable plate and the said surface of the said graphene layer (due to the presence of the said same sign electrostatic charges on both of the above-mentioned surfaces), the adherence of the said graphene layer to the said surface of the said suitable plate is hindered.

23B6: This claim is comprised of a method of “enhancing” the “adherence” of a graphene layer to the surface of a suitable plate (where the said suitable plate is described in claims 7, 8, 9, 10, 11, and 12) by means of the attractive forces of electrostatic charges.
The above objective may be achieved by employing methods identical to the ones mentioned in claim 23B5 above, except that according to this claim, the said electrostatic charges are of opposite signs i.e. the electrostatic charge projected onto the said surface of the said suitable plate is of the opposite sign to the electrostatic charge projected onto the upper surface of the said compact monolayer (that is deposited on the upper surface of a suitable substrate).
As a result of the presence of the attractive electrostatic forces between the said surface of the said suitable plate and the said surface of the said graphene layer (due to the presence of the said opposite sign electrostatic charges on the above-mentioned surfaces), the adherence of the said graphene layer to the said surface of the said suitable plate is enhanced.

24: According to this claim, a compact monolayer [made up of a suitable organic material (or organic compound)] which is produced by one of the conventional methods while still resting/floating on top of a suitable vehicle, is carbonized by means of a suitable radiation type beam as described in claim 23, according to one of the methods described in claim 23A.
According to this claim, it is preferable to use a suitable non-carbon containing substance (e.g. water) as the said suitable vehicle used in the preparation of the said compact monolayer, so that there is no possibility of carbonization of the said suitable vehicle even if the said radiation type beam “passes through” the said compact monolayer and “penetrates” into the said suitable vehicle.

24A: According to this claim, a doped compact monolayer [made up of a suitable doped organic material (or organic compound)] which is produced by one of the conventional methods and resting/floating on top of a suitable vehicle, is carbonized (while still floating on top of the said suitable vehicle) by means of a suitable radiation type beam as described in claim 23, according to one of the methods described in claim 23A.
According to this claim, it is preferable to use a suitable non-carbon containing substance (e.g. water) as the vehicle used in the preparation of the said doped compact monolayer, so that there is no possibility of carbonization of the said suitable vehicle even if the said radiation type beam “passes through” the said doped compact monolayer and “penetrates” into the said suitable vehicle.

25: According to this claim, a compact monolayer [made up of a suitable organic material (or organic compound)] which is spread/deposited directly on the upper surface of a suitable substrate (as described in claims 19, 19A, 19B, 19C and 20) is carbonized according to a “desired pattern” by means of a suitable radiation type beam (as described in claim 23A), using a method similar to the methods described in claim 23A [except that only those “sections” of the said compact monolayer which are a part of the said desired pattern are carbonized, while “leaving” the rest of the said compact monolayer (those sections which are not a part of the said desired pattern) uncarbonized], thus producing a “patterned” graphene layer which is spread/deposited directly on the upper surface of the said suitable substrate.
The next stage in this claim is the “removal” of the said uncarbonized sections of the said compact monolayer present “within” the said patterned graphene layer (thus “leaving behind” solely the said patterned graphene layer spread/deposited directly on the upper surface of the said suitable substrate) according to one of the methods as described below:

25A: According to this claim, the removal of the said uncarbonized suitable organic material (or organic compound) present “within” the said patterned graphene layer (as described in claim 25, above) is achieved by evaporating the said uncarbonized suitable organic material (or organic compound) by means of the application of heat of suitable intensity at a suitable “pace/rate” (e.g. the flame of a suitable torch, or a fan driven heated air current from a device similar to a hair dryer) to the said patterned graphene layer, thus leaving behind solely the said patterned graphene layer spread/deposited on the upper surface of the said suitable substrate.

25B: According to this claim, the removal of the said uncarbonized suitable organic material (or organic compound) present “within” the said patterned graphene layer (as described in claim 25, above) is achieved by “washing away” the said uncarbonized suitable organic material (or organic compound) by means of a suitable chemical agent (possessing an appropriate “flow pressure” and being at an appropriate temperature), thus leaving behind solely the said patterned graphene layer spread/deposited on the upper surface of the said suitable substrate.

25C: According to this claim, the removal of the said uncarbonized suitable organic material (or organic compound) present “within” the said patterned graphene layer (as described in claim 25, above) is achieved by dissolving the said uncarbonized suitable organic material (or organic compound) into a suitable solvent, followed by discarding the said suitable solvent containing the said dissolved material, thus leaving behind solely the said patterned graphene layer spread/deposited on the upper surface of the said suitable substrate.

25D: According to this claim, the removal of the said uncarbonized suitable organic material (or organic compound) present “within” the said patterned graphene layer (as described in claim 25, above) is achieved by the addition of a suitable chemical agent that chemically reacts with the said uncarbonized suitable organic material (or organic compound) in order to form a chemical substance that can then be washed away or removed by another suitable chemical agent, thus leaving behind solely the said patterned graphene layer spread/deposited on the upper surface of the said suitable substrate.

26: According to this claim, a doped compact monolayer [made up of a suitable doped organic material (or doped organic compound)] spread/deposited directly on the upper surface of a suitable substrate (as described in claim 22) is carbonized by employing methods described in claims 23, 23A, 23B, or 25, above, thus producing a doped graphene layer (or a doped patterned graphene layer, if the said carbonization is carried out according to claim 25) which is spread/deposited directly on the upper surface of the said suitable substrate.
Where a method according to claim 25 is employed, the next step is the “removal” of the said uncarbonized sections of the said doped compact monolayer present “within” the said doped patterned graphene layer according to one of the methods described in claims 25A, 25B, 25C or 25D, thus “leaving behind” solely the said doped patterned graphene layer spread/deposited on the upper surface of the said suitable substrate.

27: According to this claim, a compact monolayer [made up of a suitable organic material (or organic compound)] spread/deposited directly on the upper surface of a suitable substrate (as described in claim 19) is removed from the said surface of the said suitable substrate by means of a “Hamid Substrate”, followed by carbonization of the said compact monolayer [made up of a suitable organic material (or organic compound)] according to one of the methods as described in claims 23A, 23B or 25.
A Hamid Substrate is a thin, flexible and foldable opaque or transparent sheet which is covered on one side by a thin layer of a suitable opaque or transparent adhesive material, while the other side of the said sheet remains adhesive free.
To achieve the said removal of the said compact monolayer as mentioned above, the adhesive surface of a Hamid Substrate is allowed to come into contact with and spread itself over the upper surface of the said compact monolayer (which is spread/deposited directly on the upper surface of the said suitable substrate) so as to cause the said adhesive surface of the said Hamid Substrate to adhere to the said upper surface of the said compact monolayer.
In order to ensure a complete “contact” between the said adhesive surface of the said Hamid Substrate and the said upper surface of the said compact monolayer, and to “drive out” any “bubbles” that may have been trapped between the said adhesive surface of the said Hamid Substrate and the said upper surface of the said compact monolayer, it may be desirable to apply an adequate amount of pressure on the adhesive-free side of the said Hamid Substrate, either by means of a suitable “roller” which is allowed to roll over the adhesive-free side of the said Hamid Substrate, or by means of allowing a “padded plate” to impart the said pressure over the entire area of the said adhesive-free side of the said Hamid Substrate.
Next, the said roller (or the said padded plate) is removed from the said adhesive-free side of the said Hamid Substrate.
Next, the said Hamid Substrate is removed/“moved away” from the said suitable substrate, thus obtaining a Hamid Substrate with a compact monolayer adhered to its “adhesive side”.
Next, the said compact monolayer (adhered to the said adhesive side of the said Hamid Substrate) is carbonized (by a method similar to those described in claims 23A, 23B or 25) while ensuring that the intensity of the said heat source and the duration of the application of the said heat source are at optimum values so as to carbonize only the said compact monolayer, and avoid the carbonization of the adhesive material beneath the said compact monolayer.
Where the method according to claim 25 is employed, the next step is the “removal” of the said uncarbonized sections of the said compact monolayer present “within” the said patterned graphene layer according to one of the methods as described in claims 25A, 25B, 25C or 25D, thus “leaving behind” solely the said patterned graphene layer adhered to the said adhesive surface of the said Hamid Substrate.
The said surface of the said Hamid Substrate bearing the said patterned or un-patterned graphene layer may then be “covered” by a “protective layer” so as to protect as well as prevent the contamination of the said graphene layer, according to one of the methods described in claims 27A, 27B or 27C, below:

27A: According to this claim, the said protective layer as described in claim 27, above, may be another Hamid Substrate, where the adhesive side of a “new” Hamid Substrate is allowed to adhere to the said adhesive side of the said Hamid Substrate which bears a graphene layer as described in claim 27, thus creating a “sandwich type structure” that consists of the said patterned or un-patterned graphene layer sandwiched between the adhesive sides of the said two Hamid Substrates.
A technique similar to the one in claim 27 is used in order to ensure a complete “contact” between the said two Hamid Substrates and to “drive out” any “bubbles” that may have been trapped between the said two Hamid Substrates (i.e. the said sandwich type structure is placed on a “table”, then an adequate amount of pressure is exerted on the upper surface of the said sandwich type structure, either by means of a suitable “roller” which is allowed to roll over the said upper surface of the said sandwich type structure, or by means of allowing a “padded plate” to impart the said pressure over the entire area of the said upper surface of the said sandwich type structure).

27B: According to this claim, the said protective layer as described in claim 27 may be “provided” by the addition of a suitable (opaque or transparent) flexible film (made up of a suitable substance) onto the surface of a Hamid Substrate bearing the said patterned or un-patterned graphene layer as described in claim 27.
The said suitable (opaque or transparent) flexible film is made up of a suitable (liquid or gaseous) substance that “sets”, upon standing, into an opaque or a transparent flexible film.
The said suitable substance should not react with, nor dissolve, nor be dissolved in the said patterned or un-patterned graphene layer.
The said addition of the said suitable (opaque or transparent) flexible film (made up of a suitable material) onto the said surface of the said Hamid Substrate bearing the said patterned or un-patterned graphene layer (as described in claim 27, above) is achieved by one of the following methods:
1. According to this method, the said suitable (opaque or transparent) substance is added onto the said surface of a Hamid Substrate bearing the said patterned or un-patterned graphene layer as described in claim 27 by a direct application (e.g. spraying or brushing).
2. According to this method, a Hamid Substrate bearing the said patterned or un-patterned graphene layer as described in claim 27 is placed at the bottom of a shallow dish (with its patterned or un-patterned graphene bearing side facing up), followed by adding an adequate amount of the said suitable liquid material into the said shallow dish until a desired layer of the said suitable liquid material is “formed” on top of the said Hamid Substrate.
3. According to this method, a Hamid Substrate bearing the said patterned or un-patterned graphene layer as described in claim 27 is placed at the bottom of an enclosed shallow dish (with its patterned or un-patterned graphene bearing side facing up), followed by adding an adequate amount of the said suitable material in a gaseous state into the said enclosed shallow dish while ensuring that the magnitude of the ambient atmospheric pressure inside the said enclosed shallow dish is adequate so as to liquefy the said gaseous substance, until a desired layer of the said liquefied suitable material is “formed” on top of the said Hamid Substrate.
Following the addition of a desired layer of the said suitable (opaque or transparent) substance onto the said surface of a Hamid Substrate by any of the methods described above, an adequate length of time is allowed to pass in order to allow the said suitable (opaque or transparent) substance to set into an opaque or transparent flexible film.

28: According to this claim, a doped compact monolayer [made up of a suitable doped organic material (or doped organic compound)] spread/deposited directly on the upper surface of the said suitable substrate (as described in claim 22) is removed from the said upper surface of the said suitable substrate (as described in claim 27), then carbonized (as described in the claim 27), followed by the procedures according to one of the methods described in claims 27A or 27B.

29: This claim is comprised of a “continuous process” for the removal of a vehicle from beneath a compact monolayer [made up of a suitable organic material (or organic compound)] where the latter is floating on top of the said vehicle.
A long sealed shallow container, as described in claim 14, is used for the preparation of the said compact monolayer according to this claim.
First, a shallow tray is placed over the conveyor belt (inside the said long sealed shallow container) while the said conveyor belt is switched off i.e. not moving.
Next, a suitable substrate is placed at the bottom of the said shallow tray.
Then, a compact monolayer is produced in one piece (by a suitable conventional method, floating on top of a suitable vehicle) inside the said shallow tray.
Next, the said conveyor belt is switched on [which starts to slowly move the said shallow tray (with its contents) towards the other end of the said “long corridor” (as mentioned in claim 14), without causing ripples or “disturbing” the said compact monolayer] while simultaneously the “conditions” inside the said long sealed shallow container are optimized so as to allow the “removal” of the said vehicle from beneath the said compact monolayer throughout the latter's journey from one end to the other end of the said long corridor, by any of the methods described in claims 19A, 19B, 19C, 19C1, 19C2, 19C3 and 19C4 through the following modifications:
If the method of the removal of the said vehicle is to be carried out according to claim 19B, then the said steady removal of the gaseous layer above the compact monolayer inside the said long sealed shallow container as well as the “introduction” of the “fresh” mixture of gases in order to replace the said removed gaseous layer, as is required in claim 19B, should take place at numerous locations along the entire length of the said long corridor (as mentioned in claim 14), through their corresponding tubes in such a manner as to satisfy the conditions required by claim 19B throughout the length of the said long corridor (as mentioned in claim 14) [i.e. the conditions required (as explained in claim 19B) in order to prevent the net evaporation or the net liquefaction of the said organic material which makes up the compact monolayer; to prevent the said vehicle or the said organic material (or organic compound) which makes up the said compact monolayer from coming to a boil; and to promote the continuous evaporation, at a desirable rate, of the said vehicle to take place only from the part of the surface of the said vehicle that is not covered by the said monolayer]. Thus, as the said shallow tray travels along the length of the said long corridor (as mentioned in claim 14), it is constantly travelling in an environment that encourages a steady removal of the said vehicle from beneath the said compact monolayer while the latter remains qualitatively and quantitatively unchanged.
Similarly, if the method of the removal of the said vehicle is to be carried out according to any of the claims involved in claim 19C (i.e. claims 19C1, 19C2, 19C3 or 19C4), then, in order to satisfy the conditions required by claim 19B throughout the length of the said long corridor (as mentioned in claim 14), an appropriate number of the said appropriate sized containers (each containing the appropriate suitable material required in the respective claim) are placed at numerous locations along the entire length of the said long corridor (as mentioned in claim 14) at a level above the said compact monolayer [i.e. if the method according claim 19C1 is chosen, then, all the said appropriate sized containers (which are placed at numerous locations along the entire length of the said long corridor—as mentioned in claim 14—at a level above the said compact monolayer) should contain the said suitable material which is required by claim 19C1].
The contents of the said appropriate sized containers need to be replaced by “fresh” materials periodically, as needed.
Whichever of the methods mentioned above is chosen, the speed of the said conveyor belt (i.e. the travelling speed of the said shallow tray) is adjusted so that by the time the said shallow tray reaches the end of its journey [i.e. the opposite end of the said long corridor (as mentioned in claim 14)], all the said vehicle has been removed from beneath the said compact monolayer and the latter comes to rest/spread/deposit directly on the upper surface of the said suitable substrate.
Using the said conveyor belt system (and the methods mentioned above) allows a “row” of the said shallow trays to be placed on the said conveyor belt and thus allows for a continuous process for “industrial” production.

30: According to this claim, a compact monolayer [made up of a suitable organic material (or organic compound)] floating on top of a suitable vehicle is “persuaded” to spread/deposit on the upper surface of a suitable substrate by means of the attractive forces of electrostatic charges.
The above objective may be achieved by means of “projecting” an electrostatic charge (either positive or negative), by suitable method(s), onto the lower surface of the said compact monolayer [made up of a suitable organic material (or organic compound)] while “projecting” an electrostatic charge of opposite sign (to that of the said electrostatic charge projected onto the said lower surface of the said compact monolayer), by suitable method(s), onto the said upper surface of the said suitable substrate.
As a result of the presence of the attractive electrostatic forces between the said lower surface of the said compact monolayer and the said upper surface of the said suitable substrate (due to the presence of the said opposite sign electrostatic charges on the above-mentioned surfaces), the said compact monolayer is “persuaded” to spread/deposit on the said upper surface of the said suitable substrate.
The said compact monolayer, the said suitable substrate, the said suitable vehicle, and the shallow tray which are used in this claim should have the properties listed below:
A property of the said compact monolayer is that its surface is capable of “accepting” an electrostatic charge and “trapping”/“holding on to” the said electrostatic charge.
A property of the said suitable substrate is that its surface is capable of “accepting” an electrostatic charge and “trapping”/“holding on to” the said electrostatic charge.
One of the properties of the said suitable vehicle is that when the said compact monolayer (which is floating on the top of the said suitable vehicle) is carrying an electrostatic charge on its surface, the said suitable vehicle does not “adversely interfere” with the said electrostatic charge i.e. the said suitable vehicle does not cause the said electrostatic charge carried by the said compact monolayer to be “neutralized”.
Another property of the said suitable vehicle is that when the said suitable substrate is carrying an electrostatic charge on its surface, the said suitable vehicle does not adversely interfere with the said electrostatic charge i.e. the said suitable vehicle does not cause the said electrostatic charge carried by the said suitable substrate to be “neutralized”.
A property of the said shallow tray is that the latter does not adversely interfere with the electrostatic charges carried by the other components throughout the processes i.e. the said shallow tray does not cause the said electrostatic charges carried by the said compact monolayer or the said suitable substrate to be “neutralized”.
The sequence of steps to prepare a compact monolayer spread/deposited on the upper surface of a suitable substrate according to this claim is as follows:
First, a long sealed shallow container is used that is identical to that described in claim 15.
Then, a suitable substrate is placed at the bottom of the said shallow tray (as described in claim 15.
Then, a compact monolayer [made up of a suitable organic material (or organic compound)] is produced in one piece [(by one of the conventional methods), floating on top of a suitable vehicle] inside the said shallow tray.
Next, the said shallow tray is placed on the floor, inside the said long sealed shallow container.
Next, an electrostatic charge is “projected” onto the lower surface of the said compact monolayer by suitable means.
Next, one side of the said suitable substrate is raised slightly so that the said suitable substrate is no longer completely horizontal i.e. there is now an “angle of inclination” between the “horizontal level” and the said suitable substrate.
Next, an electrostatic charge of opposite sign to that projected onto the lower surface of the said compact monolayer is projected onto the upper surface of the said suitable substrate by suitable means i.e. if the said lower surface of the said compact monolayer carries a positive electrostatic charge, then the said upper surface of the said suitable substrate should end up carrying a negative electrostatic charge.
Next, the entire “body” of the said charged suitable substrate is raised “uniformly” in a very slow manner (in order to prevent causing ripples or “disturbing” the said charged compact monolayer) i.e. the magnitude of the said angle of inclination is kept constant throughout the said raising process of the said charged suitable substrate.
Eventually, as the said charged suitable substrate rises, the said charged upper surface of the said raised side of the said charged suitable substrate “breaks through” the surface of the liquid inside the said shallow tray (i.e. the said vehicle and the said charged compact monolayer), thus the said lower surface of the said charged compact monolayer comes into contact with the said oppositely charged upper surface of the said raised side of the said suitable substrate. As a result, the said lower surface of the said compact monolayer will be attracted to, and therefore, adhere to the said upper surface of the said raised side of the said suitable substrate, because the former and the latter carry electrostatic charges of opposite signs.
As the “gentle” raising of the said charged suitable substrate proceeds, the said charged upper surface of the said suitable substrate will progressively become “covered” with the said oppositely charged compact monolayer until the entire “body” of the said suitable substrate is raised above the said liquid inside the said shallow tray (i.e. above the said vehicle and the said charged compact monolayer). The end result of the above process is that the said compact monolayer will come to rest/spread/deposit directly on the said upper surface of the said suitable substrate.
Next, both the said compact monolayer and the said suitable substrate may be neutralized by a discharge (e.g. bleed off to ground).
The next step involves the removal of the last remnants/traces of the said vehicle which might have been trapped between the said lower surface of the said compact monolayer and the said upper surface of the said suitable substrate, which may be achieved by using methods described in claim 29.

31: According to this claim, a compact monolayer [made up of a suitable organic material (or organic compound)] floating on top of a suitable vehicle is “persuaded” to spread/deposit on the outward surface of a suitable substrate strip (as described in claim 16) by means of the attractive forces of electrostatic charges.
The above objective may be achieved by means of “projecting” an electrostatic charge (either positive or negative), by suitable method(s), onto the lower surface of the said compact monolayer while “projecting” an electrostatic charge of opposite sign—to that of the said electrostatic charge projected onto the said lower surface of the said compact monolayer—by suitable method(s), onto the said outward surface of the said suitable substrate strip.
As a result of the presence of the attractive electrostatic forces between the said lower surface of the said compact monolayer and the said outward surface of the said suitable substrate strip (due to the presence of the said opposite sign electrostatic charges on the above-mentioned surfaces), the said compact monolayer is “persuaded” to spread/deposit on the said outward surface of the said suitable substrate strip.
The said compact monolayer, the “encircling instrument” (a non-stick filament used for pushing the outer periphery of a monolayer in order to produce a monolayer of desired “compactness”, i.e. to produce a compact monolayer), the said substrate strip, the suitable vehicle, the shallow tray, and the rollers (holding the said substrate strip in “place”) which are used in this claim should have the properties listed below:
A property of the said compact monolayer is that its surface is capable of “accepting” an electrostatic charge and “trapping”/“holding on to” the said electrostatic charge.
One of the properties of the said suitable substrate strip is that the latter as well as its outward surface are capable of “accepting” an electrostatic charge and “trapping”/“holding on to” the said electrostatic charge.
Another property of the said suitable substrate strip is that its outward surface is made up of a material that does not carbonize when subjected to a heat source, as described in claim 23.
One of the properties of the said suitable vehicle is that when the said compact monolayer (which is floating on the top of the said suitable vehicle) is carrying an electrostatic charge on its surface, the said vehicle does not “adversely interfere” with the said electrostatic charge i.e. the said suitable vehicle does not cause the said electrostatic charge carried by the said compact monolayer to be “neutralized”.
Another property of the said suitable vehicle is that when the said suitable substrate strip is carrying an electrostatic charge on its outward surface, the said suitable vehicle does not “adversely interfere” with the said electrostatic charge i.e. the said suitable vehicle does not cause the said electrostatic charge carried by the said outward surface of the said suitable substrate strip to be “neutralized”.
A property of the said shallow tray is that the latter does not “adversely interfere” with the electrostatic charges carried by the other components throughout the processes i.e. the said shallow tray does not cause the said electrostatic charges carried by the other components to be “neutralized”.
A property of the said encircling instrument is that the latter does not “adversely interfere” with the electrostatic charges carried by the other components throughout the processes i.e. the said encircling instrument does not cause the said electrostatic charges carried by the other components to be “neutralized”.
A property of the said rollers is that the latter do not “adversely interfere” with the electrostatic charges of the other components throughout the processes i.e. the said rollers do not cause the said electrostatic charges carried by the other components to be “neutralized”.
The sequence of steps to prepare a compact monolayer spread/deposited on the outward surface of a suitable substrate strip according to claim 31 is as follows:
First, a long sealed shallow container is used that is identical to that described in the claim 16.
Next, a compact monolayer [made up of a suitable organic material (or organic compound)] is produced in one piece [(by one of the conventional methods), floating on top of a suitable vehicle] inside a shallow tray.
Next, the said shallow tray is placed inside the said long sealed shallow container close to one end of the long corridor as mentioned in claim 16, in such a manner that the “sloped” end of the said conveyor belt system as mentioned in claim 16 (and consequently, the said outward surface of the said substrate strip) which is proximal to the said shallow tray, “dips” into the said shallow tray and positions its tip/apex at a suitable level below the said compact monolayer and inside the said vehicle.
Next, an electrostatic charge is “projected” onto the said lower surface of the said compact monolayer by a suitable method.
Next, an electrostatic charge of opposite sign to that projected onto the said lower surface of the said compact monolayer is “projected” onto the said outward surface of the said suitable substrate strip by a suitable method i.e. if the said lower surface of the said compact monolayer carries a positive electrostatic charge, then the said outward surface of the said suitable substrate strip should end up carrying a negative electrostatic charge.
Next, the said conveyor belt system (as mentioned in claim 16) is switched on which causes the said suitable substrate strip to “travel” in the direction as described in claim 16, while simultaneously the said compact monolayer is “pushed”, at a controlled rate of speed, towards the said suitable substrate strip by pushing the said encircling instrument in the direction towards the said suitable substrate strip.
As a result of the presence of the attractive electrostatic forces between the said lower surface of the said compact monolayer and the said outward surface of the said suitable substrate strip (due to the presence of the said opposite sign electrostatic charges on the above-mentioned surfaces), the said compact monolayer is attracted to, and, adhere to the said outward surface of the said suitable substrate strip.
The speed of the said pushing of the said compact monolayer towards the said suitable substrate strip, as described above, should be “controlled” to be at an “optimum magnitude”, because, if the said speed is too fast, then the said compact monolayer will scrunch and result in a multi layered organic material (or organic compound) as the said suitable substrate strip would be moving too slow relative to the said compact monolayer, conversely, if the said pushing is too slow, then the said compact monolayer will “rupture”/break, as the said suitable substrate strip would be moving too fast relative to the said compact monolayer.
Next, both the said compact monolayer and the said suitable substrate strip may be neutralized by a discharge (e.g. bleed off to ground).
The next step involves the removal of the last remnants/traces of the said suitable vehicle which might have been trapped between the said lower surface of the said compact monolayer and the said outward surface of the said suitable substrate strip, which may be achieved by using methods described in claim 29.

32: This claim is identical to claim 31, except that according to this claim, a doped compact monolayer [made up of a suitable doped organic material (or doped organic compound)] is used instead of the compact monolayer [made up of a suitable organic material (or organic compound)] used in claim 31, where the said doped compact monolayer “participates” in all the steps as described in claim 31.

33: This claim is identical to claim 30, except that according to this claim, a doped compact monolayer [made up of a suitable doped organic material (or doped organic compound)] is used instead of the compact monolayer [made up of a suitable organic material (or organic compound)] used in claim 30, where the said doped compact monolayer “participates” in all the steps as described in claim 30.

34: This claim is comprised of “projecting” an electrostatic charge (either positive or negative), by suitable method(s), onto the lower surface of a compact monolayer [made up of a suitable organic material (or organic compound)] where the latter is prepared according to a conventional method inside a shallow tray in a manner such that the said compact monolayer is “sandwiched” between 2 suitable vehicles.
The said compact monolayer possesses properties identical to those of the said compact monolayer mentioned in claim 30, and similarly, each of the said suitable vehicles possess properties identical to those of the said suitable vehicle mentioned in claim 30.

35: According to this claim, a compact monolayer [made up of a suitable organic material (or organic compound)] “sandwiched” between 2 suitable vehicles, as described in claim 34, is “persuaded” to spread/deposit on the upper surface of a suitable substrate by means of the attractive forces of electrostatic charges.
The above objective may be achieved by means of “projecting” an electrostatic charge (either positive or negative), by suitable method(s), onto the lower surface of the said compact monolayer while “projecting” an electrostatic charge of opposite sign—to that of the said electrostatic charge projected onto the said lower surface of the said compact monolayer—by suitable method(s), onto the said upper surface of the said suitable substrate.
The said compact monolayer, the said suitable substrate, the said suitable vehicles, and the shallow tray which are used in this version of the invention should have the properties identical to those of the said compact monolayer, the said suitable substrate, the said suitable vehicle, and the said shallow tray mentioned in claim 30.
The sequence of steps to prepare a compact monolayer [made up of a suitable organic material (or organic compound)] spread/deposited on the upper surface of a suitable substrate according to this claim are as follows:
First, a long sealed shallow container is used that is identical to that described in claim 15.
Next, a suitable substrate is placed at the bottom of a shallow tray (as described in claim 15).
Then, a compact monolayer [made up of a suitable organic material (or organic compound)] is produced in one piece (inside the said shallow tray) according to a conventional method in a manner such that the said compact monolayer is “sandwiched” between 2 suitable vehicles.
Next, the said shallow tray is placed on the floor, inside the said long sealed shallow container.
Next, an electrostatic charge is “projected” onto the lower surface of the said compact monolayer by suitable means.
Next, one side of the said suitable substrate is raised slightly so that the said suitable substrate is no longer completely horizontal i.e. there is now an “angle of inclination” between the “horizontal level” and the said suitable substrate.
Next, an electrostatic charge of opposite sign to that projected onto the said lower surface of the said compact monolayer is projected onto the upper surface of the said suitable substrate by suitable means i.e. if the said lower surface of the said compact monolayer carries a positive electrostatic charge, then the said upper surface of the said suitable substrate should end up carrying a negative electrostatic charge.
Next, the entire “body” of the said charged suitable substrate is raised “uniformly” in a very slow manner (in order to prevent causing ripples or “disturbing” the said charged compact monolayer) i.e. the magnitude of the said angle of inclination is kept constant throughout the said raising process of the said charged suitable substrate.
As the said charged suitable substrate rises, the said charged upper surface of the said raised side of the said charged suitable substrate comes into contact with the said oppositely charged lower surface of the said compact monolayer. As a result, the said lower surface of the said compact monolayer will be attracted to, and therefore, adhere to the said upper surface of the said raised side of the said suitable substrate, because the former and the latter carry electrostatic charges of opposite signs.
As the “gentle” raising of the said charged suitable substrate proceeds, the said charged upper surface of the said suitable substrate will progressively become “covered” with the said oppositely charged compact monolayer until all of the said upper surface of the said charged suitable substrate is “covered” with the said compact monolayer.
The end result of the above process is that the said compact monolayer will come to rest/spread/deposit directly on the said upper surface of the said suitable substrate.
Next, the said raising of the said suitable substrate is continued until the entire “body” of the said suitable substrate has moved completely out of the said vehicles and the said suitable substrate is removed from the said shallow tray.
Next, both the said compact monolayer and the said suitable substrate may be neutralized by a discharge (e.g. bleed off to ground).
The next step involves the removal of the last remnants/traces of the said vehicles which might have been trapped between the said lower surface of the said compact monolayer and the said upper surface of the said suitable substrate, which may be achieved by using methods described in claim 29.

36: According to this claim, a compact monolayer [made up of a suitable organic material (or organic compound)] “sandwiched” between 2 suitable vehicles, as described in claim 34, is “persuaded” to spread/deposit on the outward surface of a suitable substrate strip (as described in claim 16) by means of the attractive forces of electrostatic charges.
The above objective may be achieved by means of “projecting” an electrostatic charge (either positive or negative), by suitable method(s), onto the lower surface of the said compact monolayer while “projecting” an electrostatic charge of opposite sign—to that of the said electrostatic charge projected onto the said lower surface of the said compact monolayer—by suitable method(s), onto the said outward surface of the said suitable substrate strip.
The said compact monolayer, the “encircling instrument” (a non-stick filament used for pushing the outer periphery of a monolayer in order to produce a monolayer of desired “compactness”, i.e. to produce a compact monolayer), the said suitable substrate strip, the said suitable vehicles, the shallow tray, and the rollers (holding the said substrate strip in “place”) which are used in this version of the invention should have the properties identical to those of the said compact monolayer, the said encircling instrument, the said suitable substrate strip, the said suitable vehicle, the said shallow tray, and the said rollers (holding the said substrate strip in “place”) mentioned in claim 31.
The sequence of steps to prepare a compact monolayer spread/deposited on the outward surface of a suitable substrate strip according to this claim is as follows:
First, a long sealed shallow container is used that is identical to that described in the claim 16.
Next, a compact monolayer [made up of a suitable organic material (or organic compound)] is produced in one piece (inside a shallow tray) according to a conventional method in a manner such that the said compact monolayer is “sandwiched” between 2 suitable vehicles.
Next, the said shallow tray is placed on the floor, inside the said long sealed shallow container close to one end of the said long corridor as mentioned in claim 16, in such a manner that the “sloped” end of the said conveyor belt system, as mentioned in claim 16 (and consequently, the said outward surface of the said suitable substrate strip) which is proximal to the said shallow tray “dips” into the said shallow tray and positions its tip/apex at a suitable level below the said compact monolayer and inside the said suitable vehicles.
Next, an electrostatic charge is “projected” onto the lower surface of the said compact monolayer by suitable means.
Next, an electrostatic charge of opposite sign to that projected onto the said lower surface of the said compact monolayer is projected onto the said outward surface of the said suitable substrate strip by suitable means i.e. if the said lower surface of the said compact monolayer carries a positive electrostatic charge, then the said outward surface of the said suitable substrate strip should end up carrying a negative electrostatic charge.
Next, the said conveyor belt system (as mentioned in claim 16) is switched on which causes the said suitable substrate strip to “travel” in the direction as described in claim 16, while simultaneously the said compact monolayer is “pushed”, at a controlled rate of speed, towards the said suitable substrate strip by pushing the said encircling instrument (at the outer periphery of the said compact monolayer) in the direction towards the said suitable substrate strip.
As a result of the presence of the attractive electrostatic forces between the said lower surface of the said compact monolayer and the said outward surface of the said suitable substrate strip (due to the presence of the said opposite sign electrostatic charges on the above-mentioned surfaces), the said compact monolayer is attracted to, and, adhere to the said outward surface of the said substrate strip and thus is “persuaded” to spread/deposit on the said outward surface of the said substrate strip.
The speed of the said pushing of the said compact monolayer towards the said suitable substrate strip, as described above, should be “controlled” to be at an “optimum magnitude”, because, if the said speed is too fast, then the said compact monolayer will scrunch and result in a multi layered organic material (or organic compound) as the said suitable substrate strip would be moving too slow relative to the said compact monolayer, conversely, if the said pushing is too slow, then the said compact monolayer will “rupture”/break, as the said suitable substrate strip would be moving too fast relative to the said compact monolayer.
Next, both the said compact monolayer and the said suitable substrate strip may be neutralized by a discharge (e.g. bleed off to ground).
The next step involves the removal of the last remnants/traces of the said vehicles which might have been trapped between the said lower surface of the said compact monolayer and the said outward surface of the said substrate strip, which may be achieved by using methods described in claim 29.

37: According to this claim, a compact monolayer [made up of a suitable organic material (or organic compound)] floating on top of a suitable vehicle is “persuaded” to spread/deposit on the upper surface of a “temporary substrate” by means of the attractive forces of electrostatic charges.
This claim is identical to claim 30 except that in this version of the invention, a “temporary substrate” is positioned (and “held in place”) above (and in the proximity of) the said upper surface of the suitable substrate used in claim 30, by suitable means; therefore, the said suitable substrate and the said temporary substrate continue to keep their positions “unchanged” relative to one another throughout the processes involved in this version of the invention i.e. when the said suitable substrate rises, then, the said temporary substrate also rises at exactly the same rate of speed, thus keeping the distance separating them constant.
The said compact monolayer, the said suitable substrate, the said suitable vehicle, and the shallow tray which are used in this version of the invention should have the properties identical to those of the said compact monolayer, the said suitable substrate, the said suitable vehicle, and the said shallow tray mentioned in claim 30.
One of the properties of the said temporary substrate and the “materials/instruments” that keep the said temporary substrate in the proximity of the said suitable substrate used in this version of the invention is that they should not adversely interfere with the electrostatic charges carried by the other components used in this version of the invention i.e. the above-mentioned temporary substrate and the said “materials/instruments” should not cause the electrostatic charges carried by the said compact monolayer or the said suitable substrate to be “neutralized”.
Another property of the said temporary substrate is that it should be adequately thin so as to allow the “passage/penetration” of “the electrostatic forces”—carried by the said lower surface of the said compact monolayer and the said upper surface of the said suitable substrate, mentioned in claim 30—to take place effectively and efficiently across its width.
The sequence of steps according to this version of the invention is similar to those of the claim 30, as follows:
First, a long sealed shallow container is used that is identical to that described in claim 15.
Next, a suitable substrate is placed at the bottom of a shallow tray (as described in claim 15).
Next, a temporary substrate is positioned (and “held in place”) above (and in the proximity of) the upper surface of the said suitable substrate.
Next, a compact monolayer [made up of a suitable organic material (or organic compound)] is produced in one piece [(by one of the conventional methods), floating on top of a suitable vehicle] inside the said shallow tray.
Next, the said shallow tray is placed on the floor, inside the said long sealed shallow container.
Next, an electrostatic charge is “projected” onto the lower surface of the said compact monolayer by suitable means.
Next, one side of the said suitable substrate is raised slightly so that the said suitable substrate is no longer completely horizontal i.e. there is now an “angle of inclination” between the “horizontal level” and the said suitable substrate, keeping in mind that the said temporary substrate simultaneously follows exactly every move that the said suitable substrate makes.
Next, an electrostatic charge of opposite sign to that projected onto the said lower surface of the said compact monolayer is projected onto the upper surface of the said suitable substrate by suitable means i.e. if the said lower surface of the said compact monolayer carries a positive electrostatic charge, then the said upper surface of the said suitable substrate should end up carrying a negative electrostatic charge.
Next, the entire “body” of the said charged suitable substrate (and therefore the said temporary substrate) is raised “uniformly” in a very slow manner (in order to prevent causing ripples or “disturbing” the said charged compact monolayer) i.e. the magnitude of the said angle of inclination is kept constant throughout the said raising process of the said charged suitable substrate (and therefore the said raising process of the said temporary substrate).
Eventually, as the said charged suitable substrate rises, the said upper surface of the said raised side of the said temporary substrate comes into contact with the said oppositely charged lower surface of the said compact monolayer.
As the said temporary substrate does not “interfere with” the various electrostatic forces present (i.e. it allows the attractive and/or repulsive forces to pass through freely), therefore, the said lower surface of the said compact monolayer will be attracted to the said upper surface of the said raised side of the said suitable substrate, however, as the said temporary substrate is positioned between the said compact monolayer and the said suitable substrate, therefore, the said compact monolayer will adhere to the said upper surface of the said raised side of the said temporary substrate.
As the “gentle” raising of the said charged suitable substrate (and the said temporary substrate) proceeds, the said upper surface of the said temporary substrate will progressively become “covered” with the said oppositely charged compact monolayer until the entire said upper surface of the said temporary substrate is “covered” with the said compact monolayer.
Next, the said raising of the said suitable substrate (and the said temporary substrate) is continued until the entire “body” of the said suitable substrate (and the said temporary substrate) has moved completely out of the said vehicle and the said suitable substrate (and the said temporary substrate) are removed from the said shallow tray.
The end result of the above process is that the said compact monolayer has come to rest/spread/deposit directly on the said upper surface of the said temporary substrate.
Next, the said temporary substrate, with the said compact monolayer spread/deposited on its upper surface, is “detached” and “moved away” from the said suitable substrate.
Next, both the said compact monolayer and the said suitable substrate may be neutralized by a discharge (e.g. bleed off to ground).
The next step involves the removal of the last remnants/traces of the said vehicle which might have been trapped between the said lower surface of the said compact monolayer and the said upper surface of the said temporary substrate, which may be achieved by using methods described in claim 29.

38: According to this claim, a compact monolayer [made up of a suitable organic material (or organic compound)] “sandwiched” between 2 suitable vehicles as described in claim 34, is “persuaded” to spread/deposit on the upper surface of a “temporary substrate” by means of the attractive forces of electrostatic charges.
This claim is identical to claim 35 except that in this version of the invention, a “temporary substrate” is positioned (and “held in place”) above (and in the proximity of) the upper surface of the suitable substrate used in claim 35, by suitable means; therefore, the said suitable substrate and the said temporary substrate continue to keep their positions “unchanged” relative to one another throughout the processes involved in this version of the invention i.e. when the said suitable substrate rises, then, the said temporary substrate also rises at exactly the same rate of speed, thus keeping the distance separating them constant.
The said compact monolayer, the said suitable substrate, the said suitable vehicles, and the shallow tray which are used in this version of the invention should have the properties identical to those of the said compact monolayer, the said suitable substrate, the said suitable vehicles, and the said shallow tray mentioned in claim 35.
The said temporary substrate and the “materials/instruments” that keep the said temporary substrate in the proximity of the said suitable substrate used in this version of the invention should have the properties identical to those of the said temporary substrate and the said “materials/instruments” mentioned in claim 37.
The sequence of steps to prepare a compact monolayer [made up of a suitable organic material (or organic compound)] spread/deposited on the upper surface of a temporary substrate according to this claim are as follows:
First, a long sealed shallow container is used that is identical to that described in claim 15.
Next, a suitable substrate is placed at the bottom of a shallow tray (as described in claim 15).
Next, a temporary substrate is positioned (and “held in place”) above (and in the proximity of) the upper surface of the said suitable substrate.
Then, a compact monolayer [made up of a suitable organic material (or organic compound)] is produced in one piece (inside the said shallow tray, as described in claim 15) according to a conventional method in a manner such that the said compact monolayer is “sandwiched” between 2 suitable vehicles.
Next, the said shallow tray is placed on the floor, inside the said long sealed shallow container.
Next, an electrostatic charge is “projected” onto the lower surface of the said compact monolayer by suitable means.
Next, one side of the said suitable substrate is raised slightly so that the said suitable substrate is no longer completely horizontal i.e. there is now an “angle of inclination” between the “horizontal level” and the said suitable substrate, keeping in mind that the said temporary substrate simultaneously follows exactly every move that the said suitable substrate makes.
Next, an electrostatic charge of opposite sign to that projected onto the said lower surface of the said compact monolayer is projected onto the said upper surface of the said suitable substrate by suitable means i.e. if the said lower surface of the said compact monolayer carries a positive electrostatic charge, then the said upper surface of the said suitable substrate should end up carrying a negative electrostatic charge.
Next, the entire “body” of the said charged suitable substrate (and therefore the said temporary substrate) is raised “uniformly” in a very slow manner (in order to prevent causing ripples or “disturbing” the said charged compact monolayer) i.e. the magnitude of the said angle of inclination is kept constant throughout the said raising process of the said charged suitable substrate (and therefore the said raising process of the said temporary substrate).
Eventually, as the said charged suitable substrate rises, the said upper surface of the said raised side of the said temporary substrate comes into contact with the said oppositely charged lower surface of the said compact monolayer.
As the said temporary substrate does not “interfere with” the various electrostatic forces present (i.e. it allows the attractive and/or repulsive forces to pass through freely), therefore, the said lower surface of the said compact monolayer will be attracted to the said upper surface of the said raised side of the said suitable substrate, however, as the said temporary substrate is positioned between the said compact monolayer and the said suitable substrate, therefore, the said compact monolayer will adhere to the said upper surface of the said raised side of the said temporary substrate.
As the “gentle” raising of the said charged suitable substrate (and the said temporary substrate) proceeds, the said upper surface of the said temporary substrate will progressively become “covered” with the said oppositely charged compact monolayer until the entire said upper surface of the said temporary substrate is “covered” with the said compact monolayer.
Next, the said raising of the said suitable substrate (and the said temporary substrate) is continued until the entire “body” of the said suitable substrate (and the said temporary substrate) has moved completely out of the said vehicles and the said suitable substrate (and the said temporary substrate) are removed from the said shallow tray.
The end result of the above process is that the said compact monolayer has come to rest/spread/deposit directly on the said upper surface of the said temporary substrate.
Next, the said temporary substrate, with the said compact monolayer spread/deposited on its upper surface, is “detached” and “moved away” from the said suitable substrate.
Next, the said compact monolayer may be neutralized by a discharge (e.g. bleed off to ground).
The next step involves the removal of the last remnants/traces of the said vehicles which might have been trapped between the said lower surface of the said compact monolayer and the said upper surface of the said temporary substrate, which may be achieved by using methods described in claim 29.

39: According to this claim, a compact monolayer [made up of a suitable organic material (or organic compound)] floating on top of a suitable vehicle is “persuaded” to spread/deposit on the upper surface of a “temporary substrate strip” by means of the attractive forces of electrostatic charges.
This claim is identical to claim 31 except that in this version of the invention, a “temporary substrate strip” is positioned (and “held in place”) in the proximity of the outward surface of the suitable substrate strip used in claim 31, by suitable means.
The said temporary substrate strip and the said suitable substrate strip continue to keep their positions “unchanged” relative to one another throughout the processes involved in this version of the invention i.e. when the said suitable substrate strip moves (in the direction mentioned in claim 31), then, the said temporary substrate strip also moves in the same direction as the said suitable substrate strip at exactly the same rate of speed while keeping the distance separating them constant.
The said compact monolayer, the said suitable substrate strip, the said suitable vehicle, the shallow tray, the said “encircling instrument” (a non-stick filament used for pushing the outer periphery of a monolayer in order to produce a monolayer of desired “compactness”, i.e. to produce a compact monolayer), and the rollers which are used in this version of the invention should have the properties identical to those of the said compact monolayer, the said suitable substrate strip, the said suitable vehicle, the said shallow tray, the said encircling instrument, and the said rollers mentioned in claim 31.
One of the properties of the said temporary substrate strip and the “materials/instruments” that keep the said temporary substrate strip in the proximity of the said suitable substrate strip used in this version of the invention is that they should not adversely interfere with the electrostatic charges carried by the other components used in this version of the invention i.e. the above-mentioned temporary substrate strip and the said “materials/instruments” should not cause the electrostatic charges carried by the said compact monolayer or the said suitable substrate strip to be “neutralized”.
Another property of the said temporary substrate strip is that it should be adequately thin so as to allow the “passage/penetration” of “the electrostatic forces”—carried by the lower surface of the said compact monolayer and the said suitable substrate strip, mentioned in claim 31—to take place effectively and efficiently across its width.
The sequence of steps according to this version of the invention is similar to those of the claim 31, as follows:
First, a long sealed shallow container is used that is identical to that described in the claim 16.
Next, a compact monolayer [made up of a suitable organic material (or organic compound)] is produced in one piece [(by one of the conventional methods), floating on top of a suitable vehicle] inside a shallow tray.
Next, a temporary substrate strip is positioned (and “held in place”) in the proximity of the outward surface of a suitable substrate strip.
Next, the said shallow tray is placed on the floor, inside the said long sealed shallow container close to one end of the said long corridor as mentioned in claim 16, in such a manner that the “sloped” end of the said conveyor belt system, as described in the claim 16, (and consequently, the said outward surface of the said substrate strip and the said temporary substrate strip) which is proximal to the said shallow tray “dips” into the said shallow tray and positions its tip/apex at a suitable level below the said compact monolayer and inside the said suitable vehicle.
Next, an electrostatic charge is “projected” onto the lower surface of the said compact monolayer by suitable means.
Next, an electrostatic charge of opposite sign to that projected onto the said lower surface of the said compact monolayer is projected onto the said outward surface of the said suitable substrate strip by suitable means i.e. if the said lower surface of the said compact monolayer carries a positive electrostatic charge, then the said outward surface of the said suitable substrate strip should end up carrying a negative electrostatic charge.
Next, the said conveyor belt system (as mentioned in claim 16) is switched on which causes the said suitable substrate strip (and therefore the said temporary substrate strip) to “travel” in the direction as described in claim 16, while simultaneously the said compact monolayer is “pushed”, at a controlled rate of speed, towards the said temporary substrate strip by pushing the encircling instrument (at the outer periphery of the said compact monolayer) in the direction towards the said temporary substrate strip.
Eventually, the said lower surface of the said charged compact monolayer comes into contact with the said upper surface of the said temporary substrate strip; and as the said temporary substrate strip does not “interfere with” the various electrostatic forces present (i.e. it allows the attractive and/or repulsive forces to pass through freely), therefore, the said lower surface of the said compact monolayer will be attracted to the said outward surface of the said suitable substrate strip, however, as the said temporary substrate strip is positioned between the said compact monolayer and the said suitable substrate strip, therefore, the said compact monolayer will adhere to the said upper surface of the said temporary substrate strip.
The end result of the above process is that the said compact monolayer will come to rest/spread/deposit directly on the said upper surface of the said temporary substrate strip.
The speed of the said pushing of the said compact monolayer towards the said temporary substrate strip, as described above, should be “controlled” to be at an “optimum magnitude”, because, if the said speed is too fast, then the said compact monolayer will scrunch and result in a multi layered organic material (or organic compound) as the said temporary substrate strip would be moving too slow relative to the said compact monolayer, conversely, if the said pushing is too slow, then the said compact monolayer will “rupture”/break, as the said temporary substrate strip would be moving too fast relative to the said compact monolayer.
Next, the said temporary substrate strip, with the said compact monolayer spread/deposited on its upper surface, is “detached” and “moved away” from the said suitable substrate strip.
Next, the said compact monolayer spread/deposited on the said upper surface of the said temporary substrate strip may be neutralized by a discharge (e.g. bleed off to ground).
The next step involves the removal of the last remnants/traces of the said vehicle which might have been trapped between the said lower surface of the said compact monolayer and the said upper surface of the said temporary substrate strip, which may be achieved by using methods described in claim 29.

40: According to this claim, a compact monolayer [made up of a suitable organic material (or organic compound)] “sandwiched” between 2 suitable vehicles is “persuaded” to spread/deposit on the upper surface of a “temporary substrate strip” by means of the attractive forces of electrostatic charges.
This claim is identical to claim 36 except that in this version of the invention, a “temporary substrate strip” is positioned in the proximity of the outward surface of the suitable substrate strip used in claim 36, by suitable means.
The said temporary substrate strip and the said suitable substrate strip continue to keep their positions “unchanged” relative to one another throughout the processes involved in this version of the invention i.e. when the said suitable substrate strip moves (in the direction mentioned in claim 36), then, the said temporary substrate strip also moves in the same direction as the said suitable substrate strip at exactly the same rate of speed while keeping the distance separating them constant.
The said compact monolayer, the said suitable substrate strip, the said temporary substrate strip, the “materials/instruments” that keep the said temporary substrate strip in the proximity of the said suitable substrate strip, the said suitable vehicles, the shallow tray, the “encircling instrument”, and the rollers (holding the said substrate strip in “place”) which are used in this claim should have the properties identical to those of the said compact monolayer, the said suitable substrate strip, the said temporary substrate strip, the “materials/instruments” that keep the said temporary substrate strip in the proximity of the said suitable substrate strip, the said suitable vehicle, the said shallow tray, the said “encircling instrument”, and the said rollers mentioned in claim 39.
Another property of the said temporary substrate strip is that it should be adequately thin so as to allow the “passage/penetration” of “the electrostatic forces”—carried by the said lower surface of the said compact monolayer and the said suitable substrate strip, mentioned in claim 36—to take place effectively and efficiently across its width.
The sequence of steps according to this version of the invention is similar to those of the claim 36, as follows:
First, a long sealed shallow container is used that is identical to that described in the claim 16.
Next, a compact monolayer [made up of a suitable organic material (or organic compound)] is produced in one piece (inside a shallow tray) according to a conventional method in a manner such that the said compact monolayer is “sandwiched” between 2 suitable vehicles.
Next, a temporary substrate strip is positioned (and “held in place”) in the proximity of the outward surface of a suitable substrate strip.
Next, the said shallow tray is placed on the floor, inside the said long sealed shallow container close to one end of the said long corridor as mentioned in claim 16, in such a manner that the “sloped” end of the said conveyor belt system (and consequently, the said outward surface of the said substrate strip and the said temporary substrate strip) which is proximal to the said shallow tray “dips” into the said shallow tray and positions its tip/apex at a suitable level below the said compact monolayer and inside the said suitable vehicles.
Next, an electrostatic charge is “projected” onto the lower surface of the said compact monolayer by suitable means.
Next, an electrostatic charge of opposite sign to that projected onto the said lower surface of the said compact monolayer is projected onto the said outward surface of the said suitable substrate strip by suitable means i.e. if the said lower surface of the said compact monolayer carries a positive electrostatic charge, then the said outward surface of the said suitable substrate strip should end up carrying a negative electrostatic charge.
Next, the said conveyor belt system (as mentioned in claim 16) is switched on which causes the said suitable substrate strip (and therefore the said temporary substrate strip) to “travel” in the direction as described in claim 16, while simultaneously the said compact monolayer is “pushed”, at a controlled rate of speed, towards the said temporary substrate strip by pushing the encircling instrument (at the outer periphery of the said compact monolayer) in the direction towards the said temporary substrate strip.
Eventually, the said lower surface of the said charged compact monolayer comes into contact with the said upper surface of the said temporary substrate strip; and as the said temporary substrate strip does not “interfere with” the various electrostatic forces present (i.e. it allows the attractive and/or repulsive forces to pass through freely), therefore, the said lower surface of the said compact monolayer will be attracted to the said outward surface of the said suitable substrate strip, however, as the said temporary substrate strip is positioned between the said compact monolayer and the said suitable substrate strip, therefore, the said compact monolayer will adhere to the said upper surface of the said temporary substrate strip.
The end result of the above process is that the said compact monolayer will come to rest/spread/deposit directly on the said upper surface of the said temporary substrate strip.
The speed of the said pushing of the said compact monolayer towards the said temporary substrate strip, as described above, should be “controlled” to be at an “optimum magnitude”, because, if the said speed is too fast, then the said compact monolayer will scrunch and result in a multi layered organic material (or organic compound) as the said temporary substrate strip would be moving too slow relative to the said compact monolayer, conversely, if the said pushing is too slow, then the said compact monolayer will “rupture”/break, as the said temporary substrate strip would be moving too fast relative to the said compact monolayer.
Next, the said temporary substrate strip, with the said compact monolayer spread/deposited on its upper surface, is “detached” and “moved away” from the said suitable substrate strip.
Next, both the said compact monolayer and the said suitable substrate strip may be neutralized by a discharge (e.g. bleed off to ground).
The next step involves the removal of the last remnants/traces of the said vehicles which might have been trapped between the said lower surface of the said compact monolayer and the said upper surface of the said temporary substrate strip, which may be achieved by using methods described in claim 29.

41: According to this claim, an electrostatically charged compact monolayer [made up of a suitable organic material (or organic compound)] spread/deposited directly on the surface of a temporary substrate, as described in claim 37 (or a temporary substrate strip as described in claim 40), is “persuaded” to spread/deposit on the upper surface of a suitable substrate by means of the attractive forces of electrostatic charges.
One of the properties of the said suitable substrate is that it allows the “passage/penetration” of “electrostatic forces”—carried by the said compact monolayer and a charged pane (see below)—to take place effectively and efficiently across its width.
The sequence of steps according to this version of the invention is as follows:
First, the said surface of the said temporary substrate with the said charged compact monolayer is “brought into contact” with the “upper surface” of a suitable substrate.
Next, a pane which “carries” an electrostatic charge opposite to that “carried by” the said charged compact monolayer is positioned in the proximity of the “lower surface” of the said suitable substrate in a manner such that the said suitable substrate is “sandwiched” between the said charged compact monolayer and the said oppositely charged pane.
Next, the said charged compact monolayer “attaches” itself to the said upper surface of the said suitable substrate due to the electrostatic attraction between the said oppositely charged compact monolayer and the said pane (as the said suitable substrate allows the “passage/penetration” of “electrostatic forces” to take place effectively and efficiently across its width).
As a result, the said compact monolayer will spread/deposit on the upper surface of the said suitable substrate.

42: According to this claim, a compact monolayer [made up of a suitable organic material (or organic compound)] floating on top of a suitable vehicle is “persuaded” to spread/deposit on the upper surface of a suitable substrate by means of “magnetic attraction forces”.
The said compact monolayer used in this version of the invention is made up of a suitable organic material (or organic compound) which contains ferromagnetic and/or paramagnetic materials within its chemical makeup/composition.
The said suitable substrate used in this version of the invention is a magnet (a permanent magnet or a temporary magnet/electromagnet where an electric current is used).
The sequence of steps to prepare a compact monolayer spread/deposited on the upper surface of a suitable substrate according to this claim is as follows:
First, a long sealed shallow container is used that is identical to that described in claim 15.
Then, a suitable substrate, having the above-mentioned property of being a permanent or a temporary magnet, is placed at the bottom of a shallow tray (as described in claim 15).
Then, a compact monolayer [made up of a suitable organic material (or organic compound)], which contains ferromagnetic and/or paramagnetic materials within its chemical makeup/composition, as described above, is produced in one piece [(by one of the conventional methods), floating on top of a suitable vehicle] inside the said shallow tray.
Next, the said shallow tray is placed on the floor, inside the said long sealed shallow container.
As this version of the invention requires that the said suitable substrate acts as a magnet, thus this next step is applicable if the said suitable substrate is a temporary magnet, in which case, the said suitable substrate is “converted” so as to behave as a magnet e.g. the electric current which converts the said suitable substrate into a magnet is “switched on”, thus the said suitable substrate will behave as a magnet for as long as the said electric current is “flowing”; or alternatively, a second magnet is brought into the proximity of the said suitable substrate in a manner such that the latter is positioned “within” the magnetic field of the said second magnet, therefore the said suitable substrate will behave as a magnet for as long as the said suitable substrate remains in the said magnetic field of the said second magnet. The said second magnet is allowed to “hold” its position relative to the said suitable substrate, by suitable means, through most of the processes according to this claim i.e. as the said suitable substrate moves, then, the said second magnet also “moves along with” the said suitable substrate.
Next, one side of the said suitable substrate is raised slightly so that the said suitable substrate is no longer completely horizontal i.e. there is now an “angle of inclination” between the “horizontal level” and the said suitable substrate.
Next, the entire “body” of the said suitable substrate is raised “uniformly” in a very slow manner—in order to prevent causing ripples or “disturbing” the said compact monolayer—i.e. the magnitude of the said angle of inclination is kept constant throughout the said raising process of the said suitable substrate.
As the said suitable substrate rises, the said upper surface of the said raised side of the said suitable substrate “breaks through” the surface of the liquid inside the said shallow tray—i.e. the said vehicle and the said compact monolayer—thus the said lower surface of the said compact monolayer comes into contact with the said upper surface of the said raised side of the said suitable substrate. As a result, the said lower surface of the said compact monolayer, which contains ferromagnetic and/or paramagnetic materials within its chemical makeup/composition, as described above, will be attracted to, and therefore, adhere to the said upper surface of the said raised side of the said suitable substrate, because the former will be attracted to the latter due to the presence of the said magnetic attraction forces.
As the “gentle” raising of the said suitable substrate proceeds, the said upper surface of the said suitable substrate will progressively become “covered” with the said compact monolayer until the entire “body” of the said suitable substrate is raised above the said liquid inside the said shallow tray—i.e. above the said vehicle and the said compact monolayer. The end result of the above process is that the said compact monolayer will come to rest/spread/deposit directly on the said upper surface of the said suitable substrate.
This next step is applicable if the said suitable substrate is a temporary magnet, in which case, the said suitable substrate is “reverted” back to its “original state” of ceasing to behave as a temporary magnet e.g. the electric current which converted the said suitable substrate into a magnet is “switched off”, thus the said suitable substrate will cease to behave as a magnet; alternatively, if a second magnet was used (as described above), then the said second magnet is removed from the proximity of the said suitable substrate, therefore the said suitable substrate will cease to behave as a magnet.
Next, if desired the said compact monolayer, which contains ferromagnetic and/or paramagnetic materials within its chemical makeup/composition, as described above, may undergo suitable chemical reactions in order to “remove” the said ferromagnetic and/or paramagnetic material from the chemical makeup/composition of the said compact monolayer.
The next step involves the removal of the last remnants/traces of the said vehicle which might have been trapped between the said lower surface of the said compact monolayer and the said upper surface of the said suitable substrate, which may be achieved by using methods described in claim 29.

43: According to this claim, a compact monolayer [made up of a suitable organic material (or organic compound)] floating on top of a suitable vehicle is “persuaded” to spread/deposit on the upper surface of a “temporary substrate” by means of “magnetic attraction forces”.
The said compact monolayer used in this version of the invention is made up of a suitable organic material (or organic compound) which contains ferromagnetic and/or paramagnetic materials within its chemical makeup/composition.
This claim is identical to claim 42 except that in this version of the invention, a “temporary substrate” is positioned (and “held in place”) above (and in the proximity of) the upper surface of the suitable substrate used in claim 42, by suitable means; therefore, the said suitable substrate and the said temporary substrate continue to keep their positions “unchanged” relative to one another throughout the processes involved in this version of the invention i.e. when the said suitable substrate rises, then, the said temporary substrate also rises at exactly the same rate of speed, thus keeping the distance separating them constant.
One of the properties of the said temporary substrate is that it should be adequately thin so as to allow the “passage/penetration” of the magnetic field “possessed/produced” by the said suitable substrate, according to claim 42, to take place effectively and efficiently across its width.
The sequence of steps according to this version of the invention is similar to those of the claim 42, as follows:
First, a long sealed shallow container is used that is identical to that described in claim 15.
Then, a suitable substrate, having the above-mentioned property of being a permanent or a temporary magnet, is placed at the bottom of a shallow tray (as described in claim 15).
Next, a temporary substrate is positioned (and “held in place”) above (and in the proximity of) the upper surface of the said suitable substrate.
Then, a compact monolayer [made up of a suitable organic material (or organic compound)], which contains ferromagnetic and/or paramagnetic materials within its chemical makeup/composition, as described above, is produced in one piece [(by one of the conventional methods), floating on top of a suitable vehicle] inside the said shallow tray.
Next, the said shallow tray is placed on the floor, inside the said long sealed shallow container.
As this version of the invention requires that the said suitable substrate acts as a magnet, thus this next step is applicable if the said suitable substrate is a temporary magnet, in which case, the said suitable substrate is “converted” so as to behave as a magnet e.g. the electric current which converts the said suitable substrate into a magnet is “switched on”, thus the said suitable substrate will behave as a magnet for as long as the said electric current is “flowing”; or alternatively, a second magnet is brought into the proximity of the said suitable substrate in a manner such that the latter is positioned “within” the magnetic field of the said second magnet, therefore the said suitable substrate will behave as a magnet for as long as the said suitable substrate remains in the said magnetic field of the said second magnet. The said second magnet is allowed to “hold” its position relative to the said suitable substrate, by suitable means, through most of the processes according to this claim i.e. as the said suitable substrate moves, then, the said second magnet also “moves along with” the said suitable substrate.
Next, one side of the said suitable substrate is raised slightly so that the said suitable substrate is no longer completely horizontal i.e. there is now an “angle of inclination” between the “horizontal level” and the said suitable substrate, keeping in mind that the said temporary substrate simultaneously follows exactly every move that the said suitable substrate makes.
Next, the entire “body” of the said suitable substrate (and therefore the said temporary substrate) is raised “uniformly” in a very slow manner—in order to prevent causing ripples or “disturbing” the said compact monolayer—i.e. the magnitude of the said angle of inclination is kept constant throughout the said raising process of the said suitable substrate (and therefore the said raising process of the said temporary substrate).
As the said suitable substrate rises, the said upper surface of the said raised side of the said temporary substrate comes into contact with the said lower surface of the said compact monolayer.
As the said temporary substrate does not “interfere with” the magnetic attraction forces present (i.e. it allows the attractive forces to pass through freely), therefore, the said lower surface of the said compact monolayer, which contains ferromagnetic and/or paramagnetic materials within its chemical makeup/composition, as described above, will be attracted to the said upper surface of the said raised side of said suitable substrate, however, as the said temporary substrate is positioned between the said compact monolayer and the said suitable substrate, therefore, the said compact monolayer will adhere to the said upper surface of the said raised side of said temporary substrate.
As the “gentle” raising of the said suitable substrate (and the said temporary substrate) proceeds, the said upper surface of the said temporary substrate will progressively become “covered” with the said compact monolayer until the entire said upper surface of the said temporary substrate is “covered” with the said compact monolayer.
Next, the said raising of the said suitable substrate (and the said temporary substrate) is continued until the entire “body” of the said suitable substrate (and the said temporary substrate) has moved completely out of the said vehicle and the said suitable substrate (and the said temporary substrate) are removed from the said shallow tray.
The end result of the above process is that the said compact monolayer has come to rest/spread/deposit directly on the said upper surface of the said temporary substrate.
Next, the said temporary substrate, with the said compact monolayer spread/deposited on its upper surface, is “detached” and “moved away” from the said suitable substrate.
Next, if desired, the said compact monolayer, which contains ferromagnetic and/or paramagnetic materials within its chemical makeup/composition, as described above, may undergo suitable chemical reactions in order to “remove” the said ferromagnetic and/or paramagnetic material from the chemical makeup/composition of the said ferromagnetic and/or paramagnetic compact monolayer.
The next step involves the removal of the last remnants/traces of the said vehicle which might have been trapped between the said lower surface of the said compact monolayer and the said upper surface of the said temporary substrate, which may be achieved by using methods described in claim 29.

44: According to this claim, a compact monolayer [made up of a suitable organic material (or organic compound)] floating on top of a suitable vehicle is “persuaded” to spread/deposit on the outward surface of a suitable substrate strip (as described in claim 16) by means of “magnetic attraction forces”.
The said compact monolayer used in this version of the invention is made up of a suitable organic material (or organic compound) which contains ferromagnetic and/or paramagnetic materials within its chemical makeup/composition.
The said suitable substrate strip used in this version of the invention is a magnet (a permanent magnet or a temporary magnet/electromagnet where an electric current is used).
The sequence of steps to prepare a compact monolayer [made up of a suitable organic material (or organic compound)] spread/deposited on the outward surface of a suitable substrate strip according to this claim is as follows:
First, a long sealed shallow container is used that is identical to that described in the claim 16.
Next, a compact monolayer [made up of a suitable organic material (or organic compound)], which contains ferromagnetic and/or paramagnetic materials within its chemical makeup/composition, as described above, is produced in one piece [(by one of the conventional methods), floating on top of a suitable vehicle] inside a shallow tray.
Next, the said shallow tray is placed on the floor, inside the said long sealed shallow container close to one end of the said long corridor as mentioned in claim 16, in such a manner that the “sloped” end of the said conveyor belt system as mentioned in claim 16 (and consequently, the said outward surface of the said suitable substrate strip) which is proximal to the said shallow tray “dips” into the said shallow tray and positions its tip/apex at a suitable level below the said compact monolayer and inside the said vehicle.
As this version of the invention requires that the said suitable substrate strip acts as a magnet, thus this next step is applicable if the said suitable substrate strip is a temporary magnet, in which case, the said suitable substrate strip is “converted” so as to behave as a magnet e.g. the electric current which converts the said suitable substrate strip into a magnet is “switched on”, thus the said suitable substrate strip will behave as a magnet for as long as the said electric current is “flowing”; or alternatively, a second magnet is brought into the proximity of the said suitable substrate strip in a manner such that the latter is positioned “within” the magnetic field of the said second magnet, therefore the said suitable substrate strip will behave as a magnet for as long as the said suitable substrate strip remains in the said magnetic field of the said second magnet.
Next, the said conveyor belt system (as mentioned in claim 16) is switched on which causes the said suitable substrate strip to “travel” in the direction as described in claim 16, while simultaneously the said compact monolayer is “pushed”, at a controlled rate of speed, towards the said suitable substrate strip by pushing the “encircling instrument” (a non-stick filament used for pushing the outer periphery of a monolayer in order to produce a monolayer of desired “compactness”, i.e. to produce a compact monolayer)—in the direction towards the said suitable substrate strip.
As a result of the presence of the magnetic attraction forces, the said compact monolayer, which contains ferromagnetic and/or paramagnetic materials within its chemical makeup/composition, as described above, is attracted to, and, adhere to the said outward surface of the said suitable substrate strip.
The end result of the above process is that the said compact monolayer will come to rest/spread/deposit directly on the said outward surface of the said suitable substrate strip.
The speed of the said pushing of the said compact monolayer towards the said suitable substrate strip, as described above, should be “controlled” to be at an “optimum magnitude”, because, if the said speed is too fast, then the said compact monolayer will scrunch and result in a multi layered organic material (or organic compound) as the said suitable substrate strip would be moving too slow relative to the said compact monolayer, conversely, if the said pushing is too slow, then the said compact monolayer will “rupture”/break, as the said suitable substrate strip would be moving too fast relative to the said compact monolayer.
This next step is applicable if the said suitable substrate strip is a temporary magnet, in which case, the said suitable substrate strip is “reverted” back to its “original state” of ceasing to behave as a temporary magnet e.g. the electric current which converted the said suitable substrate strip into a magnet is “switched off”, thus the said suitable substrate strip will cease to behave as a magnet; alternatively, if a second magnet was used (as described above), then the said second magnet is removed from the proximity of the said suitable substrate strip, therefore the said suitable substrate strip will cease to behave as a magnet.
Next, if desired, the said compact monolayer, which contains ferromagnetic and/or paramagnetic materials within its chemical makeup/composition, as described above, may undergo suitable chemical reactions in order to “remove” the said ferromagnetic and/or paramagnetic material from the chemical makeup/composition of the said compact monolayer.
The next step involves the removal of the last remnants/traces of the said vehicle which might have been trapped between the said lower surface of the said compact monolayer and the said outward surface of the said suitable substrate strip, which may be achieved by using methods described in claim 29.

45: According to this claim, a compact monolayer [made up of a suitable organic material (or organic compound)] floating on top of a suitable vehicle is “persuaded” to spread/deposit on the upper surface of a “temporary substrate strip” by means of “magnetic attraction forces”.
The said compact monolayer used in this version of the invention is made up of a suitable organic material (or organic compound) which contains ferromagnetic and/or paramagnetic materials within its chemical makeup/composition.
This claim is identical to claim 44 except that in this version of the invention, a “temporary substrate strip” is positioned (and “held in place”) in the proximity of the outward surface of the suitable substrate strip used in claim 44, by suitable means.
The said temporary substrate strip and the said suitable substrate strip continue to keep their positions “unchanged” relative to one another throughout the processes involved in this version of the invention i.e. when the said suitable substrate strip moves (in the direction mentioned in claim 31), then, the said temporary substrate strip also moves in the same direction as the said suitable substrate strip at exactly the same rate of speed while keeping the distance separating them constant.
One of the properties of the said temporary substrate strip is that it should be adequately thin so as to allow the “passage/penetration” of the magnetic field “possessed/produced” by the said suitable substrate strip, according to claim 44, to take place effectively and efficiently across its width.
The sequence of steps according to this version of the invention is similar to those of the claim 44, as follows:
First, a long sealed shallow container is used that is identical to that described in the claim 16.
Next, a compact monolayer [made up of a suitable organic material (or organic compound)], which contains ferromagnetic and/or paramagnetic materials within its chemical makeup/composition, as described above, is produced in one piece [(by one of the conventional methods), floating on top of a suitable vehicle] inside shallow a tray.
Next, a temporary substrate strip is positioned (and “held in place”) in the proximity of the outward surface of a suitable substrate strip.
Next, the said shallow tray is placed on the floor, inside the said long sealed shallow container close to one end of the said long corridor as mentioned in claim 16, in such a manner that the “sloped” end of the said conveyor belt system (and consequently, the said outward surface of the said suitable substrate strip and the said temporary substrate strip) which is proximal to the said shallow tray “dips” into the said shallow tray and positions its tip/apex at a suitable level below the said compact monolayer and inside the said suitable vehicle.
As this version of the invention requires that the said suitable substrate strip acts as a magnet, thus this next step is applicable if the said suitable substrate strip is a temporary magnet, in which case, the said suitable substrate strip is “converted” so as to behave as a magnet e.g. the electric current which converts the said suitable substrate strip into a magnet is “switched on”, thus the said suitable substrate strip will behave as a magnet for as long as the said electric current is “flowing”; or alternatively, a second magnet is brought into the proximity of the said suitable substrate strip in a manner such that the latter is positioned “within” the magnetic field of the said second magnet, therefore the said suitable substrate strip will behave as a magnet for as long as the said suitable substrate strip remains in the said magnetic field of the said second magnet.
Next, the said conveyor belt system (as mentioned in claim 16) is switched on which causes the said substrate strip (and therefore the said temporary substrate strip) to “travel” in the direction as described in claim 16, while simultaneously the said compact monolayer is “pushed”, at a controlled rate of speed, towards the said temporary substrate strip by pushing the “encircling instrument” (a non-stick filament used for pushing the outer periphery of a monolayer in order to produce a monolayer of desired “compactness”, i.e. to produce a compact monolayer)—in the direction towards the said temporary substrate strip.
Eventually, the said lower surface of the said compact monolayer comes into contact with the upper surface of the said temporary substrate strip; and as the said temporary substrate strip does not “interfere with” the magnetic attraction forces present (i.e. it allows the attractive forces to pass through freely), therefore, the said lower surface of the said compact monolayer, which contains ferromagnetic and/or paramagnetic materials within its chemical makeup/composition, will be attracted to the said outward surface of the said suitable substrate strip, however, as the said temporary substrate strip is positioned between the said compact monolayer and the said suitable substrate strip, therefore, the said compact monolayer will adhere to the said upper surface of the said temporary substrate strip.
The end result of the above process is that the said compact monolayer will come to rest/spread/deposit directly on the said upper surface of the said temporary substrate strip.
The speed of the said pushing of the said compact monolayer towards the said temporary substrate strip, as described above, should be “controlled” to be at an “optimum magnitude”, because, if the said speed is too fast, then the said compact monolayer will scrunch and result in a multi layered organic material (or organic compound) as the said temporary substrate strip would be moving too slow relative to the said compact monolayer, conversely, if the said pushing is too slow, then the said compact monolayer will “rupture”/break, as the said temporary substrate strip would be moving too fast relative to the said compact monolayer.
Next, the said temporary substrate strip, with the said compact monolayer spread/deposited on its upper surface, is “detached” and “moved away” from the said suitable substrate strip.
Next, if desired, the said compact monolayer, which contains ferromagnetic and/or paramagnetic materials within its chemical makeup/composition, may undergo suitable chemical reactions in order to “remove” the said ferromagnetic and/or paramagnetic material from the chemical makeup/composition of the said ferromagnetic and/or paramagnetic compact monolayer.
The next step involves the removal of the last remnants/traces of the said vehicle which might have been trapped between the said lower surface of the said compact monolayer and the said upper surface of the said temporary substrate strip, which may be achieved by using methods described in claim 29.

46: According to this claim, a compact monolayer [made up of a suitable organic material (or organic compound)] floating on top of a suitable vehicle is “persuaded” to spread/deposit on the upper surface of a suitable substrate by means of “magnetic repulsive forces”.
The said compact monolayer used in this version of the invention is made up of a suitable organic material (or organic compound) which contains diamagnetic materials within its chemical makeup/composition.
The sequence of steps to prepare a compact monolayer [made up of a suitable organic material (or organic compound)] spread/deposited on the upper surface of a suitable substrate according to this claim is as follows:
First, a long sealed shallow container is used that is identical to that described in claim 15.
Then, a suitable substrate is placed at the bottom of a shallow tray (as described in claim 15.
Then, a compact monolayer [made up of a suitable organic material (or organic compound)], which contains diamagnetic materials within its chemical makeup/composition, is produced in one piece [(by one of the conventional methods), floating on top of a suitable vehicle] inside the said shallow tray.
Next, the said shallow tray is placed on the floor, inside the said long sealed shallow container.
Next, a “suitably strong” magnet is positioned (and “held in place”) above (and in the proximity of) the upper surface of the said compact monolayer. The said magnet may be a permanent magnet or a temporary magnet/electromagnet where an electric current is used—if the said magnet used in this invention is a temporary magnet, then the latter is “converted” so as to behave as a magnet i.e. the electric current which converts the said temporary magnet/electromagnet into a magnet is “switched on”, thus the said temporary magnet/electromagnet will behave as a magnet for as long as the said electric current is “flowing”.
Next, one side of the said suitable substrate is raised slightly so that the said suitable substrate is no longer completely horizontal i.e. there is now an “angle of inclination” between the “horizontal level” and the said suitable substrate.
Next, the entire “body” of the said suitable substrate is raised “uniformly” in a very slow manner—in order to prevent causing ripples or “disturbing” the said compact monolayer—i.e. the magnitude of the said angle of inclination is kept constant throughout the said raising process of the said suitable substrate; while simultaneously, if the said magnet used in this invention is a temporary magnet, then the latter is “converted” so as to behave as a magnet i.e. the electric current which converts the said suitable substrate (temporary magnet) into a magnet is “switched on”, thus the said suitable substrate (temporary magnet) will behave as a magnet for as long as the said electric current is “flowing”.
Eventually, as the said suitable substrate rises, the said upper surface of the said raised side of the said suitable substrate “breaks through” the surface of the liquid inside the said shallow tray—i.e. the said vehicle and the said compact monolayer—thus the lower surface of the said compact monolayer comes into contact with the said upper surface of the said raised side of the said suitable substrate.
Due to the presence of the magnetic field produced by the said magnet, the said diamagnetic compact monolayer, which contains diamagnetic materials within its chemical makeup/composition, is “pushed away” from the said magnet, and thus, the said compact monolayer is “pushed” towards the said upper surface of the said suitable substrate; as a result, the said compact monolayer is “persuaded” to rest/spread/deposit directly on the said upper surface of the said suitable substrate.
As the “gentle” raising of the said suitable substrate proceeds, the said upper surface of the said suitable substrate will progressively become “covered” with the said compact monolayer until the entire “body” of the said suitable substrate is raised above the said liquid inside the said shallow tray—i.e. above the said vehicle and the said compact monolayer. The end result of the above process is that the said compact monolayer will come to rest/spread/deposit directly on the said upper surface of the said suitable substrate.
Next, if desired, the said compact monolayer, which contains diamagnetic materials within its chemical makeup/composition, may undergo suitable chemical reactions in order to “remove” the said diamagnetic material from the chemical makeup/composition of the said diamagnetic compact monolayer.
The next step involves the removal of the last remnants/traces of the said vehicle which might have been trapped between the said lower surface of the said compact monolayer and the said upper surface of the said suitable substrate, which may be achieved by using methods described in claim 29.

47: According to this claim, a compact monolayer [made up of a suitable organic material (or organic compound)] floating on top of a suitable vehicle is “persuaded” to spread/deposit on the outward surface of a suitable substrate strip (as described in claim 16) by means of “magnetic repulsive forces”.
The said compact monolayer used in this version of the invention is made up of a suitable organic material (or organic compound) which contains diamagnetic materials within its chemical makeup/composition.
The sequence of steps to prepare a compact monolayer [made up of a suitable organic material (or organic compound)] spread/deposited on the outward surface of a suitable substrate strip according to this claim is as follows:
First, a long sealed shallow container is used that is identical to that described in the claim 16.
Next, a compact monolayer [made up of a suitable organic material (or organic compound)], which contains diamagnetic materials within its chemical makeup/composition, is produced in one piece [(by one of the conventional methods), floating on top of a suitable vehicle] inside a shallow tray.
Next, the said shallow tray is placed on the floor, inside the said long sealed shallow container close to one end of the said long corridor as mentioned in claim 16, in such a manner that the “sloped” end of the said conveyor belt system (and consequently, the said outward surface of the said suitable substrate strip) which is proximal to the said shallow tray “dips” into the said shallow tray and positions its tip/apex at a suitable level below the said compact monolayer and inside the said vehicle.
Next, a “suitably strong” magnet is positioned (and “held in place”) above (and in the proximity of) the upper surface of the said compact monolayer. The said magnet may be a permanent magnet or a temporary magnet/electromagnet where an electric current is used—if the said magnet used in this invention is a temporary magnet, then the latter is “converted” so as to behave as a magnet i.e. the electric current which converts the said temporary magnet/electromagnet into a magnet is “switched on”, thus the said temporary magnet/electromagnet will behave as a magnet for as long as the said electric current is “flowing”.
Next, the said conveyor belt system (as mentioned in claim 16) is switched on which causes the said suitable substrate strip to “travel” in the direction as described in claim 16, while simultaneously the said compact monolayer is “pushed”, at a controlled rate of speed, towards the said suitable substrate strip by pushing the “encircling instrument” (a non-stick filament used for pushing the outer periphery of a monolayer in order to produce a monolayer of desired “compactness”, i.e. to produce a compact monolayer) in the direction towards the said suitable substrate strip.
Eventually, the lower surface of the said compact monolayer comes into contact with the said outward surface of the said suitable substrate strip.
Due to the presence of the magnetic field produced by the said magnet, the said diamagnetic compact monolayer, which contains diamagnetic materials within its chemical makeup/composition, is “pushed away” from the said magnet, and thus, the said compact monolayer is “pushed” towards the said outward surface of the said suitable substrate strip; as a result, the said compact monolayer is “persuaded” to rest/spread/deposit directly on the said outward surface of the said suitable substrate strip.
The speed of the said pushing of the said compact monolayer towards the said suitable substrate strip, as described above, should be “controlled” to be at an “optimum magnitude”, because, if the said speed is too fast, then the said compact monolayer will scrunch and result in a multi layered organic material (or organic compound) as the said suitable substrate strip would be moving too slow relative to the said compact monolayer, conversely, if the said pushing is too slow, then the said compact monolayer will “rupture”/break, as the said suitable substrate strip would be moving too fast relative to the said compact monolayer.
Next, if desired, the said compact monolayer, which contains diamagnetic materials within its chemical makeup/composition, may undergo suitable chemical reactions in order to “remove” the said diamagnetic material from the chemical makeup/composition of the said diamagnetic compact monolayer.
The next step involves the removal of the last remnants/traces of the said vehicle which might have been trapped between the said lower surface of the said compact monolayer and the said outward surface of the said suitable substrate strip, which may be achieved by using methods described in claim 29.

48: According to this claim, a compact monolayer [made up of a suitable organic material (or organic compound)] “sandwiched” between 2 suitable vehicles is “persuaded” to spread/deposit on the upper surface of a suitable substrate by means of “magnetic attraction forces”.
The said compact monolayer used in this version of the invention is made up of a suitable organic material (or organic compound) which contains ferromagnetic and/or paramagnetic materials within its chemical makeup/composition.
The said suitable substrate used in this version of the invention is a magnet (a permanent magnet or a temporary magnet/electromagnet where an electric current is used).
The sequence of steps to prepare a compact monolayer spread/deposited on the upper surface of a suitable substrate according to this claim is as follows:
First, a long sealed shallow container is used that is identical to that described in claim 15.
Then, a suitable substrate, having the above-mentioned property of being a permanent or a temporary magnet, is placed at the bottom of a shallow tray (as described in claim 15).
Then, a compact monolayer [made up of a suitable organic material (or organic compound)], which contains ferromagnetic and/or paramagnetic materials within its chemical makeup/composition, is produced in one piece (inside the said shallow tray) according to a conventional method in a manner such that the said compact monolayer is “sandwiched” between 2 suitable vehicles.
Next, the said shallow tray is placed on the floor, inside the said long sealed shallow container.
As this version of the invention requires that the said suitable substrate acts as a magnet, thus this next step is applicable if the said suitable substrate is a temporary magnet, in which case, the said suitable substrate is “converted” so as to behave as a magnet e.g. the electric current which converts the said suitable substrate into a magnet is “switched on”, thus the said suitable substrate will behave as a magnet for as long as the said electric current is “flowing”; or alternatively, a second magnet is brought into the proximity of the said suitable substrate in a manner such that the latter is positioned “within” the magnetic field of the said second magnet, therefore the said suitable substrate will behave as a magnet for as long as the said suitable substrate remains in the said magnetic field of the said second magnet. The said second magnet is allowed to “hold” its position relative to the said suitable substrate, by suitable means, through most of the processes according to this claim i.e. as the said suitable substrate moves, then, the said second magnet also “moves along with” the said suitable substrate.
Next, one side of the said suitable substrate is raised slightly so that the said suitable substrate is no longer completely horizontal i.e. there is now an “angle of inclination” between the “horizontal level” and the said suitable substrate.
Next, the entire “body” of the said suitable substrate is raised “uniformly” in a very slow manner—in order to prevent causing ripples or “disturbing” the said compact monolayer—i.e. the magnitude of the said angle of inclination is kept constant throughout the said raising process of the said suitable substrate.
Eventually, as the said suitable substrate rises, the said upper surface of the said raised side of the said suitable substrate comes into contact with the lower surface of the said compact monolayer. As a result, the said lower surface of the said compact monolayer, which contains ferromagnetic and/or paramagnetic materials within its chemical makeup/composition, will be attracted to, and therefore, adhere to the said upper surface of the said raised side of the said suitable substrate, because the former will be attracted to the latter due to the presence of the said magnetic attraction forces.
As the “gentle” raising of the said suitable substrate proceeds, the said upper surface of the said suitable substrate will progressively become “covered” with the said compact monolayer until the entire “body” of the said suitable substrate is raised above the said liquid inside the said shallow tray—i.e. above the said vehicles and the said compact monolayer. The end result of the above process is that the said compact monolayer will come to rest/spread/deposit directly on the said upper surface of the said suitable substrate.
This next step is applicable if the said suitable substrate is a temporary magnet, in which case, the said suitable substrate is “reverted” back to its “original state” of ceasing to behave as a temporary magnet e.g. the electric current which converted the said suitable substrate into a magnet is “switched off”, thus the said suitable substrate will cease to behave as a magnet; alternatively, if a second magnet was used (as described above), then the said second magnet is removed from the proximity of the said suitable substrate, therefore the said suitable substrate will cease to behave as a magnet.
Next, if desired, the said compact monolayer, which contains ferromagnetic and/or paramagnetic materials within its chemical makeup/composition, may undergo suitable chemical reactions in order to “remove” the said ferromagnetic and/or paramagnetic material from the chemical makeup/composition of the said ferromagnetic and/or paramagnetic compact monolayer.
The next step involves the removal of the last remnants/traces of the said vehicles which might have been trapped between the said lower surface of the said compact monolayer and the said upper surface of the said suitable substrate, which may be achieved by using methods described in claim 29.

49: According to this claim, a compact monolayer [made up of a suitable organic material (or organic compound)] “sandwiched” between 2 suitable vehicles, as described in claim 34, is “persuaded” to spread/deposit on the upper surface of a “temporary substrate” by means of “magnetic attraction forces”.
The said compact monolayer used in this version of the invention is made up of a suitable organic material (or organic compound) which contains ferromagnetic and/or paramagnetic materials within its chemical makeup/composition.
This claim is identical to claim 48 except that in this version of the invention, a “temporary substrate” is positioned (and “held in place”) above (and in the proximity of) the upper surface of the suitable substrate used in claim 48, by suitable means; therefore, the said suitable substrate and the said temporary substrate continue to keep their positions “unchanged” relative to one another throughout the processes involved in this version of the invention i.e. when the said suitable substrate rises, then, the said temporary substrate also rises at exactly the same rate of speed, thus keeping the distance separating them constant.
One of the properties of the said temporary substrate is that it should be adequately thin so as to allow the “passage/penetration” of the magnetic field “possessed/produced” by the said suitable substrate, according to claim 48, to take place effectively and efficiently across its width.
The sequence of steps according to this version of the invention is similar to those of the claim 48, as follows:
First, a long sealed shallow container is used that is identical to that described in claim 15.
Then, a suitable substrate, having the above-mentioned property of being a permanent or a temporary magnet, is placed at the bottom of a shallow tray (as described in claim 15).
Next, a temporary substrate is positioned (and “held in place”) above (and in the proximity of) the upper surface of the said suitable substrate.
Then, a compact monolayer [made up of a suitable organic material (or organic compound)], which contains ferromagnetic and/or paramagnetic materials within its chemical makeup/composition, is produced in one piece (inside the said shallow tray) according to a conventional method in a manner such that the said compact monolayer is “sandwiched” between 2 suitable vehicles.
Next, the said shallow tray is placed on the floor, inside the said long sealed shallow container.
As this version of the invention requires that the said suitable substrate acts as a magnet, thus this next step is applicable if the said suitable substrate is a temporary magnet, in which case, the said suitable substrate is “converted” so as to behave as a magnet e.g. the electric current which converts the said suitable substrate into a magnet is “switched on”, thus the said suitable substrate will behave as a magnet for as long as the said electric current is “flowing”; or alternatively, a second magnet is brought into the proximity of the said suitable substrate in a manner such that the latter is positioned “within” the magnetic field of the said second magnet, therefore the said suitable substrate will behave as a magnet for as long as the said suitable substrate remains in the said magnetic field of the said second magnet. The said second magnet is allowed to “hold” its position relative to the said suitable substrate, by suitable means, through most of the processes according to this claim i.e. as the said suitable substrate moves, then, the said second magnet also “moves along with” the said suitable substrate.
Next, one side of the said suitable substrate is raised slightly so that the said suitable substrate is no longer completely horizontal i.e. there is now an “angle of inclination” between the “horizontal level” and the said suitable substrate, keeping in mind that the said temporary substrate simultaneously follows exactly every move that the said suitable substrate makes.
Next, the entire “body” of the said suitable substrate (and therefore the said temporary substrate) is raised “uniformly” in a very slow manner—in order to prevent causing ripples or “disturbing” the said compact monolayer—i.e. the magnitude of the said angle of inclination is kept constant throughout the said raising process of the said suitable substrate (and therefore the said raising process of the said temporary substrate).
Eventually, as the said suitable substrate rises, the said upper surface of the said raised side of the said temporary substrate comes into contact with the lower surface of the said compact monolayer.
As the said temporary substrate does not “interfere with” the magnetic attraction forces present (i.e. it allows the attractive forces to pass through freely), therefore, the said lower surface of the said compact monolayer, which contains ferromagnetic and/or paramagnetic materials within its chemical makeup/composition, will be attracted to the said upper surface of the said raised side of said suitable substrate (as the latter acts as a magnet, as described above), however, as the said temporary substrate is positioned between the said compact monolayer and the said suitable substrate, therefore, the said compact monolayer will adhere to the said upper surface of the said raised side of the said temporary substrate.
As the “gentle” raising of the said suitable substrate (and the said temporary substrate) proceeds, the said upper surface of the said temporary substrate will progressively become “covered” with the said compact monolayer until the entire said upper surface of the said temporary substrate is “covered” with the said compact monolayer.
This next step is applicable if the said suitable substrate is a temporary magnet, in which case, the said suitable substrate is “reverted” back to its “original state” of ceasing to behave as a temporary magnet e.g. the electric current which converted the said suitable substrate into a magnet is “switched off”, thus the said suitable substrate will cease to behave as a magnet; or alternatively, the said second magnet is removed from the proximity of the said suitable substrate, therefore the said suitable substrate will cease to behave as a magnet.
Next, the said raising of the said suitable substrate (and the said temporary substrate) is continued until the entire “body” of the said suitable substrate (and the said temporary substrate) has moved completely out of the said vehicles and the said suitable substrate (and the said temporary substrate) are removed from the said shallow tray.
The end result of the above process is that the said compact monolayer has come to rest/spread/deposit directly on the said upper surface of the said temporary substrate.
Next, the said temporary substrate, with the said compact monolayer spread/deposited on its upper surface, is “detached” and “moved away” from the said suitable substrate.
Next, if desired, the said compact monolayer, which contains ferromagnetic and/or paramagnetic materials within its chemical makeup/composition, may undergo suitable chemical reactions in order to “remove” the said ferromagnetic and/or paramagnetic material from the chemical makeup/composition of the said ferromagnetic and/or paramagnetic compact monolayer.
The next step involves the removal of the last remnants/traces of the said vehicles which might have been trapped between the said lower surface of the said compact monolayer and the said upper surface of the said temporary substrate, which may be achieved by using methods described in claim 29.

50: According to this claim, a compact monolayer [made up of a suitable organic material (or organic compound)] “sandwiched” between 2 suitable vehicles as described in claim 34, is “persuaded” to spread/deposit on the outward surface of a suitable substrate strip (as described in claim 16) by means of “magnetic attraction forces”.
The said compact monolayer used in this version of the invention is made up of a suitable organic material (or organic compound) which contains ferromagnetic and/or paramagnetic materials within its chemical makeup/composition.
The said suitable substrate strip used in this version of the invention is a magnet (a permanent magnet or a temporary magnet/electromagnet where an electric current is used).
The sequence of steps to prepare a compact monolayer [made up of a suitable organic material (or organic compound)] spread/deposited on the outward surface of a suitable substrate strip according to this claim is as follows:
First, a long sealed shallow container is used that is identical to that described in the claim 16.
Next, a compact monolayer [made up of a suitable organic material (or organic compound)], which contains ferromagnetic and/or paramagnetic materials within its chemical makeup/composition, is produced in one piece (inside a shallow tray) according to a conventional method in a manner such that the said compact monolayer is “sandwiched” between 2 suitable vehicles.
Next, the said shallow tray is placed on the floor, inside the said long sealed shallow container close to one end of the said long corridor as mentioned in claim 16, in such a manner that the “sloped” end of the said conveyor belt system as mentioned in claim 16 (and consequently, the said outward surface of the said suitable substrate strip) which is proximal to the said shallow tray “dips” into the said shallow tray and positions its tip/apex at a suitable level below the said compact monolayer and inside the said suitable vehicles.
As this version of the invention requires that the said suitable substrate strip acts as a magnet, thus this next step is applicable if the said suitable substrate strip is a temporary magnet, in which case, the said suitable substrate strip is “converted” so as to behave as a magnet e.g. the electric current which converts the said suitable substrate strip into a magnet is “switched on”, thus the said suitable substrate strip will behave as a magnet for as long as the said electric current is “flowing”; or alternatively, a second magnet is brought into the proximity of the said suitable substrate strip in a manner such that the latter is positioned “within” the magnetic field of the said second magnet, therefore the said suitable substrate strip will behave as a magnet for as long as the said suitable substrate strip remains in the said magnetic field of the said second magnet.
Next, the said conveyor belt system (as mentioned in claim 16) is switched on which causes the said suitable substrate strip to “travel” in the direction as described in claim 16, while simultaneously the said compact monolayer is “pushed”, at a controlled rate of speed, towards the said suitable substrate strip by pushing the “encircling instrument” (a non-stick filament used for pushing the outer periphery of a monolayer in order to produce a monolayer of desired “compactness”, i.e. to produce a compact monolayer) in the direction towards the said suitable substrate strip.
As a result of the presence of the magnetic attraction forces, the said compact monolayer, which contains ferromagnetic and/or paramagnetic materials within its chemical makeup/composition, is attracted to, and, adhere to the said outward surface of the said suitable substrate strip. The end result of the above process is that the said compact monolayer will come to rest/spread/deposit directly on the said outward surface of the said suitable substrate strip.
The speed of the said pushing of the said compact monolayer towards the said suitable substrate strip, as described above, should be “controlled” to be at an “optimum magnitude”, because, if the said speed is too fast, then the said compact monolayer will scrunch and result in a multi layered organic material (or organic compound) as the said suitable substrate strip would be moving too slow relative to the said compact monolayer, conversely, if the said pushing is too slow, then the said compact monolayer will “rupture”/break, as the said suitable substrate strip would be moving too fast relative to the said compact monolayer.
Next, if desired, the said compact monolayer, which contains ferromagnetic and/or paramagnetic materials within its chemical makeup/composition, may undergo suitable chemical reactions in order to “remove” the said ferromagnetic and/or paramagnetic material from the chemical makeup/composition of the said ferromagnetic and/or paramagnetic compact monolayer.
The next step involves the removal of the last remnants/traces of the said vehicles which might have been trapped between the said lower surface of the said compact monolayer and the said outward surface of the said suitable substrate strip, which may be achieved by using methods described in claim 29.

51: According to this claim, a compact monolayer [made up of a suitable organic material (or organic compound)] “sandwiched” between 2 suitable vehicles is “persuaded” to spread/deposit on the outward surface of a “temporary substrate strip” by means of “magnetic attraction forces”.
The said compact monolayer used in this version of the invention is made up of a suitable organic material (or organic compound) which contains ferromagnetic and/or paramagnetic materials within its chemical makeup/composition.
This claim is identical to claim 50 except that in this version of the invention, a “temporary substrate strip” is positioned (and “held in place”) in the proximity of the outward surface of the suitable substrate strip used in claim 50, by suitable means.
The said temporary substrate strip and the said suitable substrate strip continue to keep their positions “unchanged” relative to one another throughout the processes involved in this version of the invention i.e. when the said suitable substrate strip moves (in the direction mentioned in claim 50), then, the said temporary substrate strip also moves in the same direction as the said suitable substrate strip at exactly the same rate of speed while keeping the distance separating them constant.
One of the properties of the said temporary substrate is that it should be adequately thin so as to allow the “passage/penetration” of the magnetic field “possessed/produced” by the said suitable substrate strip, according to claim 50, to take place effectively and efficiently across its width.
The sequence of steps according to this version of the invention is similar to those of the claim 50, as follows:
First, a long sealed shallow container is used that is identical to that described in the claim 16.
Next, a compact monolayer [made up of a suitable organic material (or organic compound)], which contains ferromagnetic and/or paramagnetic materials within its chemical makeup/composition, is produced in one piece (inside a shallow tray) according to a conventional method in a manner such that the said compact monolayer is “sandwiched” between 2 suitable vehicles.
Next, a temporary substrate strip is positioned (and “held in place”) in the proximity of the outward surface of a suitable substrate strip.
Next, the said shallow tray is placed on the floor, inside the said long sealed shallow container close to one end of the said long corridor as mentioned in claim 16, in such a manner that the “sloped” end of the said conveyor belt system (and consequently, the said outward surface of the said substrate strip and the said temporary substrate strip) which is proximal to the said shallow tray “dips” into the said shallow tray and positions its tip/apex at a suitable level below the said compact monolayer and inside the said suitable vehicles.
As this version of the invention requires that the said suitable substrate strip acts as a magnet, thus this next step is applicable if the said suitable substrate strip is a temporary magnet, in which case, the said suitable substrate strip is “converted” so as to behave as a magnet e.g. the electric current which converts the said suitable substrate strip into a magnet is “switched on”, thus the said suitable substrate strip will behave as a magnet for as long as the said electric current is “flowing”; or alternatively, a second magnet is brought into the proximity of the said suitable substrate strip in a manner such that the latter is positioned “within” the magnetic field of the said second magnet, therefore the said suitable substrate strip will behave as a magnet for as long as the said suitable substrate strip remains in the said magnetic field of the said second magnet.
Next, the said conveyor belt system (as mentioned in claim 16) is switched on which causes the said substrate strip (and therefore the said temporary substrate strip) to “travel” in the direction as described in claim 16, while simultaneously the said compact monolayer is “pushed”, at a controlled rate of speed, towards the said temporary substrate strip by pushing the “encircling instrument” (a non-stick filament used for pushing the outer periphery of a monolayer in order to produce a monolayer of desired “compactness”, i.e. to produce a compact monolayer) in the direction towards the said temporary substrate strip.
Eventually, the lower surface of the said compact monolayer comes into contact with the upper surface of the said temporary substrate strip; and as the said temporary substrate strip does not “interfere with” the magnetic attraction forces present (i.e. it allows the attractive forces to pass through freely), therefore, the said lower surface of the said compact monolayer, which contains ferromagnetic and/or paramagnetic materials within its chemical makeup/composition, will be attracted to the said outward surface of the said suitable substrate strip, however, as the said temporary substrate strip is positioned between the said compact monolayer and the said suitable substrate strip, therefore, the said compact monolayer will adhere to the said upper surface of the said temporary substrate strip.
The end result of the above process is that the said compact monolayer will come to rest/spread/deposit directly on the said upper surface of the said temporary substrate strip.
The speed of the said pushing of the said compact monolayer towards the said temporary substrate strip, as described above, should be “controlled” to be at an “optimum magnitude”, because, if the said speed is too fast, then the said compact monolayer will scrunch and result in a multi layered organic material (or organic compound) as the said temporary substrate strip would be moving too slow relative to the said compact monolayer, conversely, if the said pushing is too slow, then the said compact monolayer will “rupture”/break, as the said temporary substrate strip would be moving too fast relative to the said compact monolayer.
Next, the said temporary substrate strip, with the said compact monolayer spread/deposited on its upper surface, is “detached” and “moved away” from the said suitable substrate strip.
Next, if desired, the said compact monolayer, which contains ferromagnetic and/or paramagnetic materials within its chemical makeup/composition, may undergo suitable chemical reactions in order to “remove” the said ferromagnetic and/or paramagnetic material from the chemical makeup/composition of the said ferromagnetic and/or paramagnetic compact monolayer.
The next step involves the removal of the last remnants/traces of the said vehicles which might have been trapped between the said lower surface of the said compact monolayer and the said upper surface of the said temporary substrate strip, which may be achieved by using methods described in claim 29.

52: According to this claim, a compact monolayer [made up of a suitable organic material (or organic compound)] “sandwiched” between 2 suitable vehicles is “persuaded” to spread/deposit on the upper surface of a suitable substrate by means of “magnetic repulsive forces”.
The said compact monolayer used in this version of the invention is made up of a suitable organic material (or organic compound) which contains diamagnetic materials within its chemical makeup/composition.
The sequence of steps to prepare a compact monolayer [made up of a suitable organic material (or organic compound)] spread/deposited on the upper surface of a suitable substrate according to this claim is as follows:
First, a long sealed shallow container is used that is identical to that described in claim 15.
Then, a suitable substrate is placed at the bottom of a shallow tray (as described in claim 15.
Then, a compact monolayer [made up of a suitable organic material (or organic compound)], which contains diamagnetic materials within its chemical makeup/composition, is produced in one piece (inside the said shallow tray) according to a conventional method in a manner such that the said compact monolayer is “sandwiched” between 2 suitable vehicles.
Next, the said shallow tray is placed on the floor, inside the said long sealed shallow container.
Next, a “suitably strong” magnet is positioned (and “held in place”) above (and in the proximity of) the upper surface of the said compact monolayer. The said magnet may be a permanent magnet or a temporary magnet/electromagnet where an electric current is used—if the said magnet used in this invention is a temporary magnet, then the latter is “converted” so as to behave as a magnet i.e. the electric current which converts the said temporary magnet/electromagnet into a magnet is “switched on”, thus the said temporary magnet/electromagnet will behave as a magnet for as long as the said electric current is “flowing”.
Next, one side of the said suitable substrate is raised slightly so that the said suitable substrate is no longer completely horizontal i.e. there is now an “angle of inclination” between the “horizontal level” and the said suitable substrate; while simultaneously, if the said magnet used in this invention is a temporary magnet, then the latter is “converted” so as to behave as a magnet e.g. the electric current which converts the said temporary magnet into a magnet is “switched on”, thus the said temporary magnet will behave as a magnet for as long as the said electric current is “flowing”.
Next, the entire “body” of the said suitable substrate is raised “uniformly” in a very slow manner—in order to prevent causing ripples or “disturbing” the said compact monolayer—i.e. the magnitude of the said angle of inclination is kept constant throughout the said raising process of the said suitable substrate.
Eventually, as the said suitable substrate rises, the said upper surface of the said raised side of the said suitable substrate comes into contact with the lower surface of the said compact monolayer.
Due to the presence of the magnetic field produced by the said magnet, the said diamagnetic compact monolayer, which contains diamagnetic materials within its chemical makeup/composition, is “pushed away” from the said magnet, and thus, the said compact monolayer is “pushed” towards the said upper surface of the said suitable substrate; as a result, the said compact monolayer is “persuaded” to rest/spread/deposit directly on the said upper surface of the said suitable substrate strip.
As the “gentle” raising of the said suitable substrate proceeds, the said upper surface of the said suitable substrate will progressively become “covered” with the said compact monolayer until the entire “body” of the said suitable substrate is raised above the said liquid inside the said shallow tray—i.e. above the said vehicles and the said compact monolayer.
The end result of the above process is that the said compact monolayer will come to rest/spread/deposit directly on the said upper surface of the said suitable substrate.
Next, if desired, the said compact monolayer, which contains diamagnetic materials within its chemical makeup/composition, may undergo suitable chemical reactions in order to “remove” the said diamagnetic material from the chemical makeup/composition of the said diamagnetic compact monolayer.
The next step involves the removal of the last remnants/traces of the said vehicles which might have been trapped between the said lower surface of the said compact monolayer and the said upper surface of the said suitable substrate, which may be achieved by using methods described in claim 29.

53: According to this claim, a compact monolayer [made up of a suitable organic material (or organic compound)] “sandwiched” between 2 suitable vehicles is “persuaded” to spread/deposit on the outward surface of a suitable substrate strip (as described in claim 16) by means of “magnetic repulsive forces”.
The said compact monolayer used in this version of the invention is made up of a suitable organic material (or organic compound) which contains diamagnetic materials within its chemical makeup/composition.
The sequence of steps to prepare a compact monolayer [made up of a suitable organic material (or organic compound)] spread/deposited on the outward surface of a suitable substrate strip according to this claim is as follows:
First, a long sealed shallow container is used that is identical to that described in the claim 16.
Next, a compact monolayer [made up of a suitable organic material (or organic compound)], which contains diamagnetic materials within its chemical makeup/composition, is produced in one piece (inside a shallow tray) according to a conventional method in a manner such that the said compact monolayer is “sandwiched” between 2 suitable vehicles.
Next, the said shallow tray is placed on the floor, inside the said long sealed shallow container close to one end of the said long corridor as mentioned in claim 16, in such a manner that the “sloped” end of the said conveyor belt system as mentioned in claim 16 (and consequently, the said outward surface of the said suitable substrate strip) which is proximal to the said shallow tray “dips” into the said shallow tray and positions its tip/apex at a suitable level below the said compact monolayer and inside the said vehicles.
Next, a “suitably strong” magnet is positioned (and “held in place”) above (and in the proximity of) the upper surface of the said compact monolayer. The said magnet may be a permanent magnet or a temporary magnet/electromagnet where an electric current is used—if the said magnet used in this invention is a temporary magnet, then the latter is “converted” so as to behave as a magnet i.e. the electric current which converts the said temporary magnet/electromagnet into a magnet is “switched on”, thus the said temporary magnet/electromagnet will behave as a magnet for as long as the said electric current is “flowing”.
Next, the said conveyor belt system (as mentioned in claim 16) is switched on which causes the said suitable substrate strip to “travel” in the direction as described in claim 16, while simultaneously the said compact monolayer is “pushed”, at a controlled rate of speed, towards the said suitable substrate strip by pushing the “encircling instrument” (a non-stick filament used for pushing the outer periphery of a monolayer in order to produce a monolayer of desired “compactness”, i.e. to produce a compact monolayer) in the direction towards the said suitable substrate strip.
Eventually, the lower surface of the said compact monolayer comes into contact with the said outward surface of the said suitable substrate strip.
Due to the presence of the magnetic field produced by the said magnet, the said diamagnetic compact monolayer, which contains diamagnetic materials within its chemical makeup/composition, is “pushed away” from the said magnet, and thus, the said compact monolayer is “pushed” towards the said outward surface of the said suitable substrate strip; as a result, the said compact monolayer is “persuaded” to rest/spread/deposit directly on the said outward surface of the said suitable substrate strip.
The speed of the said pushing of the said compact monolayer towards the said suitable substrate strip, as described above, should be “controlled” to be at an “optimum magnitude”, because, if the said speed is too fast, then the said compact monolayer will scrunch and result in a multi layered organic material (or organic compound) as the said suitable substrate strip would be moving too slow relative to the said compact monolayer, conversely, if the said pushing is too slow, then the said compact monolayer will “rupture”/break, as the said suitable substrate strip would be moving too fast relative to the said compact monolayer.
Next, if desired, the said compact monolayer, which contains diamagnetic materials within its chemical makeup/composition, may undergo suitable chemical reactions in order to “remove” the said diamagnetic material from the chemical makeup/composition of the said diamagnetic compact monolayer.
The next step involves the removal of the last remnants/traces of the said vehicles which might have been trapped between the said lower surface of the said compact monolayer and the said outward surface of the said suitable substrate, which may be achieved by using methods described in claim 29.

54: According to this claim, a compact monolayer [made up of a suitable organic material (or organic compound)] “sandwiched” between two “suitable surfaces” is carbonized by placing the said “sandwiched compact monolayer” in a “hot environment”.
The said suitable surfaces mentioned above may be two suitable substrates (as described in claims 1, 2, 3, 4, 5, and 6), or two suitable plates (as described in claims 7, 8, 9, 10, 11, and 12), or one suitable substrate (as described in claims 1, 2, 3, 4, 5, and 6) and one suitable plate (as described in claims 7, 8, 9, 10, 11, and 12).
The said hot environment mentioned above may be a kiln/oven/furnace.

55: This claim is comprised of a very thin substrate (made up of a suitable material which is capable of being dissolved in a suitable reagent) the upper surface of which may be smooth or it may possess “raised” patterns or “carved/etched” patterns in a similar manner as described in claims 3 and 4 respectively.

56: This claim is comprised of a very thin plate (made up of a suitable material which is capable of being dissolved in a suitable reagent) the upper surface of which may be smooth or it may possess “raised” patterns or “carved/etched” patterns in a similar manner as described in claims 9 and 10 respectively.
The said plate is capable of being heated to suitably high temperatures.
